(19) United States
(12) Patent Application Publication
(10) Pub. No.: US 2023/0199577 A1
(43) Pub. Date: Jun. 22, 2023

(54) Keeping/Changing MR-DC Upon Conditional Handover (CHO)

(71) Applicant: Telefonaktiebolaget LM Ericsson (publ), Stockholm (SE)

(72) Inventors: Icaro L.J. Da Silva, Solna (SE); Julien Muller, Rennes (FR)

(21) Appl. No.: 17/926,181

(22) PCT Filed: May 20, 2021
(86) PCT No.: PCT/SE2021/050479

§ 371 Date: Nov. 18, 2022

Related U.S. Application Data
(60) Provisional application No. 63/028,408, filed on May 21, 2020.

(51) Int. Cl. H04W 36/00; H04W 76/30

(52) U.S. Cl. CPC H04W 36/0069; H04W 36/00837; H04W 76/30

(57) ABSTRACT

Techniques for conditional reconfiguration in a multi-connectivity scenario. In an example method, a first network node, configured to operate as a master node, MN, for multi-connectivity operation of a wireless device along with a second network node operating as a secondary node, SN, for the wireless device, determines (810) to configure the wireless device with a conditional reconfiguration and transmits (820) a handover request message to a third network node, the handover request message including an indication that the handover request message is for conditional handover. The first network node receives (830) an acknowledgment of the handover request message and, in response, delays (840) transmission of a release message to the second network node until the first network node receives an indication that the conditional handover is executed.

### TECHNICAL FIELD

The present disclosure is generally related to wireless communication devices and is more particularly related to conditional reconfigurations in multi-connectivity operating scenarios.

### BACKGROUND

Some reconfiguration procedures are particularly susceptible to failure in New Radio (NR) systems, whose radio links are more prone to fast fading due to their higher operating frequencies. Conditional reconfiguration is one approach to improve robustness against failure in this regard. Under this approach, the network transmits a conditional reconfiguration to a wireless device and specifies a condition that is to trigger the wireless device to execute that conditional reconfiguration. The wireless device waits to execute the conditional reconfiguration until the wireless device detects that the condition is fulfilled. Once the device detects that condition, the device may autonomously execute the conditional reconfiguration without receiving any other signaling, so that the reconfiguration proves robust to link deterioration.

The terms “multi-connectivity” or “multi-connectivity operation” refer to the simultaneous connection of a wireless device (e.g., at a radio resource control, RRC, layer) to multiple different radio network nodes, or to multiple different cells provided by different radio network nodes. In wireless networks developed by members of the 3rd-Generation Partnership Project (3GPP), one category of multi-connectivity operation is called multi-radio dual connectivity (MR-DC). A user equipment (UE) operating in MR-DC has a Master Node (MN) connection and a Secondary Node (SN) connection. One example of MR-DC configuration is EUTRAN-NR Dual Connectivity (EN-DC) where an LTE eNodeB operates as the MN and an NR gNodeB operates as an SN. Other configurations are also possible, e.g., where both MN and SN are NR gNodeB(s).

Since Release 15 of the 3GPP specifications, a node operating as an MN for a UE operating in MR-DC, can trigger a handover (reconfiguration with sync) for a UE operating in MR-DC. When that occurs the target MN receiving a handover request may either decide to release MR-DC or to continue the MR-DC operation with the incoming UE.

Although this conditional reconfiguration approach can improve robustness against failure, its use proves challenging in some contexts. More particularly, known approaches to conditional reconfiguration fail to adequately account for the multiplicity of radio network nodes or cells involved in multi-connectivity.

### SUMMARY

In MR-DC, the expected time between the transmission of an SN Addition Request message that sets up an SN and the reception of an SN Reconfiguration Complete is rather short. Because in CHO the UE may take longer to access a candidate target MN, or may not even attempt to access it, this may lead to many unintended SN Releases from the candidate target SN. This may create race conditions, e.g., the candidate target MN having to repeatedly modify its CHO configurations towards the source MN.

In addition to this problem, when a target MN candidate transmits the Handover Request Acknowledge message in response to a CHO, in the event that decides to keep or change the SN, legacy procedures define that the source MN releases the SN. However, in the CHO case, that is not the desired behavior as the equivalent changes at the UE are only performed when the conditions are fulfilled.

Various embodiments described herein address some or all of these problems.

A first example method comprises a method performed by a first network node, configured to operate as a master network node for multi-connectivity operation of a wireless device, in accordance with particular embodiments. The method in some embodiments includes determining to configure the wireless device with a conditional reconfiguration. The method may further comprise transmitting a handover request message to a third network node, including an indication that the procedure is for conditional handover. The method may further comprise receiving an acknowledgment of the handover request message and, in response, delaying transmission of a release message to a second network node operating as a secondary network node for the wireless device.

A second example method comprises a method performed by a network node configured to operate as a candidate target network node for multi-connectivity operation of a wireless device, in accordance with other particular embodiments. The method includes receiving a handover request message from a source network node for the wireless device, the handover request message including an indication that the procedure is for conditional handover. The method further includes transmitting a secondary node addition request to a candidate target secondary network node, including an indication that the request is for a conditional handover. The method still further includes receiving an acknowledgment of the secondary node addition request, and transmitting an acknowledgment of the handover request to the first network node.

A third example method comprises a method performed by a network node, which may be configured to operate as a candidate target secondary node for a wireless device, in accordance with other particular embodiments. The method includes receiving a secondary node addition request, including an indication that the request is for a conditional reconfiguration. The method still further includes transmitting an acknowledgment of the secondary node addition request, in response to the secondary node addition request. In some embodiments, the method may comprise starting a supervision timer, in response to receiving the secondary node addition request; this may comprise setting a supervision timer to a value based on the indication that the request is for a conditional handover.

A fourth example method comprises a method performed by network node configured to operate as a candidate target master node for multi-connectivity operation of a wireless device, in accordance with other particular embodiments. The method includes receiving, from a wireless device, an RRC reconfiguration complete message. The method further includes determining that the wireless device has been configured with a conditional reconfiguration and has an associated multi-connectivity-related configuration for a candidate target secondary node. The method still further includes transmitting a secondary node reconfiguration complete message to the candidate target secondary node, and transmitting a message to a source master node for the wireless device.

A fifth example method comprises a method performed by a network node, configured to operate as a candidate target secondary node for a wireless device, in accordance with other particular embodiments. The method includes receiving a secondary node reconfiguration complete message, e.g., from a master node candidate target for conditional handover of the wireless device. The method further includes stopping a supervision timer associated with conditional secondary node addition of the wireless device. The method still further includes considering a context associated with the wireless device to be active.

A sixth example method comprises a method performed by a network node configured to operate as a master network node for multi-connectivity operation of a wireless device, in accordance with other particular embodiments. The method includes receiving a message from a candidate target master node to which the wireless device has executed a conditional handover. The method further includes transmitting, to a candidate target master node for which conditional handover of the wireless device has been configured but not executed, a message indicating that a conditional handover configuration for the wireless device is to be released.

A seventh example method comprises a method performed by a candidate target master node for multi-connectivity conditional handover of a wireless device. This method includes receiving, from a source master node for the wireless device, a message indicating that a conditional reconfiguration for the wireless device is to be released, and determining that the conditional reconfiguration for the wireless device has an associated target secondary node candidate for the conditional handover. The method may further comprise transmitting a secondary node release request message to the target secondary node candidate.

Advantages of various of the disclosed embodiments is that they enable a UE operating in MR-DC to be configured with Conditional Reconfiguration (e.g., Conditional Handover—CHO) and they enable a candidate target MN to either keep the SN or modify/change the SN.

According to various embodiments, a target MN candidate may configure an SN candidate target to either keep the SN or change the SN, without the SN candidate target having the risk of setting too short value for the supervision timer, as this would be clearly for a CHO. Since the time between the transmission of an SN Addition Request and reception of an SN Reconfiguration Complete is longer than in legacy, as in CHO the UE may take longer to access a candidate target MN, or not even come, the methods may be used to avoid unintended SN Releases from the candidate target SN, which avoids creating quite many race conditions e.g., candidate target MN having to modify its CHO configurations towards the source MN. In some embodiments, the candidate target SN may also reserve resources for the UE taking into account that the UE may connect after a longer time compared to legacy SN Addition or may not connect at all, which will lead to an optimized resource allocation within the node.

In addition, in some embodiments, when the target MN candidate transmits the Handover Request Acknowledge message in response to a CHO, in the case it has decided to keep or change the SN, the methods prevent procedures that define that the source MN releases the SN, by delaying that action to when CHO is executed.

Embodiments herein also include corresponding apparatuses, computer programs, and carriers of those computer programs. Embodiments herein for instance include various network nodes configured to perform any of the steps of any of the embodiments described above.

### BRIEF DESCRIPTION OF THE DRAWINGS

FIG. 1 shows an example signaling flow for inter-MN handover with or without MN initiated SN change.

FIG. 2 illustrates NG-RAN node Addition Preparation, successful operation.

FIG. 3 shows S-NG-RAN node Reconfiguration Complete procedure, successful operation.

FIG. 4 is a signal flow diagram illustrating an example method that includes CHO preparation.

FIG. 5 is a signal flow diagram illustrating an example method that includes CHO execution.

FIG. 6 is a signal flow diagram illustrating an example method that includes cancellation of CHO.

FIG. 7 illustrates aspects of the presently disclosed techniques with respect to a wireless device.

FIG. 8 illustrates an example method, according to some embodiments.

FIG. 9 illustrates an example method, according to some embodiments.

FIG. 10 illustrates an example method, according to some embodiments.

FIG. 11 illustrates an example method, according to some embodiments.

FIG. 12 illustrates an example method, according to some embodiments.

FIG. 13 illustrates an example method, according to some embodiments.

FIG. 14 illustrates an example method, according to some embodiments.

FIG. 15 illustrates an example method, according to some embodiments.

FIG. 16 illustrates an example method, according to some embodiments.

FIG. 17 is a block diagram illustrating an example network node.

FIG. 18A and FIG. 18B show example information elements.

FIG. 19A and FIG. 19B show example SN Addition Request messages.

FIG. 20A and FIG. 20B together show and example Handover Request message.

FIG. 21 shows an example definition of the Handover Success message for 3GPP specifications.

FIG. 22A and FIG. 22B together illustrate an example implementation of the 3GPP specifications, including a definition of the SN Release Request Acknowledge message.

FIG. 23A and FIG. 23B together illustrate an example implementation of the 3GPP specifications, including a definition of the Xn-U Address Indication message.

FIG. 24 illustrates an example implementation of the SN Status Transfer message in 3GPP specifications.

FIG. 25 is a signal flow diagram illustrating inter-MN handover with/without MN initiated SN change.

FIG. 26 is a signal flow diagram illustrating inter-MN handover with/without MN initiated SN change procedure.

FIG. 27 is a block diagram of a wireless communication network according to some embodiments.

FIG. 28 is a block diagram of a user equipment according to some embodiments.

FIG. 29 is a block diagram of a virtualization environment according to some embodiments.

FIG. 30 is a block diagram of a communication network with a host computer according to some embodiments.

FIG. 31 is a block diagram of a host computer according to some embodiments.

FIG. 32 is a flowchart illustrating a method implemented in a communication system, in accordance with one embodiment.

FIG. 33 is a flowchart illustrating a method implemented in a communication system, in accordance with one embodiment.

FIG. 34 is a flowchart illustrating a method implemented in a communication system, in accordance with one embodiment.

FIG. 35 is a flowchart illustrating a method implemented in a communication system, in accordance with one embodiment.

### DETAILED DESCRIPTION

Exemplary embodiments of the present disclosure will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment can be tacitly assumed to be present/used in another embodiment. Any two or more embodiments described in this document may be combined with each other.

### Keeping/Changing MR-DC During Mobility for a UE Operating in MR-DC

A UE operating in MR-DC (Multi-Radio dual Connectivity) has a Master Node (MN) connection and a Secondary Node (SN) connection. One example of MR-DC configuration is EUTRAN-NR Dual Connectivity (EN-DC) where an LTE eNodeB operates as the MN and an NR gNodeB operates as an SN. Other configurations are also possible, e.g., both MN and SN being NR gNodeB(s).

Since Release 15 of the 3GPP specifications, a node operating as an MN for a UE operating in MR-DC can trigger a handover (reconfiguration with sync) for a UE operating in MR-DC. When that occurs the target MN receiving a handover request may either decide to release MR-DC or to continue the MR-DC operation with the incoming UE.

The overall procedure (or set of procedures) involved in these cases are captured in 3GPP TS 37.340, more precisely in Section 10.7 for the MR-DC case (10.7.2). As discussed there, inter-MN handover with/without MN initiated SN change is used to transfer UE context data from a source MN to a target MN while the UE context at the SN is kept or moved to another SN. During an Inter-Master Node handover, the target MN decides whether to keep or change the SN, or release the SN.

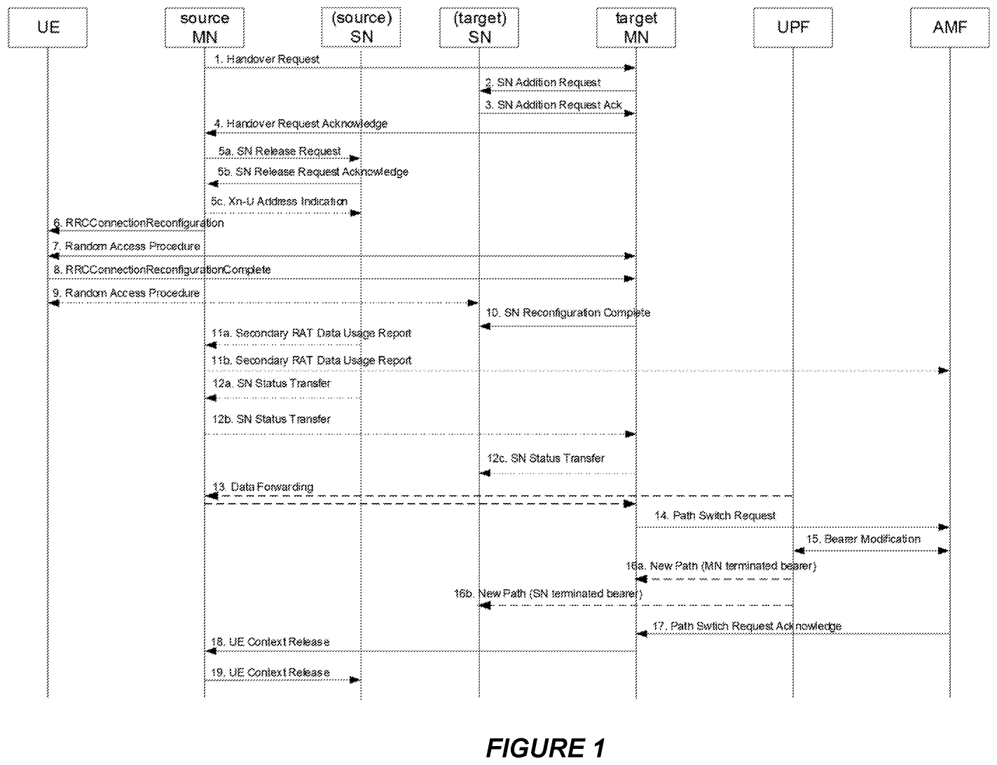

FIG. 1 shows an example signaling flow for inter-MN handover with or without MN initiated SN change. The steps shown in that figure include the following:
1. The source MN initiates the handover by sending a Handover Request to the target MN.
2. If the target MN decides to keep the source SN, the target MN sends SN Addition Request to the SN including the SN UE XnAP ID as a reference to the UE context in the SN that was established by the source MN. If the target MN decides to change the SN, the target MN sends the SN Addition Request to the target SN including the UE context in the source SN that was established by the source MN.
3. The (target) SN replies with SN Addition Request Acknowledge. The (target) SN may include the indication of the full or delta RRC configuration.
4. The target MN includes within the Handover Request Acknowledge message the MN RRC reconfiguration message to be sent to the UE in order to perform the handover, and may also provide forwarding addresses to the source MN. If PDU session split is performed in the target side during handover procedure, more than one data forwarding addresses corresponding to each node are included in the Handover Request Acknowledge message. The target MN indicates to the source MN that the UE context in the SN is kept if the target MN and the SN decided to keep the UE context in the SN in step 2 and step 3.
5a/5b. The source MN sends SN Release Request message to the (source) SN including a Cause indicating MCG mobility. The (source) SN acknowledges the release request. The source MN indicates to the (source) SN that the UE context in SN is kept, if it receives the indication from the target MN. If the indication as the UE context kept in SN is included, the SN keeps the UE context.
5c. The source MN sends XN-U Address Indication message to the (source) SN to transfer data forwarding information. More than one data forwarding addresses may be provided if the PDU session is split in the target side.
6. The source MN triggers the UE to perform handover and apply the new configuration, by sending an RRCConnectionReconfiguration message.
7/8. Random access procedure: The UE synchronizes to the target MN and replies with MN RRC reconfiguration complete message.
9. If configured with bearers requiring SCG radio resources, the UE synchronizes to the (target) SN, using a random access procedure.
10. If the RRC connection reconfiguration procedure was successful, the target MN informs the (target) SN via SN Reconfiguration Complete message.
11a. The source SN sends the Secondary RAT Data Usage Report message to the source MN and includes the data volumes delivered to and received from the UE over the NR/E-UTRA radio as described in clause 10.11.2.
11b. The source MN sends the Secondary RAT Report message to AMF to provide information on the used NR/E-UTRA resource.
12. For bearers using RLC AM, the source MN sends the SN Status Transfer to the target MN, including, if needed, SN Status received from the source SN. The target forwards the SN Status to the target SN, if needed.
13. If applicable, data forwarding takes place from the source side. If the SN is kept, data forwarding may be omitted for SN terminated bearers or QoS flows kept in the SN.
14-17. The target MN initiates the Path Switch procedure. If the target MN includes multiple DL TEIDs for one PDU session in the Path Switch Request message, multiple UL TEID of the UPF for the PDU session should be included in the Path Switch Ack message in case there is TEID update in UPF.
18. The target MN initiates the UE Context Release procedure towards the source MN.
19. Upon reception of the UE Context Release message from source MN, the (source)

SN releases C-plane related resources associated to the UE context towards the source MN. Any ongoing data forwarding may continue. The SN shall not release the UE context associated with the target MN if the UE contest kept indication was included in the SN Release Request message in step 5.

As shown in FIG. 1 and discussed above, the target MN (i.e., a T-Ng-eNB/gNB) receives a HANDOVER REQUEST XnAP message including both MCG and SCG configuration for the UE, indicating the UE is operating in MR-DC. If the target MN decides to keep the source SN, the target MN sends SN Addition Request to the SN, including the SN UE XnAP ID as a reference to the UE context in the SN that was established by the source MN. If the target MN decides to change the SN, the target MN sends the SN Addition Request to the target SN, including the UE context in the source SN that was established by the source MN.

The target SN (which may be the same as the source SN, in case the target MN decides to keep the SN) transmits an SN Addition Request Ack to the source MN. Upon that, the source MN triggers an SN Release procedure followed by the necessary steps to enable data forwarding such as the transmission to the source SN of an Xn-U address indication, the reception of an SN Status transfer from the source SN, and the transmission of the SN Status transfer to the target MN.

Similar principles also apply for the EN-DC case, described in 3GPP TS 37.340, section 10.7.1.

### Conditional Handover/Conditional Reconfiguration

Two new work items for mobility enhancements in LTE and NR have started in 3GPP in Release 16. The main objectives of the work items are to improve the robustness at handover and to decrease the interruption time at handover. For that purpose, Conditional Handover (specified in RRC as a case of a conditional reconfiguration) is being specified. Conditional handover is described in stage 2, 3GPP TS 38.300, v 16.1.0, in chapter 9.2.3.4.

Conditional Handover (CHO) is defined as a handover that is executed by the UE when one or more handover execution conditions are met. The UE starts evaluating the execution condition(s) upon receiving the CHO configuration, and stops evaluating the execution condition(s) once the execution condition(s) is met. The following principles apply to CHO:
The CHO configuration contains the configuration of CHO candidate cell(s) generated by the candidate gNB(s) and execution condition(s) generated by the source gNB.
An execution condition may consist of one or two trigger condition(s) (CHO events A3/A5). Only a single RS type is supported and at most two different trigger quantities (e.g., RSRP and RSRQ, RSRP and SINR, etc.) can be configured simultaneously for the evaluation of CHO execution condition of a single candidate cell.
Before any CHO execution condition is satisfied, upon reception of HO command (without CHO configuration), the UE executes the HO procedure as described in clause 9.2.3.2 of 3GPP TS 38.300, regardless of any previously received CHO configuration.
While executing CHO, i.e., from the time when the UE starts synchronization with target cell, the UE does not monitor the source cell.

CHO is not supported for N2 based handover in this release of the specification.

### MR-DC and Conditional Handover

In RAN2 #109e, it has been agreed that “CHO (MCG)” can work together with MR-DC, i.e., “receive CHO when MR-DC is configured, and receive SCG addition when CHO is configured.” Note that “MCG” and “SCG” refer to Master Cell Group and Secondary Cell Group, respectively; these terms can be regarded as interchangeable with MN and SN for the purposes of the present disclosure.

Thus, according to the agreement two scenarios would be supported:
1. A UE operating in MR-DC may receive a CHO configuration including an

RRCReconfiguration per candidate target MN;
2. A UE configured with CHO (i.e., monitoring conditions for a candidate target) receives an SCG addition.

Then, in RAN2 #109e-bis, it has been agreed that the RRCReconfiguration prepared by an MN candidate target can either contain an SCG configuration (i.e., keep it or modify, in case the UE is already in EN-DC) or release it. According to the current agreement: “We will not preclude SCG configuration in RRC Reconfiguration with conditional reconfiguration. Limit to cases without RAN3 impact.”

When a handover request for CHO is transmitted from a source MN, a candidate target node may decide to take at least one of the following decisions:
Case 1) Create a candidate target RRCReconfiguration that upon CHO execution releases MR-DC configurations;
Case 2) Create a candidate target RRCReconfiguration that upon CHO execution keeps MR-DC configurations (SN is kept);
Case 3) Create a candidate target RRCReconfiguration that upon CHO execution changes MR-DC configurations (SN is changed).

Current procedures may create problems for Cases 2 and 3, especially between a candidate target MN receiving a Handover Request message for CHO, and a candidate target SN.

More particularly, if upon receiving a Handover Request message for CHO from a source MN the candidate target MN triggers a legacy SN Addition Request towards a candidate target SN, i.e., the candidate target MN simply sends a legacy SN Addition Request, the candidate target SN may transmit an SN Addition Request Acknowledge message and start its supervision timer (TXn_{DCprep}), that should run until the target SN candidate expects a Reconfiguration Complete message from the target MN candidate, which is an indication that the UE has accessed the target MN and successfully applied the SN-related configurations.

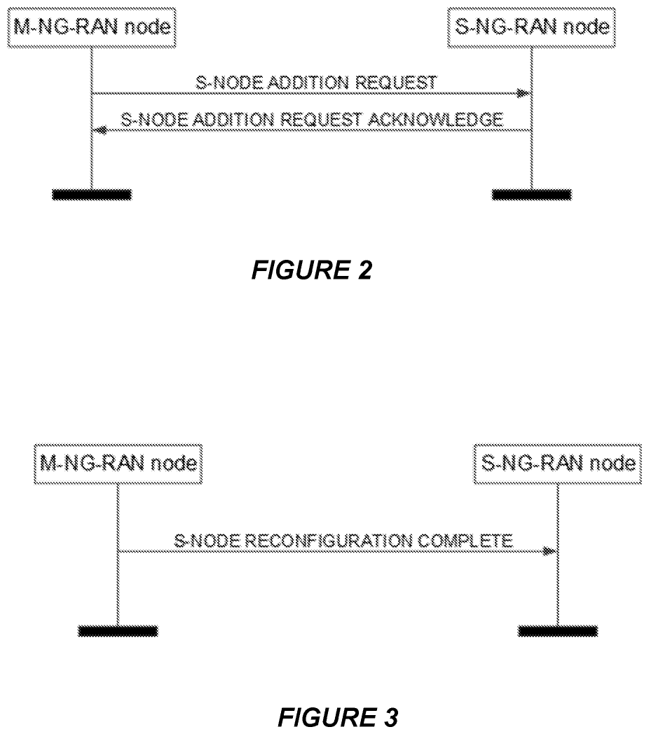

Relevant procedures include the S-NG-RAN node Addition Preparation procedure, which is used to request the S-NG-RAN node to allocate resources for dual connectivity operation for a specific UE. This procedure is shown in FIG. 2, and uses UE-associated signaling.

The M-NG-RAN node initiates the procedure by sending the S-NODE ADDITION REQUEST message to the S-NG-RAN node. When the M-NG-RAN node sends the S-NODE ADDITION REQUEST message, it starts the timer TXn_{DCprep}. Upon reception of the S-NODE ADDITION REQUEST ACKNOWLEDGE message, the M-NG-RAN node stops the timer TXn_{DCprep}.

If the S-NODE ADDITION REQUEST message contains the SN Addition Trigger Indication IE, the S-NG-RAN node includes the RRC config indication IE in the S-NODE ADDITION REQUEST ACKNOWLEDGE message to inform the M-NG-RAN node if the S-NG-RAN node applied full or delta configuration.

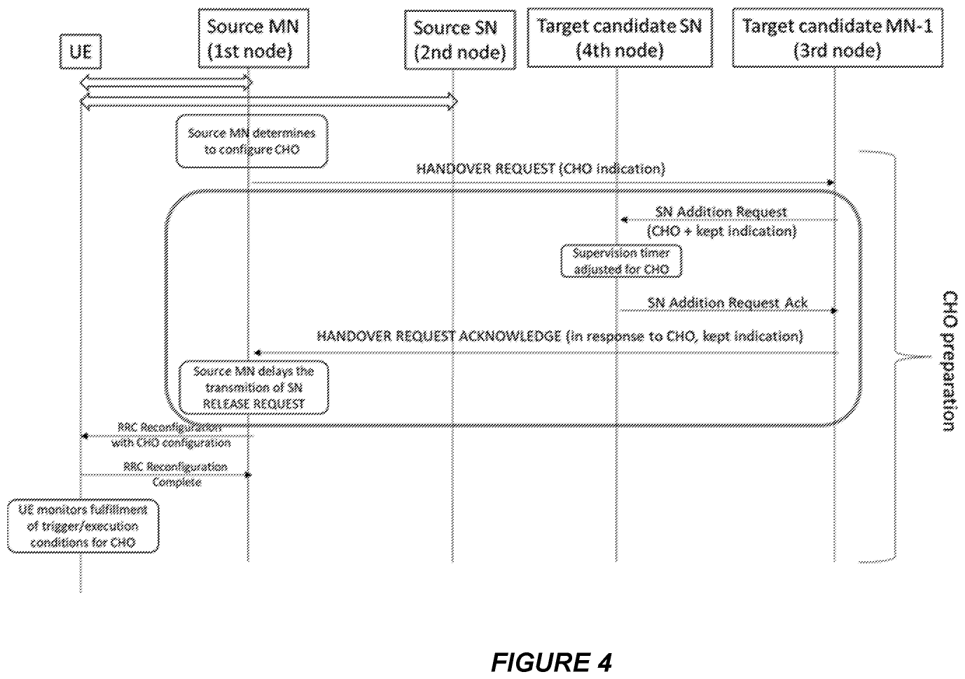

The S-NG-RAN node Reconfiguration Completion procedure is used to provide information to the S-NG-RAN node whether the requested configuration was successfully applied by the UE. This procedure uses UE-associated signaling and is shown in FIG. 3.

The M-NG-RAN node initiates the procedure by sending the S-NODE RECONFIGURATION COMPLETE message to the S-NG-RAN node. The S-NODE RECONFIGURATION COMPLETE message may contain information that the UE has successfully applied the configuration requested by the S-NG-RAN node, in which case the M-NG-RAN node may also provide configuration information in the M-NG-RAN node to S-NG-RAN node Container IE. Alternatively, the S-NODE RECONFIGURATION COMPLETE message may indicate that the configuration requested by the S-NG-RAN node has been rejected, in which case the M-NG-RAN node will provide information with sufficient precision in the included Cause IE to enable the S-NG-RAN node to know the reason for an unsuccessful reconfiguration. The M-NG-RAN node may also provide configuration information in the M-NG-RAN node to S-NG-RAN node Container IE.

Upon reception of the S-NODE RECONFIGURATION COMPLETE message the S-NG-RAN node stops the timer TXn_{DCoverall}.

TXn_{DCoverall} specifies the maximum time in the S-NG-RAN node for either the S-NG-RAN node initiated S-NG-RAN node Modification procedure or the protection of the NG-RAN actions necessary to configure UE resources at S-NG-RAN node Addition or M-NG-RAN node initiated S-NG-RAN node Modification.

Since the expected time between the transmission of an SN Addition Request and reception of an SN Reconfiguration Complete is rather short, and because in CHO the UE may take longer to access a candidate target MN, or not even come, current procedures may lead to many unintended SN Releases from the candidate target SN, which may create quite many race conditions, e.g., the candidate target MN having to repeatedly modify its CHO configurations towards the source MN.

In addition to this problem, when a target MN candidate transmits the Handover Request Acknowledge message in response to a CHO, in the event that decides to keep or change the SN, legacy procedures define that the source MN releases the SN. However, in the CHO case, that is not the desired behavior as the equivalent changes at the UE are only performed when the conditions are fulfilled.

Following are described novel techniques for addressing these problems. While described and explained in the context of 3GPP MR-DC, it should be appreciated that the inventive concepts, techniques, and apparatuses described herein include the use of these same and similar techniques in the context of EN-DC, and in the context of multi-connectivity more generally. Thus, the term “multi-connectivity” could be substituted for each use of the term “MR-DC” in any of the following.

In some of the discussion that follows, techniques are explained with respect to a “first network node,” a “second network node,” a “third network node,” and a “fourth network node.” These labels should be understood as purely nominal, and are used for convenience, and should not be understood as indicating a particular order or priority. In the descriptions below, the term “first network node” is used to refer to a network node, e.g., a gNB or eNB, operating as a source MN in multi-connectivity operation with a UE. The “second network node” is a network node, e.g., a gNB or eNB, operating as a source SN in the same multi-connectivity operation. The “third network node” is a network node, e.g., a gNB or eNB, acting as a target MN for a conditional handover (CHO) according to the presently disclosed techniques, while the “fourth network node” is a network node, e.g., a gNB or eNB, acting as a target SN for the conditional handover.

In more detail, below are examples of possible correspondences:
First network node may correspond to (e.g., operate as) one of the following: a Source Master Node (MN), S-MN, Source gNodeB, source eNodeB, Source NG-RAN node, an M-NG-RAN node indicating a gNodeB (e.g., connected to 5GC) operating in MR-DC as an MN, and associated to NG-RAN; an M-NG-RAN node indicating an ng-eNodeB (e.g., connected to 5GC) operating in MR-DC as an MN, and associated to NG-RAN; an LTE eNodeB connected to EPC operating a MeNodeB or MeNB
Second network node may correspond (e.g., operate as) one of the following: to a Source Secondary Node (SN), S-SN, Source Secondary gNodeB (SgNB), source Secondary eNodeB (SeNB), Secondary Source NG-RAN node, etc.
Third network node: may correspond to (e.g., operate as) a target candidate node, candidate target node, target node, target candidate gNodeB, target candidate eNodeB, target candidate NG-RAN node, candidate target gNodeB, candidate target eNodeB, candidate target NG-RAN node, target gNodeB, target eNodeB, target NG-RAN node.
Fourth network node: may correspond to (e.g., operate as) a target candidate Secondary Node (SN), candidate target SN, target SN, target candidate S-gNodeB, target candidate S-eNodeB, target candidate S-NG-RAN node, candidate target S-gNodeB, candidate target S-eNodeB, candidate target S-NG-RAN node, target S-gNodeB, target S-eNodeB, target S-NG-RAN node.

Aspects of the invention correspond to methods specific to each of these network nodes, as detailed below. Several embodiments relate to CHO preparation, as discussed immediately below.

A first embodiment comprises a method performed at a first network node operating as Source MN, the method comprising:
determining to configure a UE with a conditional reconfiguration (e.g., Conditional Handover—CHO), wherein the UE is operating in MR-DC with the first network node as Master Node (e.g., Source MN, S-MN);
transmitting a HANDOVER REQUEST message to a third network node (which is a candidate target node, e.g., a target gNodeB) including an indication that the procedure is for CHO;
receiving a HANDOVER REQUEST ACKNOWLEDGE message from the third network node (which is a candidate target node, e.g., a target gNodeB), the message possibly including information that the SN is to be kept upon CHO execution;
delaying the transmission of an SN RELEASE REQUEST message to a second network node operating as Source Secondary Node SN (S-SN);
configuring the UE with CHO, including configuration provided from both the fourth (e.g., operating as SN candidate target) and the third network nodes.

A related embodiment comprises a method performed at a third network node operating as candidate target MN, the method comprising:
receiving a HANDOVER REQUEST message to from a first network node including an indication that the procedure is for CHO;
transmitting an SN Addition Request to a fourth network node (e.g., operating as SN Candidate target), including an indication that request is for a CHO;
receiving an SN Addition Request Acknowledge from the fourth network node (e.g., operating as SN Candidate target);
Transmitting a HANDOVER REQUEST ACKNOWLEDGE message to the first network node (which is the source MN, e.g., a source gNodeB), the message possibly including information that the SN is to be kept upon CHO execution;

Another related embodiment comprises a method performed at a fourth network node operating as Candidate target SN, the method comprising:
Receiving an SN Addition Request from a third network node operating as Candidate target MN, including an indication that request is for a CHO;
Setting a supervision timer to a value based on the indication that the request is for a CHO
   In some embodiments, upon determining that the SN Addition Request is for a CHO candidate target MN, the third network node sets its supervision timer to a value that is longer than the value it would set for a legacy HO and/or a legacy SN addition.
Transmitting an SN Addition Request Acknowledge to the third network node operating as Candidate target MN;
Starting the supervision timer upon transmitting the message to the third network node.

In some embodiments, upon determining that the SN Addition Request is for a CHO candidate target MN, the third network node may reserve resources for the UE taking into account that the UE may connect after a longer time compare to legacy SN Addition or may not connect at all.

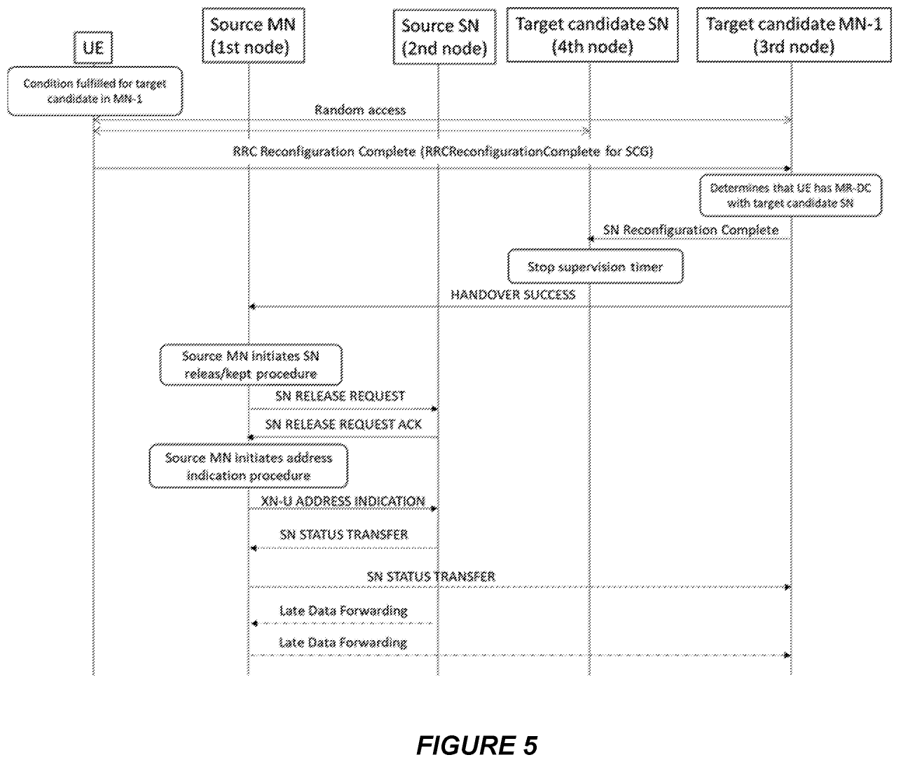

FIG. 4 shows an example of the method for the CHO preparation part. As shown in the figure, a UE is initially connected to a source MN and a source SN. The source MN determines to configure CHO and sends a handover request message to a target candidate master node (third network node), with the handover request message including an indication that the request is for a CHO. The target candidate master node sends an SN ADDIDITION REQUEST message to a target candidate SN (fourth network node), with that message including an indication that the request is for CHO and an indication of whether the SN is being kept. A supervision timer is set by the target candidate SN, with the value being adjusted based on the handover at issue being a CHO. The target candidate SN also sends an SN ADDITION REQUEST ACK message to the target candidate master node.

The target candidate master node than sends a HANDOVER REQUEST ACKNOWLEDGE message to the source master node. This message may include an indication that the acknowledgment is in response to a CHO and may include an indication of whether the SN is being kept. The source master node delays the transmission of a SN RELEASE REQUEST, as discussed above, since the handover is conditional.

The source MN then sends the RRC Reconfiguration to the UE, with an indication that it is for CHO. This RRC Reconfiguration may be as provided by the target candidate MN, in the acknowledgment of the handover request. The UE responds with an RRC Reconfiguration Complete message, to acknowledge the RRC Reconfiguration, and then monitors the relevant trigger/execution conditions to determine if and when to execute the CHO.

Other embodiments are directed to CHO execution. An example embodiment is a method performed at the first network node, operating as Source MN, the method comprising:
receiving a second message from the third node, which is a target MN (e.g., candidate target gNodeB for which CHO has been configured); and
transmitting an SN RELEASE REQUEST message to a second network node operating as a Source SN (S-SN), e.g., a Source Secondary gNodeB (Source SgNB), possibly including an indication that the SN is kept; and
receiving an SN RELEASE REQUEST ACKNOWLEDGE message from the second network node operating as a Source SN (S-SN) e.g., a Source Secondary gNodeB (Source SgNB).

In some embodiments, the second message is a HANDOVER SUCCESS message. Some embodiments may further comprise determining that late data forwarding is to be performed. In these embodiments, if data forwarding is needed, the first network node (e.g., Source MN) initiates an address indication procedure with the second network node; receives an SN Status Transfer from the second network node operating as Source SN;

transmits an SN Status Transfer to the third network node (e.g., candidate target node, target gNodeB; receives forwarded data from the second network node operating as Source SN; and forwards data to the third network node (e.g., target gNodeB).

Another embodiment is a method performed at a second network node operating as Source SN, the method comprising:
receiving an SN RELEASE REQUEST message from the first network node operating as a Source MN (S-MN), possibly including an indication that the SN is kept; and
transmitting an SN RELEASE REQUEST ACKNOWLEDGE message to the first network node operating as a Source MN (S-MN).

Some embodiments may comprise any or all of:
receiving an Xn-U Address Indication from the first network node operating as a Source MN (S-MN);
determining that late data forwarding is to be performed;
transmitting an SN Status Transfer to the first network node operating as Source MN; and
forwarding data to the first network node (e.g., Source gNodeB, Source MN).

Another embodiment is a method performed at the third network node (operating as a candidate target MN), the method comprising:
receiving, from the UE, an RRC Reconfiguration Complete message;
   the message may contain within another RRC Reconfiguration Complete message associated to the SCG reconfiguration;
determining that the incoming UE has been configured with CHO and has an associated MR-DC related configuration for a fourth network node (operating as SN candidate target);
transmitting an SN Reconfiguration Complete message to the fourth network node (operating as SN candidate target);
   that includes the RRC reconfiguration Complete message associated to the SCG reconfiguration, and transmitted from the UE;
transmitting a message to the first node, which is a source MN (e.g., source gNodeB that has configured CHO);
   in one embodiment the message is a HANDOVER SUCCESS message.
receiving forwarded data from the first node; and
transferring forwarded SN-terminated data bearers to the fourth node.

Still another embodiment is a method performed at the fourth network node (operating as a candidate target SN), the method comprising:
receiving an SN Reconfiguration Complete message from the third network node (operating as MN candidate target);
   that includes the RRC reconfiguration Complete message associated to the SCG reconfiguration, and transmitted from the UE;
stopping the supervision timer; consider the UE context as active; and
receiving forwarded SN-terminated bearers' data from the third node.

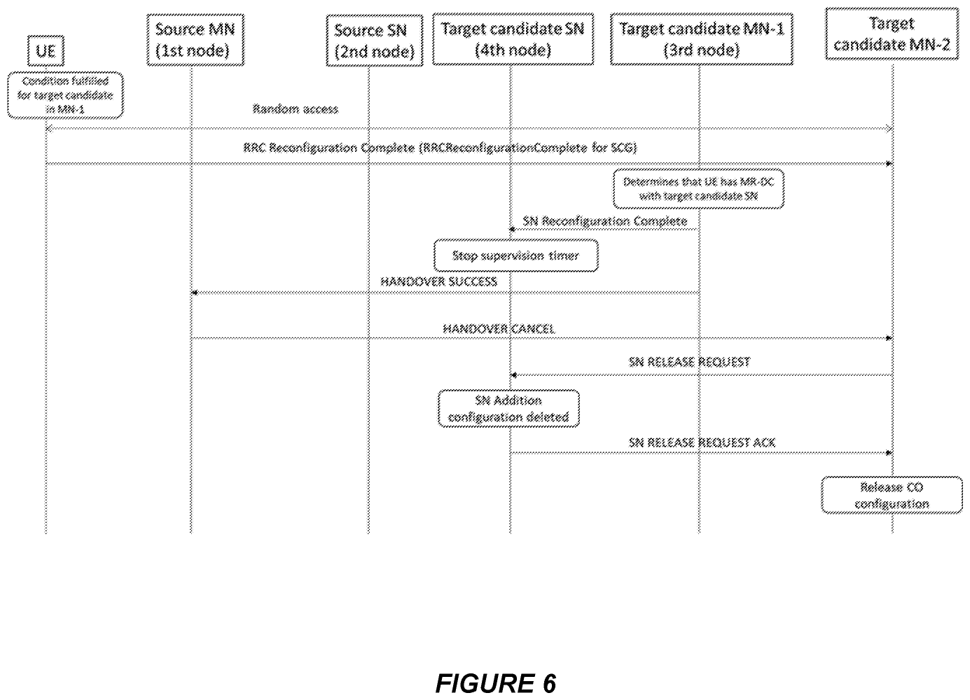

An example execution procedure is summarized in FIG. 5. As seen in the figure, the UE determines that a condition is fulfilled for handover to the target candidate MN (third network node). The UE then initiates a random access process with each of the target candidate MN and the target candidate SN (fourth network node), per the RRC Reconfiguration message it previously received. The UE then sends an RRC Reconfiguration Complete message to the target candidate MN.

The target candidate MN determines that the UE has MR-DC with the target candidate SN and sends an SN Reconfiguration complete message to the target candidate SN, which stops its supervision timer in response. The target candidate MN also sends a HANDOVER SUCCESS message to the source MN, which can then initiate the SN release procedure, if the source SN is not being kept. In this case, the source MN sends an SN RELEASE REQUEST message to the source SN, which responds with a SN RELEASE REQUEST ACK message. The source MN then initiates an address indication procedure, sending an XN-U ADDRESS INDICATION message to the source SN, which responds with an SN STATUS TRANSFER message. The source MN forwards the SN STATUS TRANSFER message to the target candidate MN and forwards any late data that it receives from the source SN to the target candidate MN.

Other embodiments of the presently disclosed techniques are directed to canceling CHO, in those targets that were not selected for the CHO. One example embodiment is a method executed in a source MN, the method comprising:
receiving a message from a first candidate target MN that the UE executes CHO;
   in one embodiment, the message is a Handover Success message; and
transmitting to a second candidate target MN where the UE has not executed CHO a message, the message comprising an indication that CHO configuration(s) are to be released.

Another embodiment is a method executed in a candidate target MN, the method comprising:
receiving from a source MN a message, the message comprising an indication that CHO configuration(s) are to be released;
determining if the CHO configuration for the associated UE has an associated target SN candidate;
triggering an SN Release procedure, by transmitting an SN Release Request message to the candidate target SN; and
receiving an SN Release Request Acknowledge from the candidate target SN.

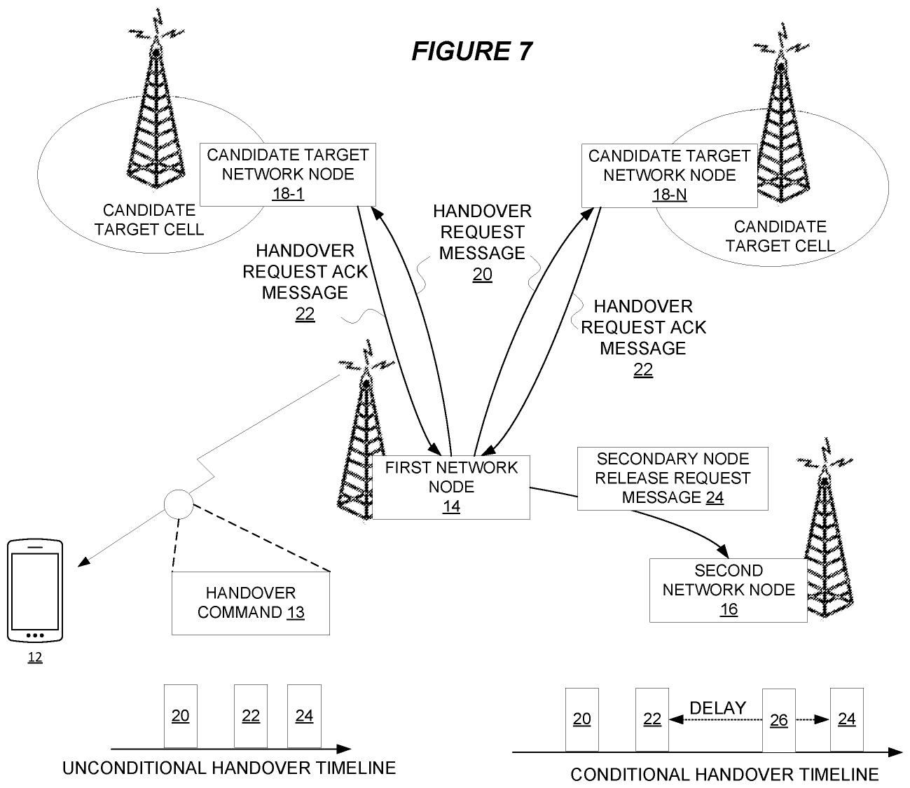

An example illustration of these embodiments is provided in FIG. 6. As seen in the figure, the UE determines that a condition is fulfilled for handover to the target candidate MN (third network node). The UE then initiates a random access process with the target candidate MN, per the RRC Reconfiguration message it previously received. The UE then sends an RRC Reconfiguration Complete message to the target candidate MN. The target candidate MN determines that the UE has MR-DC with the target candidate SN and sends an SN Reconfiguration complete message to the target candidate SN, which stops its supervision timer in response. The target candidate MN also sends a HANDOVER SUCCESS message to the source MN.

The source MN then determines that it had previously configured another target candidate master node for CHO of the UE, target candidate MN-2. The source MN sends a HANDOVER CANCEL message to target candidate MN-2. Target candidate MN-2 then sends an SN RELEASE REQUEST to the target candidate SN that was not selected for CHO. The target candidate SN deletes the SN Addition configuration that it previously received (see FIG. 4) and responds with an SN RELEASE REQUEST ACK message. The target candidate MN-2 then releases the CHO configuration for the UE.

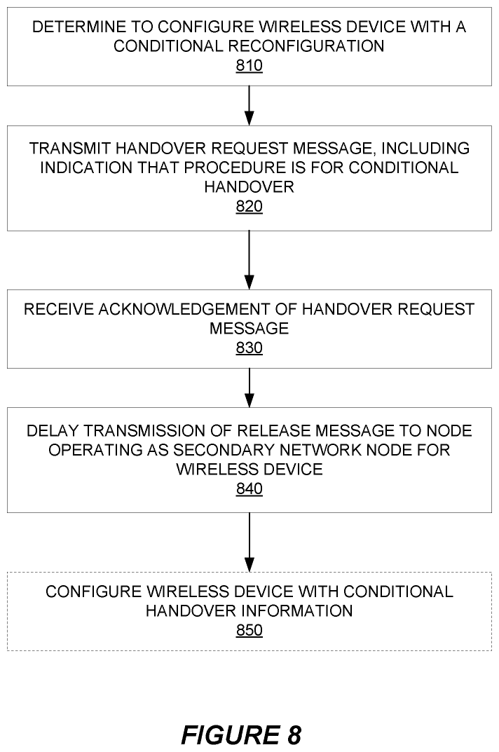

To provide a system-level context for the techniques described herein, FIG. 7 shows a wireless device 12 configured for use in a wireless communication network according to some embodiments. The wireless device 12 is configured for multi-connectivity operation. Multi-connectivity in this regard refers to the simultaneous connection of the wireless device 12 (e.g., at a radio resource control, RRC, layer) to multiple different radio network nodes, or to multiple different cells provided by different radio network nodes. The multiple different radio network nodes or cells may use the same radio access technology (e.g., both may use Evolved Universal Terrestrial Radio Access (E-UTRA) or both may use New Radio (NR)). Or, the multiple different radio network nodes or cells may use different radio access technologies, e.g., one may use E-UTRA and another may use NR.

One example of multi-connectivity is dual connectivity (DC) in which the wireless device 12 is simultaneously connected to two different radio network nodes, or to two different cells provided by two different radio network nodes. In this case, the wireless device 12 may be configured with a so-called master cell group (MCG) and a secondary cell group (SCG), where the MCG includes one or more cells provided by the radio network node acting as a master node (MN) and the SCG includes one or more cells served by the radio network node acting as a secondary node (SN). The master node may be a master in the sense that it controls the secondary node and/or provides the control plane connection to the core network. For example, E-UTRA-NR (EN) DC refers to where the master node uses E-UTRA and the secondary node uses NR, whereas NR-E-UTRA (NE) refers to where the master node uses NR and the secondary node uses E-UTRA. For example, in multi-connectivity operation, a wireless device 12 with multiple receivers (Rx) and/or transmitters (Tx) may utilize radio resources amongst one or more radio access technologies (e.g., New Radio, NR, and/or E-UTRA) provided by multiple distinct schedulers connected via a non-ideal backhaul. Multi-radio dual connectivity (MR-DC) in this regard is a generalization of Intra-E-UTRA DC, where a multiple Rx/Tx wireless device may be configured to utilize resources provided by two different nodes connected via a non-ideal backhaul, one providing NR access and the other one providing either E-UTRA or NR access. One node acts as the master node (MN) and the other as a SN. E-UTRAN for instance supports MR-DC via E-UTRA-NR dual connectivity (EN-DC), in which a wireless device is connected to one eNB that acts as a MN and one en-gNB that acts as a secondary node (SN). Either way, in MR-DC, the wireless device 12 may have a single Radio Resource Control (RRC) state, based on the MN RRC and a single control plane connection towards the core network.

In this context, FIG. 7 also shows a first network node 14 that operates as a master network node (i.e., MN) for multi-connectivity operation of the wireless device 12. FIG. 7 further shows a second network node 16 that operates as a secondary network node (i.e., SN) for multi-connectivity operation of the wireless device 12. During multi-connectivity operation, though, the first network node 14 decides to configure the wireless device 12 for handover with respect to one or more candidate target nodes 18-1 . . . 18-N. As a result of the handover, the master network node for the device's multi-connectivity operation would change from being the first network node 14 to being one of the candidate target network nodes 18-1 . . . 18-N. Towards this end, the first network node 14 as shown in FIG. 7 transmits a handover request message 20 to each of one or more of the candidate target nodes 18-1 . . . 18-N. The handover request message 20 requests preparation of resources at the candidate target node for the handover of the wireless device 12. Each candidate target node may return a response to the handover request message 20, to inform the first network node 14 whether resources were prepared for the handover at that candidate target node. As shown in this example, each candidate target network node 18-1 . . . 18-N responds with a respective handover request acknowledgment (ACK) message 22 that informs the first network node 14 about prepared resources at the respective candidate target node for the handover. With resources prepared for the handover, the master network node 14 may transmit a handover command 13 to the wireless device 12, e.g., in the form of an RRC reconfiguration.

Notably, though, the first network node 14 according to some embodiments herein advantageously preserves the wireless device's service from the second network node 16 in multi-connectivity operation until the wireless device has executed handover to a candidate target node. The first network node 14 in this regard accounts for whether the handover is conditional or not. If, for example, the wireless device 12 is to execute the handover unconditionally in response to the handover command 13, the first network node 14 may go ahead and request release of resources for the wireless device 12 at the second network node 16, by transmitting a secondary node release request message 24 to the second network node 16 in response to receiving the handover request acknowledge message(s) 20. This is shown at the bottom left of FIG. 7, in the “unconditional handover timeline.” But, if the handover is a conditional handover such that the wireless device 12 is to execute the handover only upon the wireless device detecting fulfillment of a condition, the first network node 14 may delay transmitting the secondary node release request message 24 to the second network node 16, e.g., until the master network node receives a message 26 indicating the conditional handover has been executed. This is shown at the bottom right of FIG. 7, in the “conditional handover timeline.” The message 26 may for instance be a handover success message that indicates the wireless device 12 has successfully accessed a candidate target node for the handover. Regardless, delaying the secondary node release request message 24 may advantageously avoid prematurely releasing resources for the wireless device 12 at the second network node 16, so that those resources remain intact during the interim between when the wireless device 12 begins monitoring for fulfillment of the condition for executing the conditional handover and when the wireless device 12 executes the conditional handover upon such fulfillment. Some embodiments may thereby allow the wireless device 12 to achieve increased data rates with multi-connectivity operation, while also enjoying improved robustness of reconfiguration (e.g., handover) against failure.

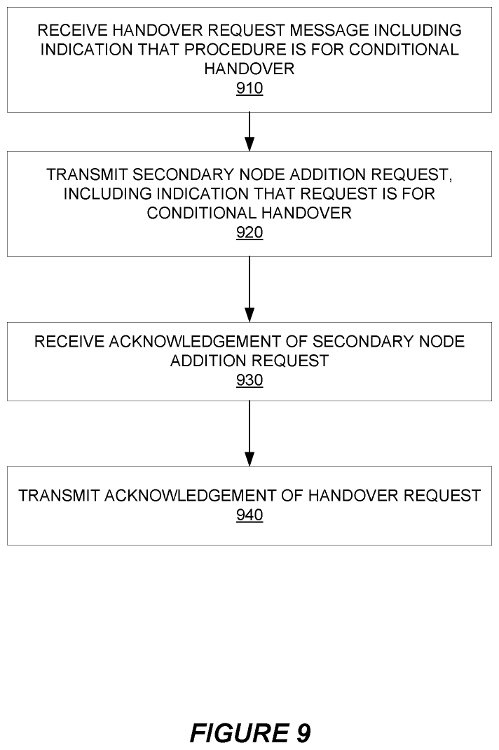

In view of the above modifications and variations, FIG. 8 depicts a method as implemented by a first network node, configured to operate as a master network node for multi-connectivity operation of a wireless device, in accordance with particular embodiments. The method in some embodiments includes determining to configure the wireless device with a conditional reconfiguration (Block 810). The method may further comprise transmitting a handover request message to a third network node, including an indication that the procedure is for conditional handover (Block 820). The method may further comprise receiving an acknowledgment of the handover request message (Block 830) and delaying transmission of a release message to a second network node operating as a secondary network node for the wireless device (Block 840). The method may still further comprise configuring the wireless device with conditional handover information, including configuration information provided from the third network node (Block 850).

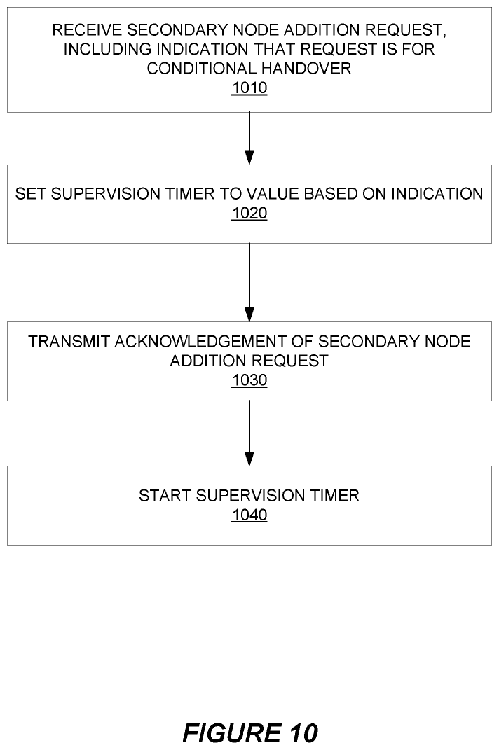

FIG. 9 depicts a method performed by a third network node, configured to operate as a target master node candidate for multi-connectivity operation of a wireless device, in accordance with other particular embodiments. The method includes receiving a handover request message from a first network node, the handover request message including an indication that the procedure is for conditional handover (Block 910). The method further includes transmitting a secondary node addition request to a fourth network node, including an indication that the request is for a conditional handover (Block 920). The method still further includes receiving an acknowledgment of the secondary node addition request (Block 930) and transmitting an acknowledgment of the handover request to the first network node (Block 940).

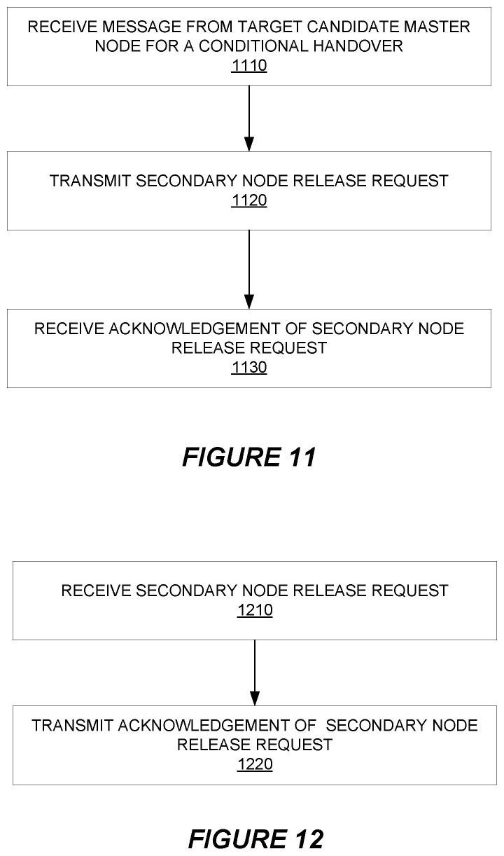

FIG. 10 depicts a method performed by a fourth network node, configured to operate as a candidate target secondary node for a wireless device, in accordance with other particular embodiments. The method includes receiving a secondary node addition request from a third network node, including an indication that the request is for a conditional handover (Block 1010). The method further includes setting a supervision timer to a value based on the indication that the request is for a conditional handover (Block 1020). The method still further includes transmitting an acknowledgment of the secondary node addition request to the third network node (Block 1030) and starting the supervision timer (Block 1040).

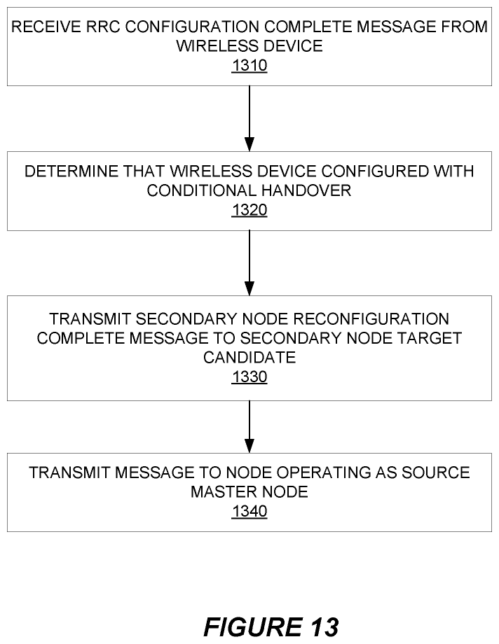

FIG. 11 depicts a method performed by a first network node, configured to operate as a master network node for multi-connectivity operation of a wireless device, in accordance with other particular embodiments. The method includes receiving a message from a third network node, operating as a candidate target master node for a conditional handover for which the wireless device has been configured (Block 1110). The method further includes transmitting a secondary node release request to a second network node operating as a source secondary node for the wireless device (Block 1120). The method still further includes receiving, from the second network node, an acknowledgment of the secondary node release request (Block 1130).

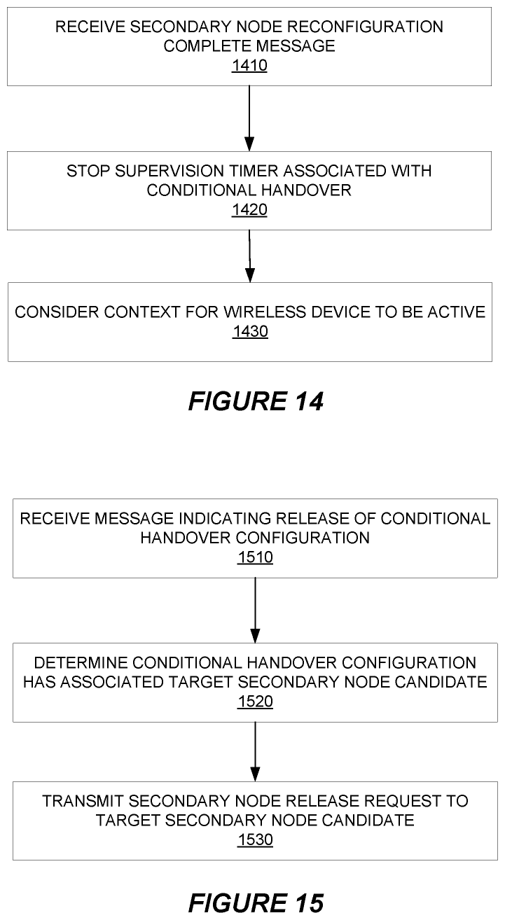

FIG. 12 depicts a method performed by a second network node, operating as a source secondary node for a wireless device operating in multi-connectivity, in accordance with other particular embodiments. The method includes receiving a secondary node release request message from a first network node operating as a source master node for the wireless device (Block 1210). The method further includes transmitting, to the first network node, an acknowledgment of the secondary node release request (Block 1220).

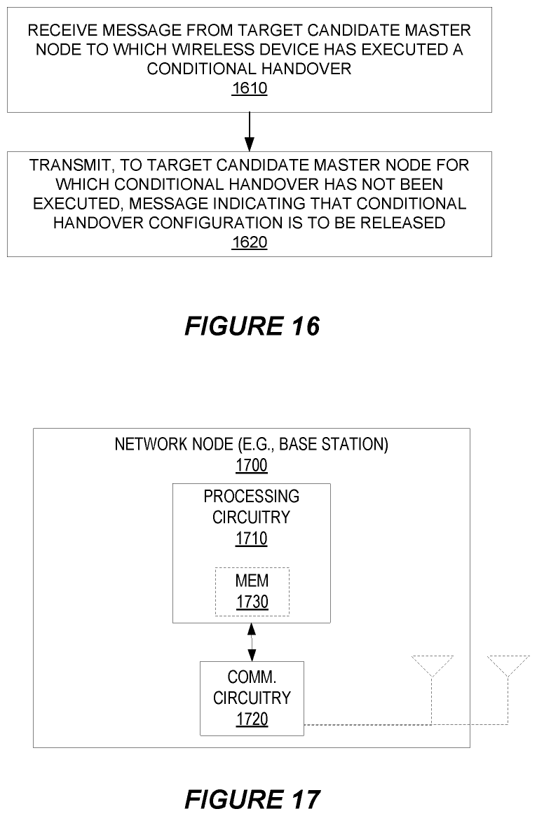

FIG. 13 depicts a method performed by a third network node, configured to operate as a target master node candidate for multi-connectivity operation of a wireless device, in accordance with other particular embodiments. The method includes receiving, from a wireless device, an RRC reconfiguration complete message (Block 1310). The method further includes determining that the wireless device has been configured with a conditional handover and has an associated multi-connectivity-related configuration for a fourth network node, operating as a secondary node candidate target (Block 1320). The method still further includes transmitting a secondary node reconfiguration complete message to the fourth network node (Block 1330), and transmitting a message to a first network node, operating as a source master node for the wireless device (Block 1340).

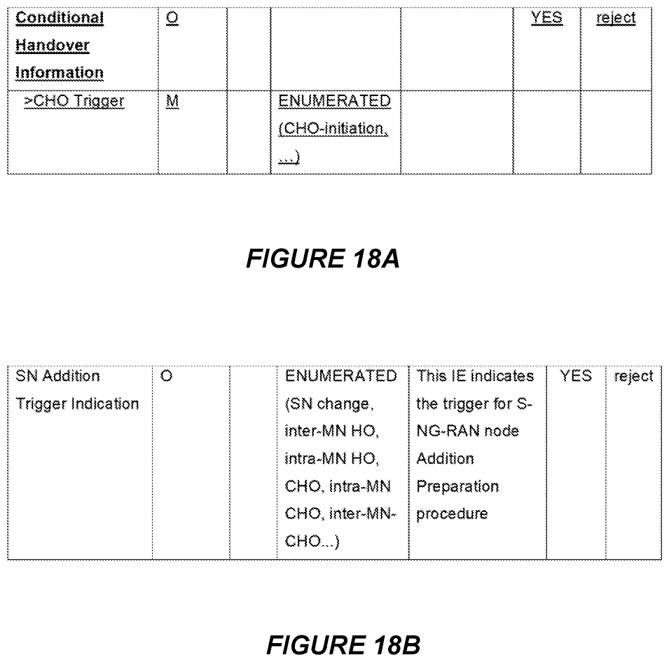

FIG. 14 depicts a method performed by a fourth network node, configured to operate as a candidate target secondary node for a wireless device, in accordance with other particular embodiments. The method includes receiving, from a third network node operating as a master node candidate target for conditional handover of the wireless device, a secondary node reconfiguration complete message (Block 1410). The method further includes stopping a supervision timer associated with conditional handover of the wireless device (Block 1420). The method still further includes considering a context associated with the wireless device to be active (Block 1430).

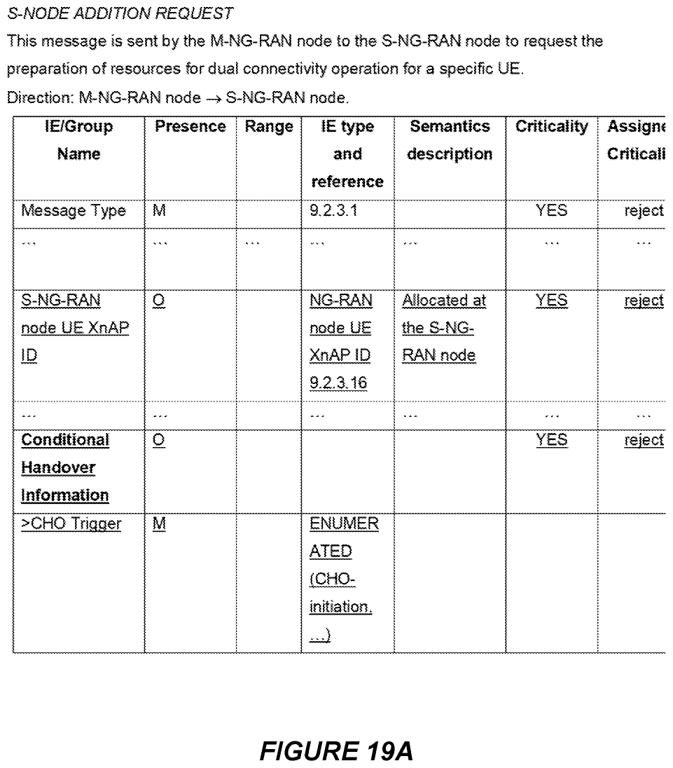

FIG. 15 depicts a method performed by a network node configured as a candidate target master node for multi-connectivity conditional handover of a wireless device, in accordance with other particular embodiments. The method includes receiving, from a source master node for the wireless device, a message indicating that a conditional handover configuration for the wireless device is to be released (Block 1510). The method further includes determining that the conditional handover configuration for the wireless device has an associated target secondary node candidate for the conditional handover (Block 1520). The method still further includes transmitting a secondary node release request message to the target secondary node candidate (Block 1530).

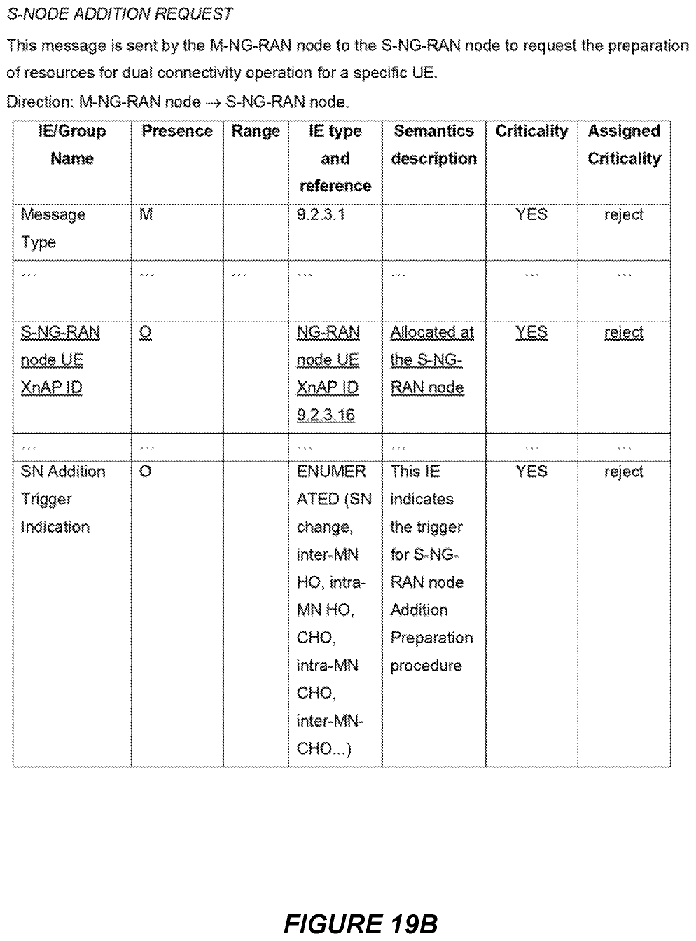

FIG. 16 depicts a method performed by a first network node, configured to operate as a master network node for multi-connectivity operation of a wireless device, in accordance with other particular embodiments. The method includes receiving a message from a candidate target master node to which the wireless device has executed a conditional handover (Block 1610). The method further includes transmitting, to a candidate target master node for which conditional handover of the wireless device has been configured but not executed, a message indicating that a conditional handover configuration for the wireless device is to be released (Block 1620).

Embodiments herein also include corresponding apparatuses. Embodiments herein for instance include a network node (e.g., a first network node, a second network node, a third network node, or a fourth network node) configured to perform any of the steps of any of the embodiments described herein. Note that any of the network node apparatuses described herein may be configured in such a way that they can play any of the roles of first, second, third, or fourth network nodes, as described herein, at different times, or even at the same time with respect to different wireless devices.

Embodiments also include a network node (e.g., a first network node, a second network node, a third network node, or a fourth network node) comprising processing circuitry and power supply circuitry. The processing circuitry is configured to perform any of the steps of any of the embodiments described herein. The power supply circuitry is configured to supply power to the network node.

Embodiments further include a network node (e.g., a first network node, a second network node, a third network node, or a fourth network node) comprising processing circuitry. The processing circuitry is configured to perform any of the steps of any of the embodiments described herein. In some embodiments, the network node further comprises communication circuitry.

Embodiments further include a network node (e.g., a first network node, a second network node, a third network node, or a fourth network node) comprising processing circuitry and memory. The memory contains instructions executable by the processing circuitry whereby the network node is configured to perform any of the steps of any of the embodiments described herein.

More particularly, the apparatuses described above may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

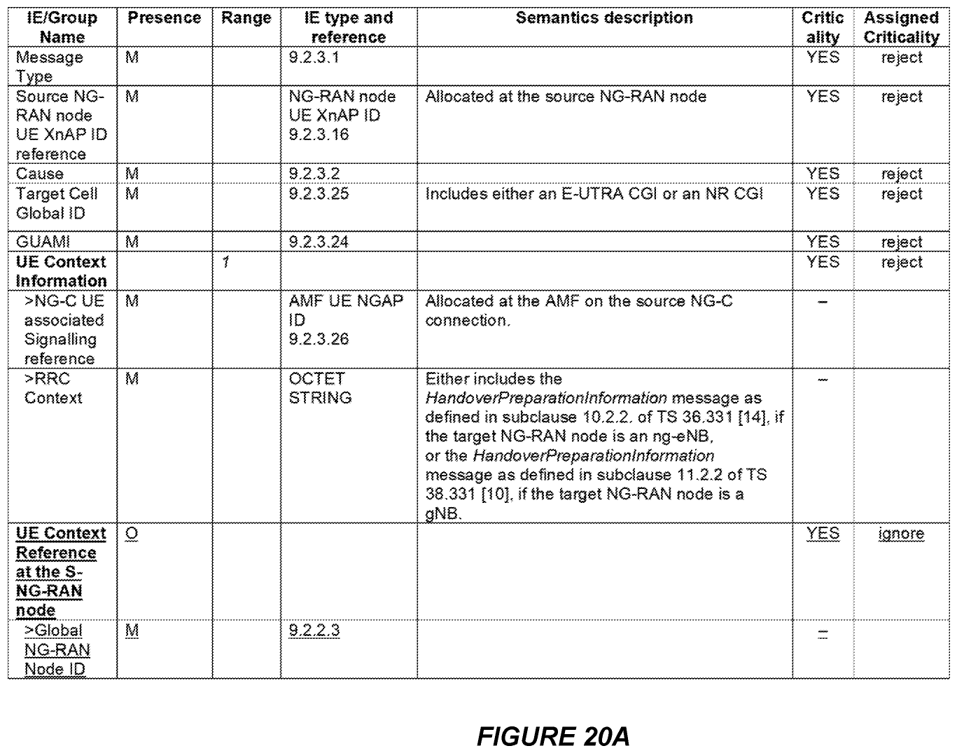

FIG. 17, for example illustrates a network node 1700 as implemented in accordance with one or more embodiments. As shown, the network node 1700 includes processing circuitry 1710 and communication circuitry 1720. The communication circuitry 1720 (e.g., radio circuitry) is configured to transmit and/or receive information to and/or from one or more other nodes, e.g., via any communication technology. Such communication may occur via one or more antennas that are either internal or external to the network node 1700. The processing circuitry 1710 is configured to perform processing described above, such as by executing instructions stored in memory 1730. The processing circuitry 1710 in this regard may implement certain functional means, units, or modules.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

Additional details and variations of the embodiments described above will be provided below. At least some of these embodiments may be described as applicable in certain contexts and/or wireless network types for illustrative purposes, but the embodiments are similarly applicable in other contexts and/or wireless network types not explicitly described.

The solutions detailed below address scenarios where a UE is configured with Multi-Radio Dual Connectivity (MR-DC) when it receives a conditional handover (CHO) configuration. The embodiments described herein are focused on NR-DC (i.e., when both master and secondary node are NR gNBs), but the solutions are equally applicable to other DC scenarios (e.g., NE-DC, (NG)EN-DC and LTE DC).

Herein, the term Conditional Handover (CHO) is repeatedly use. Other terms may be considered as synonyms such as conditional reconfiguration, or Conditional Configuration (since the message that is stored and applied upon fulfillment of a condition is an RRCReconfiguration or RRCConnectionReconfiguration). Terminology wise, one could also interpret CHO in a broader sense.

The principle for the configuration is the same with configuring triggering/execution condition(s) and a reconfiguration message to be applied when the triggering condition(s) are fulfilled.

### CHO Preparation Techniques

An embodiment comprises a method performed at a first network node operating as Source MN, the method comprising:
determining to configure a UE with a conditional reconfiguration (e.g., Conditional Handover—CHO), wherein the UE is operating in MR-DC with the first network node as Master Node (e.g., Source MN, S-MN);
   the determination may be based on measurement reports received from the UE at the Source MN, including measurements for cells associated to neighbour nodes (e.g., neighbour gNodeB(s)) that may be candidate target nodes for CHO;
transmitting a HANDOVER REQUEST message to a third network node (which is a candidate target node, e.g., a target gNodeB) including an indication that the procedure is for CHO;
   in one embodiment the MN transmitting a HANDOVER REQUEST message to a single candidate target including an indication that the procedure is for CHO;
      For example, a candidate target may have one target cell candidate associated to it.
   in one embodiment the MN transmitting HANDOVER REQUEST messages to a single candidate target including an indication that the procedure is for CHO;
      For example, a candidate target may have multiple target cells candidates associated to it. In that case there may be one HANDOVER REQUEST message transmitted for each target cell candidate.
   in one embodiment the MN transmitting HANDOVER REQUEST messages to multiple candidate targets including an indication that the procedure is for CHO;
      For example, a candidate target may have multiple target cells candidates associated to it. In that case there may be one HANDOVER REQUEST message transmitted for each target cell candidate. And, there may be multiple candidate cells in different candidate target nodes.
   in one embodiment the source MN transmitting a HANDOVER REQUEST message for each UE and for each candidate target cell, including an indication that the procedure is for CHO;
      The determination at the source MN concerning which cells to request CHO for can be based on measurements reported by the UE. For example, if the UE reports that neighbour cells A, B, C are the best in terms of RSRP, and/or RSRQ and/or SINR, these may be the cells the source MN requests the candidate target MN to configure CHO for. And, for each of these candidate cells, the source MN transmits a HO REQUEST message with an indication that this is for CHO.
   in one embodiment the source MN transmitting a HANDOVER REQUEST message for each UE and for each candidate target cell, including both MCG and SCG configuration. The source MN includes the source SN UE XnAP ID (or equivalent interface protocol identification for the UE), SN ID (node identifier for the SN) and the UE context in the source SN in the Handover Request message. That is included to indicate SN related information to the candidate target MN, which may either determine to keep, release or change the SN upon CHO execution.
receiving a HANDOVER REQUEST ACKNOWLEDGE message from the third network node (which is a candidate target node, e.g., a target gNodeB), the message possibly including information that the SN is to be kept upon CHO execution.
   in one embodiment the MN receiving one HANDOVER REQUEST ACKNOWLEDGE from a single candidate target;
      For example, a candidate target may have one target cell candidate associated to it.
   in one embodiment the MN receiving HANDOVER REQUEST ACKNOWLEDGE messages from a single candidate target node;
      For example, a candidate target may have multiple target cells candidates associated to it. In that case there may be one HANDOVER REQUEST ACKNOWLEDGE message received for each target cell candidate.
   in one embodiment the MN receiving HANDOVER REQUEST ACKNOWLEDGE messages from multiple candidate targets;
      For example, a candidate target may have multiple target cells candidates associated to it. In that case there may be one HANDOVER REQUEST ACKNOWLEDGE message received for each target cell candidate. And, there may be multiple candidate cells in different candidate target nodes.
   in one embodiment the source MN receiving HANDOVER REQUEST ACKNOWLEDGE messages including an indication that the SN is to be kept;
      Differently from the legacy handover case, in this CHO scenario the indication is indicating that the SN is to be kept upon CHO execution; And, the actions of the source Mn accordingly are to be only executed upon CHO execution, not upon reception of the message.
delaying the transmission of an SN RELEASE REQUEST message to a second network node operating as Source Secondary Node SN (S-SN);
   in one embodiment, the method comprising the delaying to trigger (i.e., delaying to initiate, delaying to start) an SN release procedure e.g., upon reception of the HANDOVER REQUEST ACKNOWLEDGE.
      The SN release procedure may correspond to an MeNB initiated SgNB Release procedure as defined in TS 36.423, sub-clause 8.7.9, e.g., in the case the MN is an LTE node and the SN is an NR node (for a UE operating in EN-DC).
      The SN release procedure may correspond to an M-NG-RAN node initiated S-NG-RAN node Release procedure as defined in TS 38.423, sub-clause 8.3.6, e.g., in the case the MN is an NR node and the SN is an NR node (for a UE operating in NR-DC).
   In one embodiment the delaying (or refraining) action is performed upon determining that the HANDOVER REQUEST ACKNOWLEDGE has been received in response to a HANDOVER REQUEST for a conditional reconfiguration (e.g., Conditional Handover);
   The SN RELEASE REQUEST message may be at least one of the following messages:
      The SN RELEASE REQUEST message may correspond to an SGNB RELEASE REQUEST message as defined in TS 36.423 e.g., in the case the MN is an LTE node and the SN is an NR node (for a UE operating in EN-DC).
      The SN RELEASE REQUEST message may correspond to an S-NODE RELEASE REQUEST message as defined in TS 38.423 e.g., in the case the MN is an NR node and the SN is an NR node (for a UE operating in NR-DC).
   In one embodiment:
      if the HANDOVER REQUEST ACKNOWLEDGE has been received in response to a HANDOVER REQUEST for a legacy reconfiguration (e.g., Handover)
         initiating the SN release procedure (if the UE is operating in MR-DC); else,
      else, if the HANDOVER REQUEST ACKNOWLEDGE has been received in response to a HANDOVER REQUEST for a conditional reconfiguration (e.g., Conditional Handover)
         delaying/refraining from initiating the SN release procedure (if the UE is operating in MR-DC); else,
   In one embodiment, monitoring the reception of a first message from one of the candidate targets; upon reception of that first message initiation the SN release procedure (if the UE is operating in MR-DC).
      The reason to add “if the UE is operating in MR-DC” is that the UE may have been reconfigured after the CHO configuration i.e., upon CHO execution the UE may not be any longer operating in MR-DC.
   In one embodiment, delaying the source MN actions for the case the SN is to be kept, if indicated in the HO REQUEST ACKNOWLEDGE message.
      This comprises the transmission of the SN Release Request to the source SN, including an indication that the SN is to be kept for that UE;
      The actions delayed at the source MN are the following: the source MN sends SN Release Request to the (source) SN including a Cause indicating MCG mobility (or, possibly a CHO indication). The (source) SN acknowledges the release request. The source MN indicates to the (source) SN that the UE context in SN is kept, if it receives the indication from the target MN. If the indication as the UE context kept in SN is included, the SN keeps the UE context.
      These actions are delaying until CHO is known to be executed e.g., upon the reception of a Handover Success message (or an equivalent indication) from the candidate target MN that has been accessed by the UE.
configuring the UE with CHO, including configuration provided from both the fourth (e.g., operating as SN Candidate target) and the third network nodes.
   In one embodiment, the method comprising the first network node (e.g., Source MN, S-MN, which may be an LTE eNodeB operating as MN) configuring the UE with Conditional Reconfiguration, such as Conditional Handover (CHO). In other words, the first network node transmits to the UE an RRC Reconfiguration message containing a CHO configuration e.g., the field conditionalReconfiguration of IE ConditionalReconfiguration to be defined in 3GPP TS 38.331.

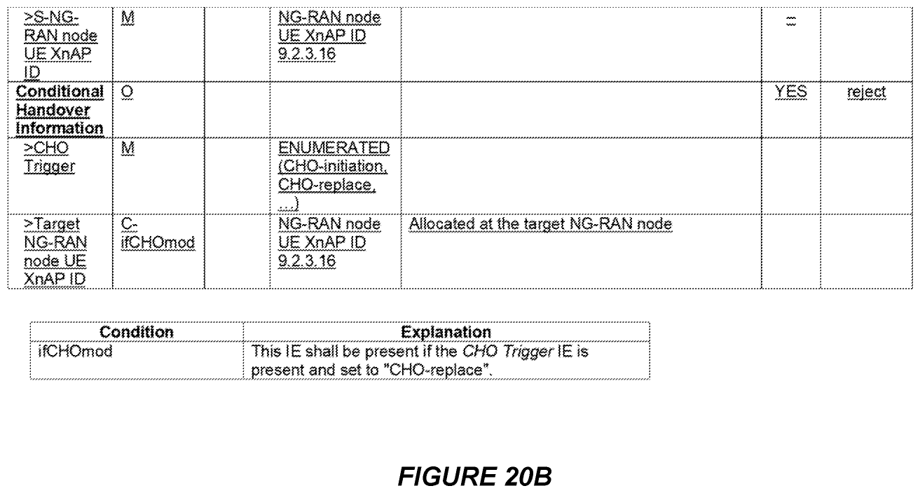

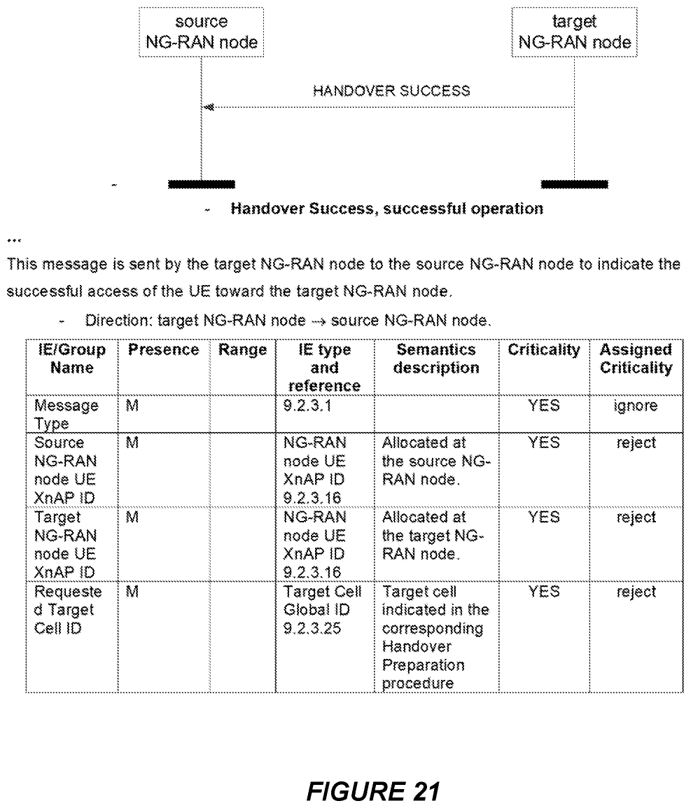

Another embodiment is a method performed at a third network node operating as candidate target MN, the method comprising:
receiving a HANDOVER REQUEST message to from a first network node including an indication that the procedure is for CHO;
   In one embodiment the candidate target MN receiving a HANDOVER REQUEST message for a single candidate target cell including an indication that the procedure is for CHO; For example, a candidate target may have one target cell candidate associated to it.
   In one embodiment the candidate target MN receiving HANDOVER REQUEST messages including an indication that the procedure is for CHO, possibly from multiple source MN(s);
   In one embodiment the source MN receiving HANDOVER REQUEST messages to multiple candidate targets including an indication that the procedure is for CHO;
      For example, a candidate target may have multiple target cells candidates associated to it. In that case there may be one HANDOVER REQUEST message transmitted for each target cell candidate. And, there may be multiple candidate cells in different candidate target nodes.
   In one embodiment the source MN receiving a HANDOVER REQUEST message for each UE and for each candidate target cell, including an indication that the procedure is for CHO;
   In one embodiment, the candidate target MN determines that the HO REQUEST message containing a CHO indication for a given UE, also contains an indication that the UE is operating in MR-DC (e.g., contains an MCG and an SCG configuration, SN terminated bearers, etc.).
      In one embodiment that determination that the UE for which CHO is to be configured is operating in MR-DC, is performed by determining that the HANDOVER REQUEST message includes both MCG and SCG configuration. And, that message also includes the source SN UE XnAP ID (or equivalent interface protocol identification for the UE), SN ID (node identifier for the SN) and the UE context in the source SN in the Handover Request message. That is included to indicate SN related information to the candidate target MN, which may either determine to keep, release or change the SN upon CHO execution.
      Upon that determination step, determine to set the configuration for performing at least one of the following for the UE operating in MR-DC and to be configured with CHO, where the action is to be delaying until CHO execution:
         Release SN;
         Keep SN;
         In one embodiment, the candidate target MN decides to keep the SN; And in addition, it decides to keep the same SpCell of the SCG (PSCell). That may be the case if the candidate target MN is aware that the current PSCell has overlapping coverage for the MCG being configured in the RRCReconfiguration for CHO. In other words, it knows that if the UE executes CHO for the configured MCG, it is likely under the coverage of the currently configured PSCell.
         In one embodiment, the candidate target MN decides to keep the SN; But, decides to change the current SpCell of the SCG (PSCell) to another cell associated to the same SN. That may be the case if the candidate target MN is aware that the current PSCell does not have overlapping coverage for the MCG being configured in the RRCReconfiguration for CHO, but is aware of another cell associated to the SN that has overlapping coverage with the MCG being configured for CHO. In other words, it knows that if the UE executes CHO for the configured MCG, it is likely under the coverage of the new PSCell, also associated to the SN.
         In one embodiment, the determination step to keep the SN e.g., (and in addition configure same PSCell or change to another PSCell in the same SN) is based on measurement information included in the HO REQUEST message, wherein these are measurements reported by the UE.
      Change SN;
         In one embodiment, the candidate target MN decides to change the SN; And in addition, it decides a new candidate target SpCell of the SCG (PSCell). That may be the case if the candidate target MN is aware that the new candidate target PSCell has overlapping coverage for the MCG being configured in the RRCReconfiguration for CHO. In other words, it knows that if the UE executes CHO for the configured MCG, it is likely under the coverage of the newly configured PSCell, associated to the new SN for which the UE is to be changed to upon CHO execution.
   In one embodiment, the candidate target MN determines that the HO REQUEST message containing a CHO indication for a given UE, but does not contain an indication that the UE is operating in MR-DC (e.g., contains an MCG and an SCG configuration, SN terminated bearers, etc.).
      In one embodiment that determination that the UE for which CHO is to be configured is not operating in MR-DC, is performed by determining that the HANDOVER REQUEST message does not include an SCG configuration and/or that message does not include the source SN UE XnAP ID (or equivalent interface protocol identification for the UE), SN ID (node identifier for the SN) or the UE context in the source SN in the Handover Request message.
      Upon that determination step, determine to set the configuration for performing at least one of the following for the UE operating in MR-DC and to be configured with CHO, where the action is to be delaying until CHO execution:
         Addition of an SN;
         In one embodiment, the candidate target MN decides to add an SN; And in addition, it decides a candidate target SpCell of the SCG (PSCell). That may be the case if the candidate target MN is aware that the candidate target PSCell has overlapping coverage for the MCG being configured in the RRCReconfiguration for CHO. In other words, it knows that if the UE executes CHO for the configured MCG, it is likely under the coverage of the newly configured PSCell, associated to the new SN for which the UE is to be changed to upon CHO execution.
transmitting an SN Addition Request to a fourth network node (e.g., operating as SN Candidate target) including an indication that request is for a CHO;
   In one embodiment, the SN Addition Request procedure in this step is initiated upon determining that for the UE operating in MR-DC and to be configured with CHO, the SN is to be kept or changed;
      In one embodiment, this step is not performed if the candidate target MN determines to release the SN upon CHO execution.
   In one embodiment, the SN Addition Request includes an indication that this request is associated to a CHO procedure i.e., that the requesting node is a candidate target MN. In other words, the indication indicates to the candidate target SN that the UE may either not perform the handover (and consequently not applying the SCG configurations and not performing the reconfiguration with sync with the SpCell of the SCG), or would perform at a later point in time (i.e., when the CHO condition to be configured to the UE will be fulfilled).
      In one embodiment, an information element (IE) similar to that shown in FIG. 18A may be introduced to the S-NG-RAN ADDITION REQUEST message.
      In one embodiment, at least one new value associate to CHO is introduced to the “SN Addition Trigger Indication” to be included in the S-NG-RAN ADDITION REQUEST message. There could be a further distinction to the cases where CHO is an intra-MN CHO (if the candidate target MCG for CHO is associated to the same MN as the current MCG SpCell) or an inter-MN CHO (if the candidate target MCG for CHO is associated to the same MN as the current MCG SpCell), as follows. The addition of this value to the SN Addition Trigger Indication is shown in FIG. 18B.
   In one embodiment, if the candidate target MN decides to keep the SN but change the SpCell of the SCG (e.g., based on measurements included in the HANDOVER REQUEST message from the source MN); or
   In one embodiment, if the candidate target MN decides to keep the SN but it is up to the candidate target SN to either keep or change the SpCell of the SCG (e.g., based on measurements included in the HANDOVER REQUEST message from the source MN that are forwarded to the candidate target SN in the SN ADDITION REQUEST); the following is performed:
      If the candidate target MN decides to keep the source SN (upon CHO execution), the candidate target MN sends an SN Addition Request to the candidate target SN including the SN UE XnAP ID as a reference to the UE context in the candidate target SN that was established by the source MN.
      In this case, in one example, at least the information elements shown in the example message of FIG. 19A would be included in the S-NG-RAN node (SN) ADDITION REQUEST message.
      In this case, in another example, at least the information elements shown in the example message of FIG. 19B would be included in the S-NG-RAN node (SN) ADDITION REQUEST message. In one embodiment, if the candidate target MN decides to change the SN (e.g., based on measurements included in the HANDOVER REQUEST message from the source MN);
      If the candidate target MN decides to change the SN (i.e., a different candidate target SN compared to the source SN), the candidate target MN sends the SN Addition Request to the candidate target SN including the UE context in the source SN that was established by the source MN.
   In one embodiment, the SN Addition Request includes an indication that this request is associated to Conditional SN Addition procedure i.e., that the UE that will receive the configuration is not applying it upon reception but upon the fulfillment of a condition. In addition, the message may contain at least another indication to enable the candidate target SN to distinguish between a mobility case (i.e., requesting node is a target MN) and a SN addition case (where the UE is not operating in MR-DC, and the requesting node is a source MN associated to a serving cell e.g., SpCell of the MCG).
receiving an SN Addition Request Acknowledge from the fourth network node (e.g., operating as SN Candidate target);
   In one embodiment, the candidate target MN receives from the candidate target SN an SN Addition Request Acknowledge that may include the indication of the full or delta RRC configuration.
   If the message has an indication of full RRC configuration, a CHO modification from the source MN to the candidate target MN does not trigger a modification towards the candidate target SN.
   If the message has an indication of delta RRC configuration, a CHO modification from the source MN to the candidate target MN triggers a modification towards the candidate target SN.
transmitting a HANDOVER REQUEST ACKNOWLEDGE message to the first network node (which is the source MN, e.g., a source gNodeB), the message possibly including information that the SN is to be kept upon CHO execution;
   In one embodiment, the candidate target MN includes within the Handover Request Acknowledge message the MN RRC reconfiguration message to be sent to the UE in order to perform the conditional handover configuration and may also provide forwarding addresses to the source MN. If PDU session split is to be performed in the candidate target side during conditional handover execution procedure, more than one data forwarding addresses corresponding to each node are included in the Handover Request Acknowledge message. The candidate target MN indicates to the source MN that the UE context in the SN is kept if the candidate target MN and the candidate target SN decided to keep the UE context in the SN.

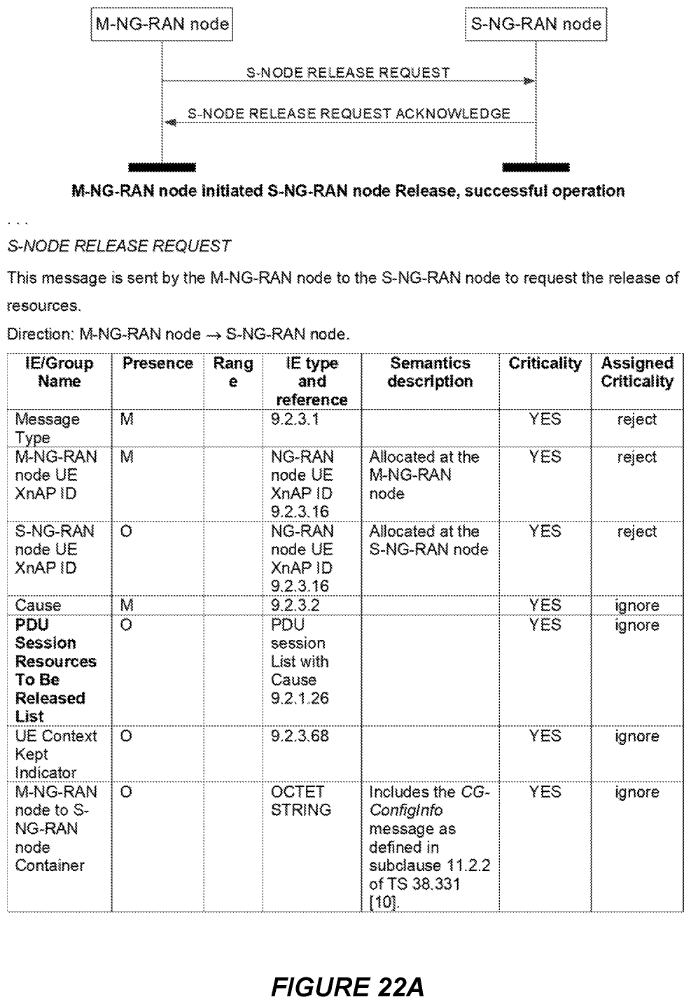

FIG. 20A and FIG. 20B together illustrate an example of the HANDOVER REQUEST message referenced above, containing the information as described in this section.

Another embodiment is a method performed at a fourth network node operating as Candidate target SN, the method comprising:
receiving an SN Addition Request from a third network node operating as Candidate target MN including an indication that request is for a CHO;
   Upon determining that the SN Addition Request is for a CHO candidate target MN, the third network node is able to set its supervision timer to a value that is longer than the value it would set for a legacy HO and/or a legacy SN addition.
   Upon determining that the SN Addition Request is for a CHO candidate target MN, the third network node may accept further SN Addition Request(s) for the same UE;
   In one embodiment, the SN Addition Request includes an indication that this request is associated to a CHO procedure i.e., that the requesting node is a candidate target MN. Based on that indication, the candidate target SN determines that the UE may either not perform the handover (and consequently not applying the SCG configurations and not performing the reconfiguration with sync with the SpCell of the SCG), or would perform at a later point in time (i.e., when the CHO condition to be configured to the UE will be fulfilled).
   In one embodiment, the received SN Addition Request messages includes the SN UE XnAP ID as a reference to the UE context in the candidate target SN that was established by the source MN; upon the reception of that the candidate target SN determines that the candidate target MN is requesting the SN to keep the UE context in the SN after CHO execution. The SN then expects the source MN to trigger an SN Release (upon HCO execution), as in this case the candidate target SN is the same as the source SN.
   In one embodiment, the received SN Addition Request message includes the UE context in the source SN that was established by the source MN, if the candidate target MN decided to change the SN (i.e., a different candidate target SN compared to the source SN). The candidate target SN then waits for an indication of a Reconfiguration Complete from the candidate target MN, when the UE executes CHO and transmits the RRC Reconfiguration Complete to the candidate target MN upon CHO execution.
   In one embodiment, the received SN Addition Request includes an indication that this request is associated to Conditional SN Addition procedure i.e., that the UE that will receive the configuration is not applying it upon reception but upon the fulfillment of a condition. In addition, the message may contain at least another indication to enable the candidate target SN to distinguish between a mobility case (i.e., requesting node is a target MN) and a SN addition case (where the UE is not operating in MR-DC, and the requesting node is a source MN associated to a serving cell e.g., SpCell of the MCG).
transmitting an SN Addition Request Acknowledge to the third network node operating as Candidate target MN
   Start the supervision timer upon transmitting the message to the third network node, upon determining that this message is sent in response to an SN Addition Request for a CHO candidate target MN.
      In one embodiment the supervision timer is the TXn DC Overall timer, as specified in TS 38.423.
   In one embodiment, the candidate target SN prepares SN related configuration for the UE e.g., SCG configuration in an RRC Reconfiguration message.
   In one embodiment, the candidate target SN transmits to the candidate target MN an SN Addition Request Acknowledge that may include the indication of the full or delta RRC configuration.
   If the candidate target SN does not want to support an SCG modification upon CHO modification, the SN prepares an SN-related RRC Reconfiguration that is a full configuration (i.e., not delta) for the UE and includes an indication of full RRC configuration.
   If the candidate target SN supports an SCG modification upon CHO modification, the SN prepares an SN-related RRC Reconfiguration that is a delta configuration for the UE and includes an indication of delta RRC configuration.

### CHO Execution Techniques

An example embodiment is a method performed at the first network node operating as Source MN the method comprising:
receiving a second message from the third node, which is a candidate target node (e.g., candidate target gNodeB for which CHO has been configured); and
   In one embodiment the second message is a HANDOVER SUCCESS message;
      The HANDOVER SUCCESS message is received as part of the Handover Success procedure and is used during a conditional handover or a DAPS handover, to enable a target NG-RAN node to inform the source NG-RAN node that the UE has successfully accessed the target NG-RAN node. In other words, the reception of the HANDOVER SUCCESS message from a specific target NG-RAN (i.e., one of the candidate target MN(s)) indicate that the UE has successfully accessed that specific target NG-RAN node.
      If late data forwarding is configured, the source NG-RAN node shall start data forwarding using the tunnel information related to the global target cell ID provided in the HANDOVER SUCCESS message. In this particular case where the UE is in MR-DC when CHO is executed and notified via the HANDVOER SUCCESS message, data forwarding may involve the Source SN node (e.g., STATUS TRANSFER, data forwarding from the Source SN to the Source MN, etc.). Details are provided in later embodiment.
      When the source NG-RAN node receives the HANDOVER SUCCESS message, it shall consider all other CHO preparations accepted for this UE in the target NG-RAN node as canceled and may initiate Handover Cancel procedure towards other candidate target NG-RAN nodes for this UE, if any, and may initiate the M-NG-RAN node initiated S-NG-RAN node Release procedure if the UE was configured with dual connectivity, as described in TS 37.340 [8].
   In one embodiment the second message may be one of the following:
      UE CONTEXT RELEASE
      RETRIEVE UE CONTEXT REQUEST
   In one embodiment the second message is NOT a HANDOVER REQUEST ACKNOWLEDGE message;
   In one embodiment the second message is any message indicating to the Source MN that Conditional Handover has been executed;
      The message may be received from the UE;
      The message may be received from a candidate target node;
   In one embodiment the second message is any message indicating to the Source MN that Conditional Handover has been successfully executed;
      The message may be received from the UE;
      The message may be received from a candidate target node;
   In one embodiment the second message may include one of the following indications:
      Indication that the UE has applied a configuration that includes MR-DC i.e., upon CHO execution the UE either starts to operate in MR-DC or continues to operate in MR-DC;
      Indication that the UE has applied a configuration that includes MR-DC and upon CHO execution the SN context is to be kept.
transmitting an SN RELEASE REQUEST message to a second network node operating as a Source SN (S-SN), e.g., a Source Secondary gNodeB (Source SgNB);
   In one embodiment, the method comprising the initiation of the SN release procedure towards the Source SN e.g., upon reception of the second message, such as the HANDOVER SUCCESS message from a candidate target MN.
   The reception of the second message indicates a CHO execution in the candidate target MN that transmits the second message to the first network node.
   In one embodiment, upon reception of the is HANDOVER SUCCESS message, the source MN initiates the release of the source SN resources towards the source SN including a Cause indicating MCG mobility. The SN acknowledges the release request. If data forwarding is needed, the MN provides data forwarding addresses to the source SN. Reception of the SN Release Request message triggers the source SN to stop providing user data to the UE and, if applicable, to start data forwarding.
   In one embodiment the first network node (e.g., S-MN) indicates to the second network node (e.g., Source SN, S-SN) a cause value for the SN RELEASE REQUEST indicating that the release is triggered due to a conditional handover. The cause value may be at least one of the following:
      MN mobility;
         This may be used in case the S-SN does not need to perform any distinction between a CHO and a legacy HO as cause value, e.g., when transmitting the SN RELEASE REQUEST ACKNOWLEDGE.
      Conditional MN mobility;
         This may be used in case the S-SN needs to perform a distinction between a CHO and a legacy HO as cause value, e.g., when transmitting the SN RELEASE REQUEST ACKNOWLEDGE including specific information;
      MCG mobility;
         This may be used in case the S-SN does not need to perform any distinction between a CHO and a legacy HO as cause value, e.g., when transmitting the SN RELEASE REQUEST ACKNOWLEDGE.
      Conditional MCG mobility;
         This may be used in case the S-SN needs to perform a distinction between a CHO and a legacy HO as cause value, e.g., when transmitting the SN RELEASE REQUEST ACKNOWLEDGE including specific information;
   In one embodiment, the source MN indicates to the (source) SN that the UE context in SN is kept, if it had received the indication from the candidate target MN during CHO preparation phase. That implies that this information is stored in the UE context during the preparation phase, so that is used during CHO execution phase. If the indication as the UE context kept in SN is included, the SN keeps the UE context.
receiving an SN RELEASE REQUEST ACKNOWLEDGE message from the second network node operating as a Source SN (S-SN) e.g., a Source Secondary gNodeB (Source SgNB);
   The reception of the SN RELEASE REQUEST ACKNOWLEDGE confirms from the S-SN that the resources have been released;
   The M-NG-RAN node initiated S-NG-RAN node Release procedure is triggered by the M-NG-RAN node to initiate the release of the resources for a specific UE. The procedure uses UE-associated signaling.
   In one embodiment, if the S-NG-RAN node provides data forwarding related information (which is received in the first network node, S-MN) in the S-NODE RELEASE REQUEST ACKNOWLEDGE message for QoS flows mapped to DRBs configured with an SN terminated bearer option in the PDU Sessions To Be Released List—SN terminated IE, the M-NG-RAN node may decide to provide data forwarding addresses to the S-NG-RAN node and trigger the Xn-U Address Indication procedure, as specified in 3GPP TS 37.340 for CHO.

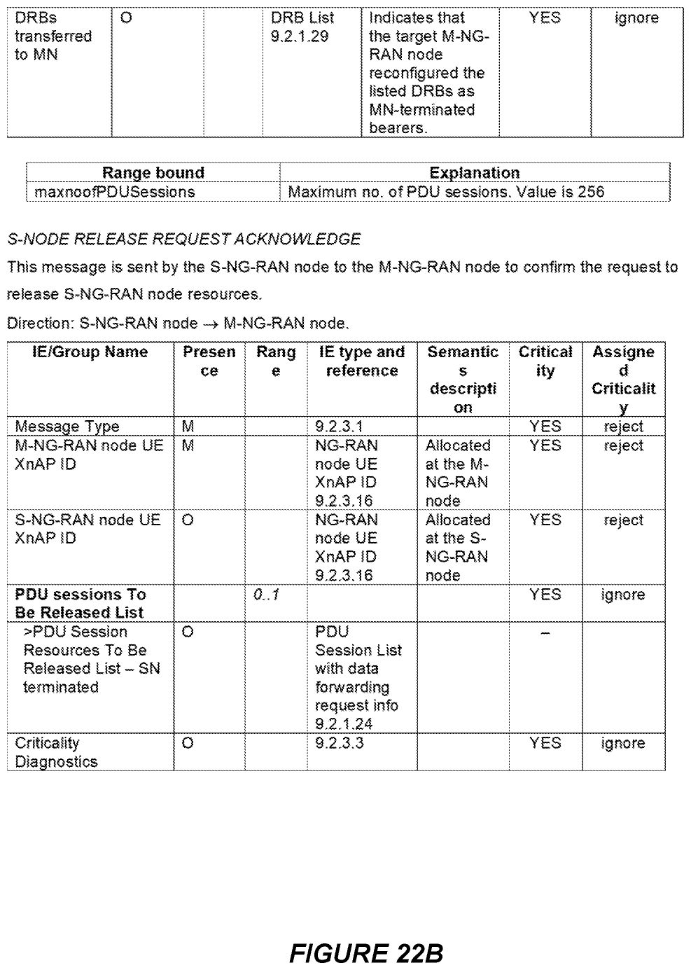

An example of how the HANDOVER SUCCESS message discussed above might possibly be defined in 3GPP TS 38.423 is shown in FIG. 21.

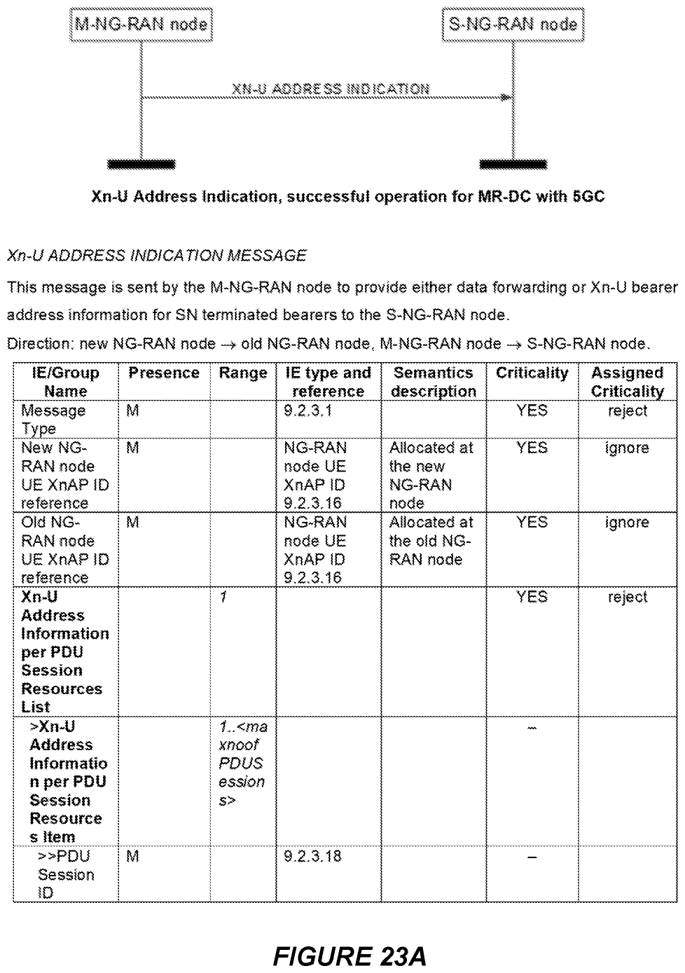

An example of how the SN Release Request Acknowledge message discussed above might be defined in 3GPP specifications is shown in FIG. 22A and FIG. 22B.

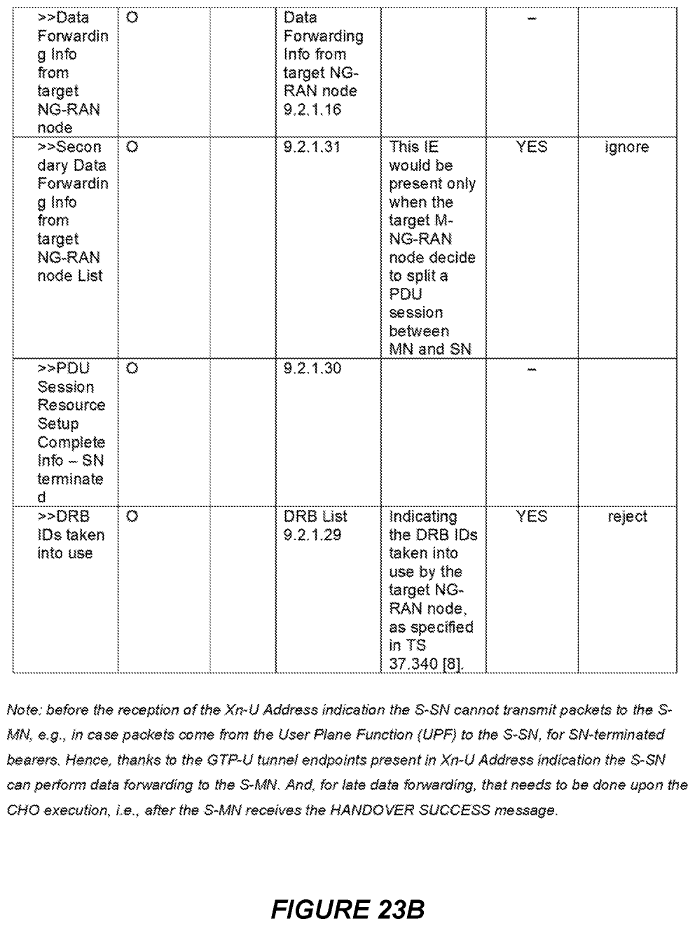

In some embodiments of the technique just described, if data forwarding is needed, the first network node (e.g., Source MN):
initiates an address indication procedure with the second network node;
   In one embodiment, the address indication procedure is an XN-U Address Indication procedure, as defined in TS 38.423 (e.g., in sub-clause 8.2.6)
   In one embodiment, the first network node corresponds to an M-NG-RAN node.
   In one embodiment the first network node indicates to the Source SN its own forwarding address (or addresses) during the address indication procedure;
   In one embodiment, the first network node (e.g., M-NG-RAN node) transmits an XN-U ADDRESS INDICATION message;
   In one embodiment, if during CHO preparation the first network node received an indication that the SN is to be kept (in the HANDOVER REQUEST ACK message), the source MN includes in the SN RELEASE REQUEST (e.g., S-NODE RELEASE REQUEST) the UE Context Kept Indicator IE set to “True”.
   In one embodiment, if the UE Context Kept Indicator IE set to “True” and the DRBs transferred to MN IE are included in the S-NODE RELEASE REQUEST message, the S-NG-RAN node shall, if supported, provide the uplink/downlink PDCP SN and HFN status for the listed DRBs, as specified in TS 37.340 [8].
   For MR-DC with 5GC, the Xn-U Address Indication procedure is used to provide forwarding addresses and Xn-U bearer address information for completion of setup of SN terminated bearers from the M-NG-RAN node to the S-NG-RAN node as specified in TS 37.340. An example of how this message may be defined in 3GPP specifications is shown in FIG. 23A and FIG. 23B.

In some embodiments, the method described above may further comprise determining that Late Data Forwarding (LDF) is to be performed.
In one embodiment, that is determined based on a configuration e.g., provided from Operation and Maintenance (OAM) system.
Receiving an SN Status Transfer from the second network node operating as Source SN;
   The Source MN receives from the S-SN the uplink PDCP SN and HFN receiver status and the downlink PDCP SN and HFN transmitter status, for each respective DRB of the S-SN DRB configuration for which PDCP SN and HFN status preservation applies.
   The Source MN receives the SN STATUS TRANSFER message from the S-SN at the time point when it considers the transmitter/receiver status to be frozen.
   In case of MR-DC, if the S-MN performs PDCP SN length change or RLC mode change for a DRB as specified in TS 37.340 [8], it shall ignore the information received for that DRB in this message.
   The S-MN may receive in the SN STATUS TRANSFER message the missing and the received uplink SDUs in the Receive Status of UL PDCP SDUs IE for each DRB for which the S-SN has accepted the request from the S-MN for uplink forwarding.
   For each DRB in the DRBs Subject to Status Transfer List IE, the S-MN shall not deliver any uplink packet which has a PDCP-SN lower than the value contained within the UL Count Value IE.
   For each DRB in the DRBs Subject to Status Transfer List IE, the S-MN shall use the value of the PDCP SN contained within the DL COUNT Value IE for the first downlink packet for which there is no PDCP-SN yet assigned.
   If the Receive Status of UL PDCP SDUs IE is included for at least one DRB in the SN STATUS TRANSFER message, the S-MN node may use it in a Status Report message sent to the UE over the radio interface.
   If the SN STATUS TRANSFER message contains in the DRBs Subject To Status Transfer List IE the Old QoS Flow List—UL End Marker expected IE, the S-MN shall be prepared to receive the SDAP end marker for the QoS flow via the corresponding DRB, as specified in TS 38.300 [8].
Transmitting an SN Status Transfer to the third network node (e.g., candidate target node, target gNodeB).
Forwarding data to the third network node (e.g., target gNodeB).
Receiving forwarded data from the second network node operating as Source SN;
   In one embodiment, if the late data forwarding is applied, the first network node (e.g., source MN) initiates data forwarding once it knows which target MN the UE has successfully accessed. In that case the behavior of the Conditional Handover data forwarding follows the same behavior as defined in 9.2.3.2.3 for the intra-system handover data forwarding, except the behavior for DRBs configured with DAPS Handover.
   In another embodiment, the source MN only starts data forwarding towards the target MN (after reception of HANDOVER SUCCESS) once it gets SN STATUS TRANSFER from the S-SN;

Another example embodiment is a method performed at a second network node operating as Source SN the method comprising (e.g., CHO execution):
Receiving an SN RELEASE REQUEST message from the first network node operating as a Source MN (S-MN);
   In one embodiment, the method comprising the initiation of the SN release procedure towards the Source SN e.g., upon reception of the second message, such as the HANDOVER SUCCESS message from a candidate target.
   The reception of the second message indicates a CHO execution in the candidate target that transmits the second message to the first network node.
   In one embodiment, upon reception of the is HANDOVER SUCCESS message, the MN initiates the release of the source SN resources towards the source SN including a Cause indicating MCG mobility. The SN acknowledges the release request. If data forwarding is needed, the MN provides data forwarding addresses to the source SN. Reception of the SN Release Request message triggers the source SN to stop providing user data to the UE and, if applicable, to start data forwarding.
   In one embodiment the first network node (e.g., S-MN) indicates to the second network node (e.g., Source SN, S-SN) a cause value for the SN RELEASE REQUEST indicating that the release is triggered due to a conditional handover. The cause value may be at least one of the following:
      MN mobility;
         This may be used in case the S-SN does not need to perform any distinction between a CHO and a legacy HO as cause value, e.g., when transmitting the SN RELEASE REQUEST ACKNOWLEDGE.
      Conditional MN mobility;
         This may be used in case the S-SN needs to perform a distinction between a CHO and a legacy HO as cause value, e.g., when transmitting the SN RELEASE REQUEST ACKNOWLEDGE including specific information;
      MCG mobility;
         This may be used in case the S-SN does not need to perform any distinction between a CHO and a legacy HO as cause value, e.g., when transmitting the SN RELEASE REQUEST ACKNOWLEDGE.
      Conditional MCG mobility;
         This may be used in case the S-SN needs to perform a distinction between a CHO and a legacy HO as cause value, e.g., when transmitting the SN RELEASE REQUEST ACKNOWLEDGE including specific information;
   In one embodiment, the reception of the SN RELEASE REQUEST message triggers the source SN to stop providing user data to the UE and, if applicable, to start data forwarding.
   In one embodiment, upon reception of the SN RELEASE REQUEST (e.g., S-NODE RELEASE REQUEST) message containing UE Context Kept Indicator IE set to “True”, the S-NG-RAN node shall, if supported, only initiate the release of the resources related to the UE-associated signaling connection between the M-NG-RAN node and the S-NG-RAN node.
   In one embodiment, if the S-NG-RAN node confirms the request to release S-NG-RAN node resources, it shall send the S-NODE RELEASE REQUEST ACKNOWLEDGE message to the M-NG-RAN node.
   In one embodiment, if the UE Context Kept Indicator IE set to “True” and the DRBs transferred to MN IE are included in the S-NODE RELEASE REQUEST message, the S-NG-RAN node shall, if supported, provide the uplink/downlink PDCP SN and HFN status for the listed DRBs, as specified in TS 37.340 [8].
Transmitting an SN RELEASE REQUEST ACKNOWLEDGE message to the first network node operating as a Source MN (S-MN);
   The transmission of the SN RELEASE REQUEST ACKNOWLEDGE confirms that the SN resources have been released;
   In one embodiment, the second network node (e.g., an S-NG-RAN node) provides data forwarding related information (which is received in the first network node, S-MN) in the S-NODE RELEASE REQUEST ACKNOWLEDGE message for QoS flows mapped to DRBs configured with an SN terminated bearer option in the PDU Sessions To Be Released List—SN terminated IE, the M-NG-RAN node may decide to provide data forwarding addresses to the S-NG-RAN node and trigger the Xn-U Address Indication procedure, as specified in TS 37.340 for CHO [8].
      In one embodiment, that sub-step of including data forwarding information is only performed if late data forwarding for the SN is configured (e.g., request in the SN Release Request, etc.)

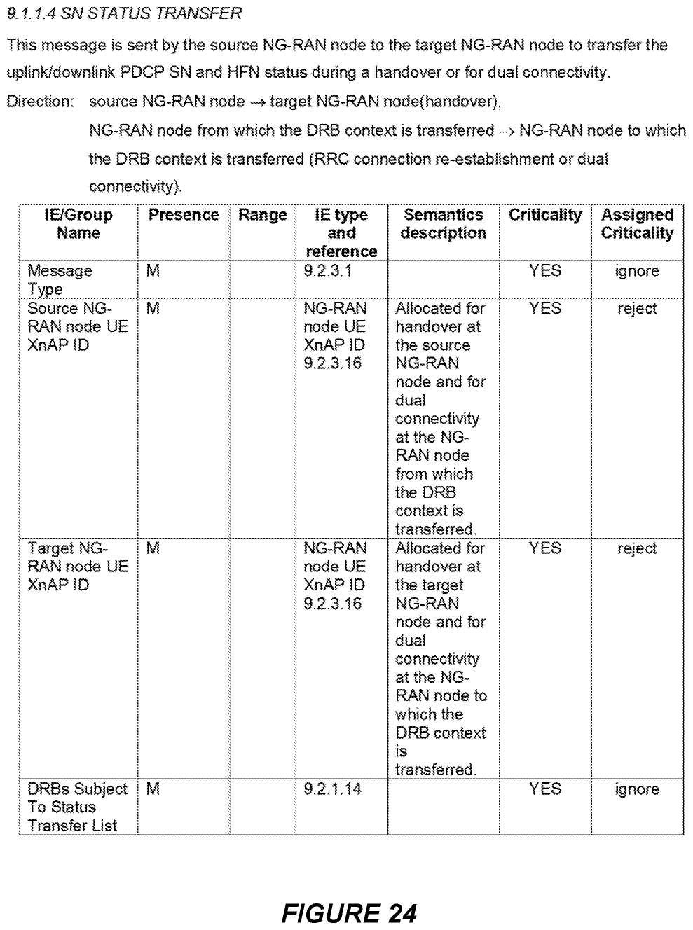

In some embodiments, the method may further comprise receiving an Xn-U Address Indication from the first network node operating as a Source MN (S-MN):
In this message the Source MN provides data forwarding addresses to the source SN.
Upon reception of the XN-U ADDRESS INDICATION message, in case of data forwarding, the second network node (e.g., S-NG-RAN node) should initiate data forwarding by forwarding pending DL user data to the indicated TNL addresses;
in case of completion of Xn-U bearer establishment for SN terminated bearers, the S-NG-RAN node may start delivery of user data to the indicated TNL address. If the XN-U ADDRESS INDICATION message includes the DRB IDs taken into use IE, the S-NG-RAN node shall, if applicable, act as specified in TS 37.340 [8].
Some of these embodiments may further comprise determining that data forwarding is needed;
Some of these embodiments may further comprise determining that late data forwarding is to be performed.
Some of these embodiments may further comprise transmitting an SN Status Transfer to the first network node operating as Source MN;
   The S-SN transfers the uplink PDCP SN and HFN receiver status and the downlink PDCP SN and HFN transmitter status from the S-SN to the S-MN, for each respective DRB§ of the S-SN DRB configuration for which PDCP SN and HFN status preservation applies.
   The S-SN initiates the procedure by stop assigning PDCP SNs to downlink SDUs and stop delivering UL SDUs towards the 5GC and sending the SN STATUS TRANSFER message to the S-MN node at the time point when it considers the transmitter/receiver status to be frozen.
   In case of MR-DC, if the S-MN performs PDCP SN length change or RLC mode change for a DRB as specified in TS 37.340 [8], it shall ignore the information received for that DRB in this message.
   For each DRB for which PDCP-SN and HFN status preservation applies, the S-SN node shall include the DRB ID IE, the UL COUNT Value IE and the DL COUNT Value IE within the DRBs Subject to Status Transfer List IE in the SN STATUS TRANSFER message.
   The S-SN may also include in the SN STATUS TRANSFER message the missing and the received uplink SDUs in the Receive Status of UL PDCP SDUs IE for each DRB for which the S-SN has accepted the request from the S-MN for uplink forwarding.
   For each DRB in the DRBs Subject to Status Transfer List IE, the S-MN node shall not deliver any uplink packet which has a PDCP-SN lower than the value contained within the UL Count Value IE.
   For each DRB in the DRBs Subject to Status Transfer List IE, the S-MN shall use the value of the PDCP SN contained within the DL COUNT Value IE for the first downlink packet for which there is no PDCP-SN yet assigned.
   If the Receive Status of UL PDCP SDUs IE is included for at least one DRB in the SN STATUS TRANSFER message, the S-MN may use it in a Status Report message sent to the UE over the radio interface.
   If the SN STATUS TRANSFER message contains in the DRBs Subject To Status Transfer List IE the Old QoS Flow List—UL End Marker expected IE, the S-MN shall be prepared to receive the SDAP end marker for the QoS flow via the corresponding DRB, as specified in TS 38.300. An example definition of this message is shown in FIG. 24.
Some of these embodiments may further comprise forwarding data to the first network node (e.g., Source gNodeB, Source MN).
   This is DL data the S-SN may still be receiving from the UPF or DL data that it may still be receiving from the UE.
Some of these embodiments may further comprise the S-SN being notified that CHO is being configured at the UE; The S-SN receives a message from the S-MN (e.g., SN REQUEST RELEASE message) with an indication that this is being triggered because the UE has been configured with CHO. In that case, upon reception, the Source SN does not release the SN resources, but it gets prepared to do (e.g., upon reception of another SN REQUEST RELEASE message), and transmits to the Source MN an SN REQUEST RELEASE ACKNOWLEDGE;

Another example embodiment comprises a method performed at the third network node (operating as a candidate target MN), the method comprising:
receiving from the UE an RRC Reconfiguration Complete message;
   The message may contain within a second RRC Reconfiguration Complete message associated to the SCG reconfiguration; the UE has also applied upon CHO execution.
   In one embodiment the RRC Reconfiguration Complete message is an RRCReconfigurationComplete message;
   In another embodiment the RRC Reconfiguration Complete message is an RRCConnectionReconfigurationComplete message;
   In one embodiment the second RRC Reconfiguration Complete message is an RRCReconfigurationComplete message;
   In another embodiment the second RRC Reconfiguration Complete message is an RRCConnectionReconfigurationComplete message;
determining that the incoming UE has been configured with CHO and has an associated MR-DC related configuration for a fourth network node (operating as SN candidate target);
   That can be done by identifying the C-RNTI the incoming UE has used, as the same C-RNTI allocated for a possibly incoming UE configured with CHO.
transmitting an SN Reconfiguration Complete message to the fourth network node (operating as SN candidate target);
   That includes the RRC reconfiguration Complete message associated to the SCG reconfiguration, and transmitted from the UE;
   That is a way to acknowledge the candidate target SN that the RRC connection reconfiguration procedure was successful.
transmitting a message to the first node, which is a source MN (e.g., source gNodeB that has configured CHO);
   In one embodiment the message is HANDOVER SUCCESS message.

The RRCReconfigurationComplete message specified in 3GPP standards may be modified to support the techniques described herein by including a second RRC Reconfiguration Complete related to the SCG applied upon CHO, in the scg-Response field, which may either be an nr-SCG-Response (also an RRCReconfigurationComplete message) or an eutra-SCG-Response, in case the candidate target MN is an NR gNodeB. This might look as follows, for example:

********************* begin example message ******************************************

| | |
|---|---|
| RRCReconfigurationComplete-v1560-IEs ::= | SEQUENCE { |
| scg-Response | CHOICE { |
| nr-SCG-Response | OCTET STRING (CONTAINING |

RRCReconfigurationComplete),

| | |
|---|---|
| eutra-SCG-Response | OCTET STRING |

}
********************* end example message ******************************************

Another example embodiment is a method performed at the fourth network node (operating as a candidate target SN) the method comprising:
receiving an SN Reconfiguration Complete message from the third network node (operating as MN candidate target);
   That includes the RRC reconfiguration Complete message associated to the SCG reconfiguration, and transmitted from the UE;
stopping the supervision timer; consider the UE context as active.
   The execution procedure is summarized in FIG. 5, which was provided above.

### CHO Canceling Techniques (e.g., in Another Candidate MN)

Another example embodiment is a method executed in a source MN, the method comprising:
Receiving a message from a first candidate target MN that the UE executes CHO;
   In one embodiment, the message is a Handover Success message;
Transmitting to a second candidate target MN where the UE has not executed CHO a message, the message comprising an indication that CHO configuration(s) are to be released;

Another example embodiment is a method executed in a candidate target MN, the method comprising:
Receiving from a source MN a message, the message comprising an indication that CHO configuration(s) are to be released;
Determining if the CHO configuration for the associated UE has an associated target SN candidate;
Triggering an SN Release procedure, by transmitting an SN Release Request message to the candidate target SN;
Receiving an SN Release Request Acknowledge from the candidate target SN;

An example illustration is provided in FIG. 6, as discussed above

Advantages of various of the disclosed embodiments is that they enable a UE operating in MR-DC to be configured with Conditional Reconfiguration (e.g., Conditional Handover—CHO) and in particular, they enable a candidate target MN to either keep the SN or modify/change the SN.

According to various embodiments, a target MN candidate may configure an SN candidate target to either keep the SN or change the SN, without the SN candidate target having the risk of setting too short value for the supervision timer, as this would be clearly for a CHO. Since the time between the transmission of an SN Addition Request and reception of an SN Reconfiguration Complete is longer than in legacy, as in CHO the UE may take longer to access a candidate target MN, or not even come, the methods may be used to avoid unintended SN Releases from the candidate target SN, which avoids creating quite many race conditions e.g., candidate target MN having to modify its CHO configurations towards the source MN. In some embodiments, the candidate target SN may also reserve resources for the UE taking into account that the UE may connect after a longer time compare to legacy SN Addition or may not connect at all, which will lead to an optimized resource allocation within the node.

In addition, in some embodiments, when the target MN candidate transmits the Handover Request Acknowledge message in response to a CHO, in the case it has decided to keep or change the SN, the methods prevent procedures that define that the source MN releases the SN, by delaying that action to when CHO is executed.

As an example of possible implementations to 3GPP specifications, implementation of the techniques described herein may require changes in the 3GPP TS 37.340 specifications. An example of certain parts of this 3GPP specification, as amended to implement the presently disclosed techniques, is provided below.

************************* begin example 3GPP specifications *******************************
10.7 Inter-Master Node Handover with/without Secondary Node Change

### 10.7.1 EN-DC

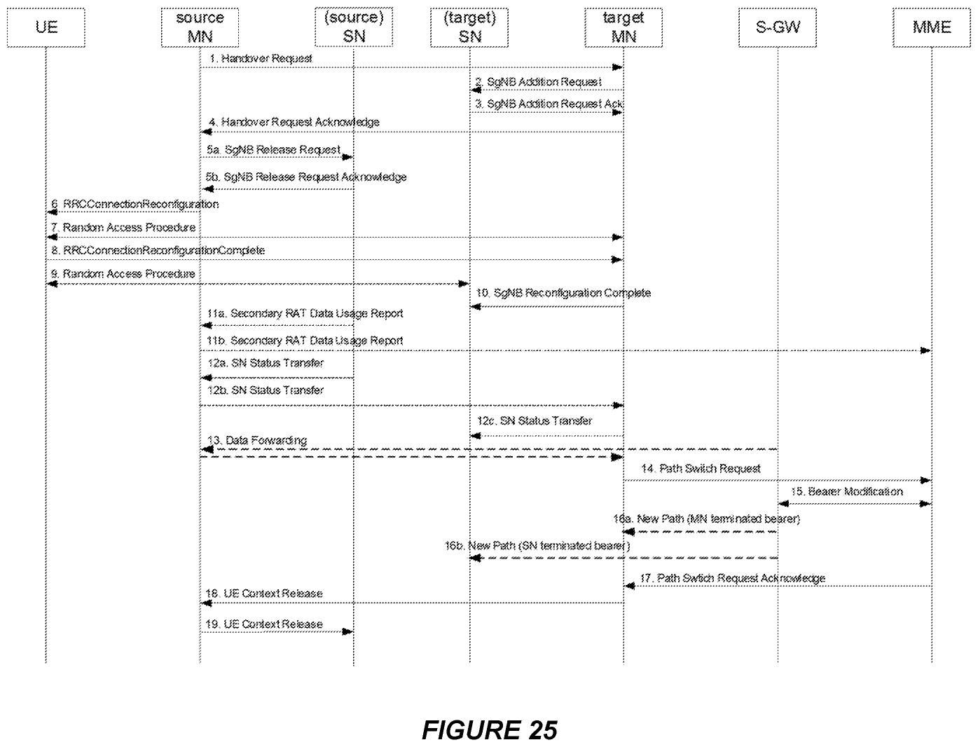

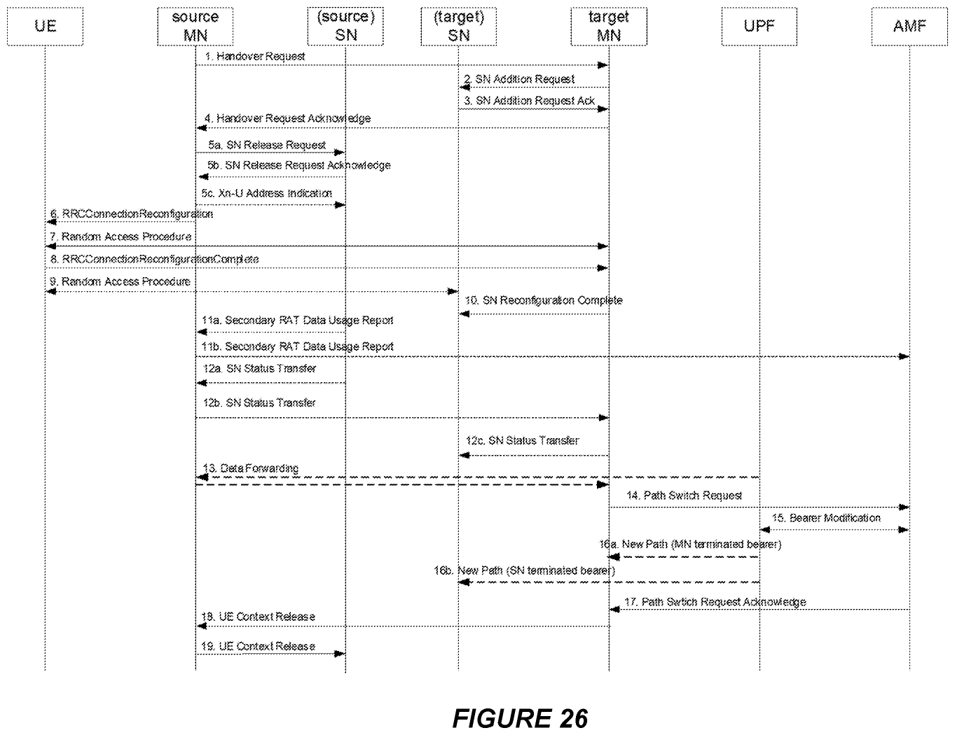

Inter-Master Node handover with/without MN initiated Secondary Node change is used to transfer context data from a source MN to a target MN while the context at the SN is kept or moved to another SN. During an Inter-Master Node handover, the target MN decides whether to keep or change the SN (or release the SN, as described in clause 10.8).
   NOTE 1: Inter-system Inter-Master node handover with/without SN change is not supported in this version of the protocol (e.g., no transition from EN-DC to NGEN-DC or NR-DC).
      [Figure omitted—see FIG. 25]
[FIG. 25] shows an example signaling flow for inter-Master Node handover with or without MN initiated Secondary Node change:
   NOTE 2: For an inter-Master Node handover without Secondary Node change, the source SN and the target SN shown in Figure 10.7.1-1 are the same node.
   1. The source MN starts the handover procedure by initiating the X2 Handover Preparation procedure including both MCG and SCG configuration. The source MN includes the (source) SN UE X2AP ID, SN ID and the UE context in the (source) SN in the Handover Request message.
   NOTE 3: The source MN may trigger the MN-initiated SN Modification procedure (to the source SN) to retrieve the current SCG configuration before step 1.
   2. If the target MN decides to keep the SN, the target MN sends SN Addition Request to the SN including the SN UE X2AP ID as a reference to the UE context in the SN that was established by the source MN. If the target MN decides to change the SN, the target MN sends the SgNB Addition Request to the target SN including the UE context in the source SN that was established by the source MN. The target MN may also indicate that the SN Addition Request is associated to a Conditional Handover.
   3. The (target) SN replies with SN Addition Request Acknowledge. The (target) SN may include the indication of the full or delta RRC configuration.
   4. The target MN includes within the Handover Request Acknowledge message a transparent container to be sent to the UE as an RRC message to perform the handover, and may also provide forwarding addresses to the source MN. The target MN indicates to the source MN that the UE context in the SN is kept if the target MN and the SN decided to keep the UE context in the SN in step 2 and step 3.
   5. The source MN sends SN Release Request to the (source) SN including a Cause indicating MCG mobility. The (source) SN acknowledges the release request. The source MN indicates to the (source) SN that the UE context in SN is kept, if it receives the indication from the target MN. If the indication as the UE context kept in SN is included, the SN keeps the UE context.
   NOTE 2: In case the handover is a conditional handover, step 5 is performed after the source MN receives an indication that the UE has successfully accessed one of the candidate target eNB as described in TS 36.300 [2], (i.e., after step 9).
   6. The source MN triggers the UE to apply the new configuration.
   7/8. The UE synchronizes to the target MN and replies with RRCConnectionReconfigurationComplete message.
   9. If configured with bearers requiring SCG radio resources, the UE synchronizes to the (target) SN.
   10. If the RRC connection reconfiguration procedure was successful, the target MN informs the (target) SN via SgNB Reconfiguration Complete message.
   11a. The SN sends the Secondary RAT Data Usage Report message to the source MN and includes the data volumes delivered to and received from the UE over the NR radio for the related E-RABs.
   NOTE 4: The order the source SN sends the Secondary RAT Data Usage Report message and performs data forwarding with MN/target SN is not defined. The SgNB may send the report when the transmission of the related bearer is stopped.
   11b. The source MN sends the Secondary RAT Report message to MME to provide information on the used NR resource.
   12. For bearers using RLC AM, the source MN sends the SN Status Transfer, including, if needed, SN Status received from the source SN to the target MN. The target forwards the SN Status to the target SN, if needed.
   13. If applicable, data forwarding takes place from the source side. If the SN is kept, data forwarding may be omitted for SN-terminated bearers kept in the SN.
   14-17. The target MN initiates the S1 Path Switch procedure.
   NOTE 5: If new UL TEIDs of the S-GW are included, the target MN performs the MN initiated SN Modification procedure to provide them to the SN.
   18. The target MN initiates the UE Context Release procedure towards the source MN.
   19. Upon reception of the UE Context Release message, the (source) SN releases C-plane related resources associated to the UE context towards the source MN. Any ongoing data forwarding may continue. The SN shall not release the UE context associated with the target MN if the UE context kept indication was included in the SgNB Release Request message in step 5.
      10.7.2 MR-DC with 5GC
Inter-MN handover with/without MN initiated SN change is used to transfer UE context data from a source MN to a target MN while the UE context at the SN is kept or moved to another SN. During an Inter-Master Node handover, the target MN decides whether to keep or change the SN (or release the SN, as described in clause 10.8). Only intra-RAT Inter-Master node handover with/without SN change is supported (e.g., no transition from NGEN-DC to NR-DC).
   [Figure omitted—see FIG. 26]

[FIG. 26] shows an example signaling flow for inter-MN handover with or without MN initiated SN change:
NOTE 1: For an Inter-Master Node handover without Secondary Node change, the source SN and the target SN shown in Figure 10.7.2-1 are the same node.
1. The source MN starts the handover procedure by initiating the Xn Handover Preparation procedure including both MCG and SCG configuration. The source MN includes the source SN UE XnAP ID, SN ID and the UE context in the source SN in the Handover Request message.
NOTE 2: The source MN may trigger the MN-initiated SN Modification procedure (to the source SN) to retrieve the current SCG configuration and to allow provision of data forwarding related information before step 1.
2. If the target MN decides to keep the source SN, the target MN sends SN Addition Request to the SN including the SN UE XnAP ID as a reference to the UE context in the SN that was established by the source MN. If the target MN decides to change the SN, the target MN sends the SN Addition Request to the target SN including the UE context in the source SN that was established by the source MN. The target MN may also indicate that the SN Addition Request is associated to a Conditional Handover.
NOTE: In case the handover is a conditional handover, step 2 the candidate target MN includes a CHO indication in the SN Addition Request.
3. The (target) SN replies with SN Addition Request Acknowledge. The (target) SN may include the indication of the full or delta RRC configuration.
4. The target MN includes within the Handover Request Acknowledge message the MN RRC reconfiguration message to be sent to the UE in order to perform the handover, and may also provide forwarding addresses to the source MN. If PDU session split is performed in the target side during handover procedure, more than one data forwarding addresses corresponding to each node are included in the Handover Request Acknowledge message. The target MN indicates to the source MN that the UE context in the SN is kept if the target MN and the SN decided to keep the UE context in the SN in step 2 and step 3.
5a/5b. The source MN sends SN Release Request message to the (source) SN including a Cause indicating MCG mobility. The (source) SN acknowledges the release request. The source MN indicates to the (source) SN that the UE context in SN is kept, if it receives the indication from the target MN. If the indication as the UE context kept in SN is included, the SN keeps the UE context.
NOTE 2: In case the handover is a conditional handover, step 3 is performed after the source MN receives an indication that the UE has successfully accessed one of the potential target ng-eNB/gNB as described in TS 38.300 [3], (i.e., after step 9).
5c. The source MN sends XN-U Address Indication message to the (source) SN to transfer data forwarding information. More than one data forwarding addresses may be provided if the PDU session is split in the target side.
6. The source MN triggers the UE to perform handover and apply the new configuration.
7/8. The UE synchronizes to the target MN and replies with MN RRC reconfiguration complete message.
9. If configured with bearers requiring SCG radio resources, the UE synchronizes to the (target) SN.
10. If the RRC connection reconfiguration procedure was successful, the target MN informs the (target) SN via SN Reconfiguration Complete message.
11a. The source SN sends the Secondary RAT Data Usage Report message to the source MN and includes the data volumes delivered to and received from the UE over the NR/E-UTRA radio as described in clause 10.11.2.
NOTE 2a: The order the source SN sends the Secondary RAT Data Usage Report message and performs data forwarding with MN/target SN is not defined. The SN may send the report when the transmission of the related QoS is stopped.
11b. The source MN sends the Secondary RAT Report message to AMF to provide information on the used NR/E-UTRA resource.
   ********************* end example 3GPP specifications **********************************

Some of the previously described embodiments are described in scenarios where a UE is configured with Multi-Radio Dual Connectivity (MR-DC) when it receives a conditional handover (CHO) configuration. The embodiments described herein are focused on NR-DC (i.e., when both master and secondary node are NR gNBs), but the embodiments are equally applicable to other DC scenarios (e.g., NE-DC, (NG)EN-DC and LTE DC).

Embodiments herein have been described with the term Conditional Handover (CHO) most of the time. Other terms may be considered as synonyms such as conditional reconfiguration, or Conditional Configuration (since the message that is stored and applied upon fulfillment of a condition is an RRCReconfiguration or RRCConnectionReconfiguration).

The principle for the configuration is the same with configuring triggering/execution condition(s) and a reconfiguration message to be applied when the triggering condition(s) are fulfilled.

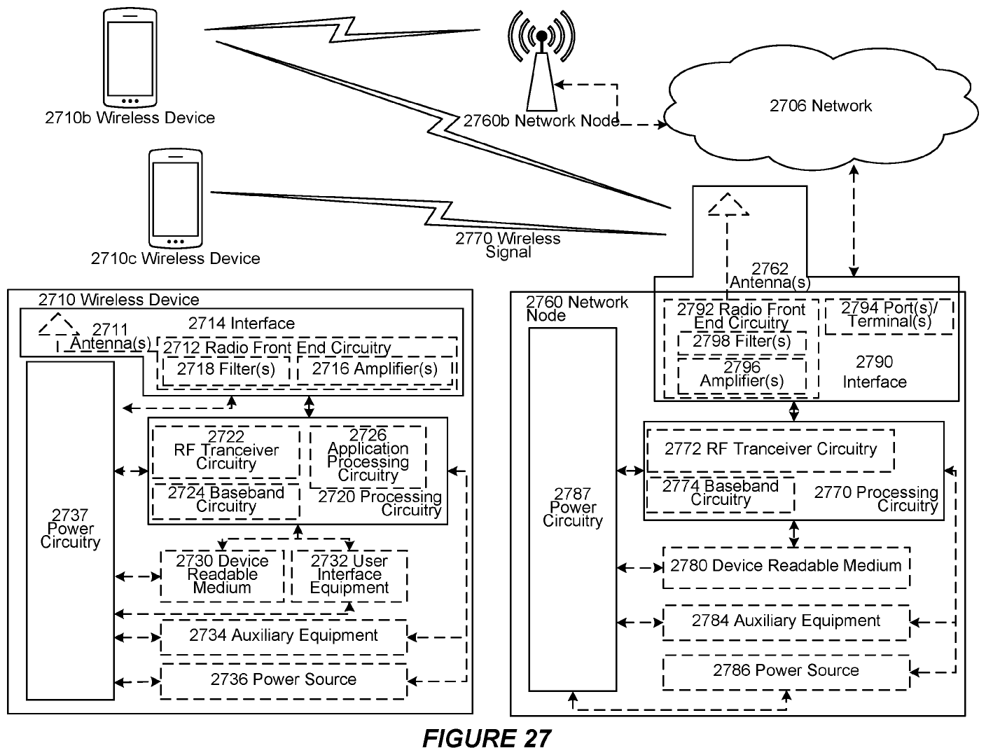

Although the subject matter described herein may be implemented in any appropriate type of system using any suitable components, the embodiments disclosed herein are described in relation to a wireless network, such as the example wireless network illustrated in FIG. 27. For simplicity, the wireless network of FIG. 27 only depicts network 2706, network nodes 2760 and 2760b, and WDs 2710, 2710b, and 2710c. In practice, a wireless network may further include any additional elements suitable to support communication between wireless devices or between a wireless device and another communication device, such as a landline telephone, a service provider, or any other network node or end device. Of the illustrated components, network node 2760 and wireless device (WD) 2710 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), Narrowband Internet of Things (NB-IoT), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 2706 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 2760 and WD 2710 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 27, network node 2760 includes processing circuitry 2770, device readable medium 2780, interface 2790, auxiliary equipment 2784, power source 2786, power circuitry 2787, and antenna 2762. Although network node 2760 illustrated in the example wireless network of FIG. 27 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 2760 are depicted as single boxes located within a larger box, or nested within multiple boxes, in practice, a network node may comprise multiple different physical components that make up a single illustrated component (e.g., device readable medium 2780 may comprise multiple separate hard drives as well as multiple RAM modules).

Similarly, network node 2760 may be composed of multiple physically separate components (e.g., a NodeB component and a RNC component, or a BTS component and a BSC component, etc.), which may each have their own respective components. In certain scenarios in which network node 2760 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 2760 may be configured to support multiple radio access technologies (RATs). In such embodiments, some components may be duplicated (e.g., separate device readable medium 2780 for the different RATs) and some components may be reused (e.g., the same antenna 2762 may be shared by the RATs). Network node 2760 may also include multiple sets of the various illustrated components for different wireless technologies integrated into network node 2760, such as, for example, GSM, WCDMA, LTE, NR, WiFi, or Bluetooth wireless technologies. These wireless technologies may be integrated into the same or different chip or set of chips and other components within network node 2760.

Processing circuitry 2770 is configured to perform any determining, calculating, or similar operations (e.g., certain obtaining operations) described herein as being provided by a network node. These operations performed by processing circuitry 2770 may include processing information obtained by processing circuitry 2770 by, for example, converting the obtained information into other information, comparing the obtained information or converted information to information stored in the network node, and/or performing one or more operations based on the obtained information or converted information, and as a result of said processing making a determination.

Processing circuitry 2770 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 2760 components, such as device readable medium 2780, network node 2760 functionality. For example, processing circuitry 2770 may execute instructions stored in device readable medium 2780 or in memory within processing circuitry 2770. Such functionality may include providing any of the various wireless features, functions, or benefits discussed herein. In some embodiments, processing circuitry 2770 may include a system on a chip (SOC).

In some embodiments, processing circuitry 2770 may include one or more of radio frequency (RF) transceiver circuitry 2772 and baseband processing circuitry 2774. In some embodiments, radio frequency (RF) transceiver circuitry 2772 and baseband processing circuitry 2774 may be on separate chips (or sets of chips), boards, or units, such as radio units and digital units. In alternative embodiments, part or all of RF transceiver circuitry 2772 and baseband processing circuitry 2774 may be on the same chip or set of chips, boards, or units.

In certain embodiments, some or all of the functionality described herein as being provided by a network node, base station, eNB or other such network device may be performed by processing circuitry 2770 executing instructions stored on device readable medium 2780 or memory within processing circuitry 2770. In alternative embodiments, some or all of the functionality may be provided by processing circuitry 2770 without executing instructions stored on a separate or discrete device readable medium, such as in a hard-wired manner. In any of those embodiments, whether executing instructions stored on a device readable storage medium or not, processing circuitry 2770 can be configured to perform the described functionality. The benefits provided by such functionality are not limited to processing circuitry 2770 alone or to other components of network node 2760, but are enjoyed by network node 2760 as a whole, and/or by end users and the wireless network generally.

Device readable medium 2780 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 2770. Device readable medium 2780 may store any suitable instructions, data or information, including a computer program, software, an application including one or more of logic, rules, code, tables, etc. and/or other instructions capable of being executed by processing circuitry 2770 and, utilized by network node 2760. Device readable medium 2780 may be used to store any calculations made by processing circuitry 2770 and/or any data received via interface 2790. In some embodiments, processing circuitry 2770 and device readable medium 2780 may be considered to be integrated.

Interface 2790 is used in the wired or wireless communication of signaling and/or data between network node 2760, network 2706, and/or WDs 2710. As illustrated, interface 2790 comprises port(s)/terminal(s) 2794 to send and receive data, for example to and from network 2706 over a wired connection. Interface 2790 also includes radio front end circuitry 2792 that may be coupled to, or in certain embodiments a part of, antenna 2762. Radio front end circuitry 2792 comprises filters 2798 and amplifiers 2796. Radio front end circuitry 2792 may be connected to antenna 2762 and processing circuitry 2770. Radio front end circuitry may be configured to condition signals communicated between antenna 2762 and processing circuitry 2770. Radio front end circuitry 2792 may receive digital data that is to be sent out to other network nodes or WDs via a wireless connection. Radio front end circuitry 2792 may convert the digital data into a radio signal having the appropriate channel and bandwidth parameters using a combination of filters 2798 and/or amplifiers 2796. The radio signal may then be transmitted via antenna 2762. Similarly, when receiving data, antenna 2762 may collect radio signals which are then converted into digital data by radio front end circuitry 2792. The digital data may be passed to processing circuitry 2770. In other embodiments, the interface may comprise different components and/or different combinations of components.

In certain alternative embodiments, network node 2760 may not include separate radio front end circuitry 2792, instead, processing circuitry 2770 may comprise radio front end circuitry and may be connected to antenna 2762 without separate radio front end circuitry 2792. Similarly, in some embodiments, all or some of RF transceiver circuitry 2772 may be considered a part of interface 2790. In still other embodiments, interface 2790 may include one or more ports or terminals 2794, radio front end circuitry 2792, and RF transceiver circuitry 2772, as part of a radio unit (not shown), and interface 2790 may communicate with baseband processing circuitry 2774, which is part of a digital unit (not shown).

Antenna 2762 may include one or more antennas, or antenna arrays, configured to send and/or receive wireless signals. Antenna 2762 may be coupled to radio front end circuitry 2790 and may be any type of antenna capable of transmitting and receiving data and/or signals wirelessly. In some embodiments, antenna 2762 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line-of-sight antenna used to transmit/receive radio signals in a relatively straight line. In some instances, the use of more than one antenna may be referred to as MIMO. In certain embodiments, antenna 2762 may be separate from network node 2760 and may be connectable to network node 2760 through an interface or port.

Antenna 2762, interface 2790, and/or processing circuitry 2770 may be configured to perform any receiving operations and/or certain obtaining operations described herein as being performed by a network node. Any information, data and/or signals may be received from a wireless device, another network node and/or any other network equipment. Similarly, antenna 2762, interface 2790, and/or processing circuitry 2770 may be configured to perform any transmitting operations described herein as being performed by a network node. Any information, data and/or signals may be transmitted to a wireless device, another network node and/or any other network equipment.

Power circuitry 2787 may comprise, or be coupled to, power management circuitry and is configured to supply the components of network node 2760 with power for performing the functionality described herein. Power circuitry 2787 may receive power from power source 2786. Power source 2786 and/or power circuitry 2787 may be configured to provide power to the various components of network node 2760 in a form suitable for the respective components (e.g., at a voltage and current level needed for each respective component). Power source 2786 may either be included in, or external to, power circuitry 2787 and/or network node 2760. For example, network node 2760 may be connectable to an external power source (e.g., an electricity outlet) via an input circuitry or interface such as an electrical cable, whereby the external power source supplies power to power circuitry 2787. As a further example, power source 2786 may comprise a source of power in the form of a battery or battery pack which is connected to, or integrated in, power circuitry 2787. The battery may provide backup power should the external power source fail. Other types of power sources, such as photovoltaic devices, may also be used.

Alternative embodiments of network node 2760 may include additional components beyond those shown in FIG. 27 that may be responsible for providing certain aspects of the network node's functionality, including any of the functionality described herein and/or any functionality necessary to support the subject matter described herein. For example, network node 2760 may include user interface equipment to allow input of information into network node 2760 and to allow output of information from network node 2760. This may allow a user to perform diagnostic, maintenance, repair, and other administrative functions for network node 2760.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g., refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 2710 includes antenna 2711, interface 2714, processing circuitry 2720, device readable medium 2730, user interface equipment 2732, auxiliary equipment 2734, power source 2736 and power circuitry 2737. WD 2710 may include multiple sets of one or more of the illustrated components for different wireless technologies supported by WD 2710, such as, for example, GSM, WCDMA, LTE, NR, WiFi, WiMAX, NB-IoT, or Bluetooth wireless technologies, just to mention a few. These wireless technologies may be integrated into the same or different chips or set of chips as other components within WD 2710.

Antenna 2711 may include one or more antennas or antenna arrays, configured to send and/or receive wireless signals, and is connected to interface 2714. In certain alternative embodiments, antenna 2711 may be separate from WD 2710 and be connectable to WD 2710 through an interface or port. Antenna 2711, interface 2714, and/or processing circuitry 2720 may be configured to perform any receiving or transmitting operations described herein as being performed by a WD. Any information, data and/or signals may be received from a network node and/or another WD. In some embodiments, radio front end circuitry and/or antenna 2711 may be considered an interface.

As illustrated, interface 2714 comprises radio front end circuitry 2712 and antenna 2711. Radio front end circuitry 2712 comprise one or more filters 2718 and amplifiers 2716. Radio front end circuitry 2714 is connected to antenna 2711 and processing circuitry 2720, and is configured to condition signals communicated between antenna 2711 and processing circuitry 2720. Radio front end circuitry 2712 may be coupled to or a part of antenna 2711. In some embodiments, WD 2710 may not include separate radio front end circuitry 2712; rather, processing circuitry 2720 may comprise radio front end circuitry and may be connected to antenna 2711. Similarly, in some embodiments, some or all of RF transceiver circuitry 2722 may be considered a part of interface 2714. Radio front end circuitry 2712 may receive digital data that is to be sent out to other network nodes or WDs via a wireless connection. Radio front end circuitry 2712 may convert the digital data into a radio signal having the appropriate channel and bandwidth parameters using a combination of filters 2718 and/or amplifiers 2716. The radio signal may then be transmitted via antenna 2711. Similarly, when receiving data, antenna 2711 may collect radio signals which are then converted into digital data by radio front end circuitry 2712. The digital data may be passed to processing circuitry 2720. In other embodiments, the interface may comprise different components and/or different combinations of components.

Processing circuitry 2720 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 2710 components, such as device readable medium 2730, WD 2710 functionality. Such functionality may include providing any of the various wireless features or benefits discussed herein. For example, processing circuitry 2720 may execute instructions stored in device readable medium 2730 or in memory within processing circuitry 2720 to provide the functionality disclosed herein.

As illustrated, processing circuitry 2720 includes one or more of RF transceiver circuitry 2722, baseband processing circuitry 2724, and application processing circuitry 2726. In other embodiments, the processing circuitry may comprise different components and/or different combinations of components. In certain embodiments processing circuitry 2720 of WD 2710 may comprise a SOC. In some embodiments, RF transceiver circuitry 2722, baseband processing circuitry 2724, and application processing circuitry 2726 may be on separate chips or sets of chips. In alternative embodiments, part or all of baseband processing circuitry 2724 and application processing circuitry 2726 may be combined into one chip or set of chips, and RF transceiver circuitry 2722 may be on a separate chip or set of chips. In still alternative embodiments, part or all of RF transceiver circuitry 2722 and baseband processing circuitry 2724 may be on the same chip or set of chips, and application processing circuitry 2726 may be on a separate chip or set of chips. In yet other alternative embodiments, part or all of RF transceiver circuitry 2722, baseband processing circuitry 2724, and application processing circuitry 2726 may be combined in the same chip or set of chips. In some embodiments, RF transceiver circuitry 2722 may be a part of interface 2714. RF transceiver circuitry 2722 may condition RF signals for processing circuitry 2720.

In certain embodiments, some or all of the functionality described herein as being performed by a WD may be provided by processing circuitry 2720 executing instructions stored on device readable medium 2730, which in certain embodiments may be a computer-readable storage medium. In alternative embodiments, some or all of the functionality may be provided by processing circuitry 2720 without executing instructions stored on a separate or discrete device readable storage medium, such as in a hard-wired manner. In any of those particular embodiments, whether executing instructions stored on a device readable storage medium or not, processing circuitry 2720 can be configured to perform the described functionality. The benefits provided by such functionality are not limited to processing circuitry 2720 alone or to other components of WD 2710, but are enjoyed by WD 2710 as a whole, and/or by end users and the wireless network generally.

Processing circuitry 2720 may be configured to perform any determining, calculating, or similar operations (e.g., certain obtaining operations) described herein as being performed by a WD. These operations, as performed by processing circuitry 2720, may include processing information obtained by processing circuitry 2720 by, for example, converting the obtained information into other information, comparing the obtained information or converted information to information stored by WD 2710, and/or performing one or more operations based on the obtained information or converted information, and as a result of said processing making a determination.

Device readable medium 2730 may be operable to store a computer program, software, an application including one or more of logic, rules, code, tables, etc. and/or other instructions capable of being executed by processing circuitry 2720. Device readable medium 2730 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 2720. In some embodiments, processing circuitry 2720 and device readable medium 2730 may be considered to be integrated.

User interface equipment 2732 may provide components that allow for a human user to interact with WD 2710. Such interaction may be of many forms, such as visual, audial, tactile, etc. User interface equipment 2732 may be operable to produce output to the user and to allow the user to provide input to WD 2710. The type of interaction may vary depending on the type of user interface equipment 2732 installed in WD 2710. For example, if WD 2710 is a smart phone, the interaction may be via a touch screen; if WD 2710 is a smart meter, the interaction may be through a screen that provides usage (e.g., the number of gallons used) or a speaker that provides an audible alert (e.g., if smoke is detected). User interface equipment 2732 may include input interfaces, devices and circuits, and output interfaces, devices and circuits. User interface equipment 2732 is configured to allow input of information into WD 2710, and is connected to processing circuitry 2720 to allow processing circuitry 2720 to process the input information. User interface equipment 2732 may include, for example, a microphone, a proximity or other sensor, keys/buttons, a touch display, one or more cameras, a USB port, or other input circuitry. User interface equipment 2732 is also configured to allow output of information from WD 2710, and to allow processing circuitry 2720 to output information from WD 2710. User interface equipment 2732 may include, for example, a speaker, a display, vibrating circuitry, a USB port, a headphone interface, or other output circuitry. Using one or more input and output interfaces, devices, and circuits, of user interface equipment 2732, WD 2710 may communicate with end users and/or the wireless network, and allow them to benefit from the functionality described herein.

Auxiliary equipment 2734 is operable to provide more specific functionality which may not be generally performed by WDs. This may comprise specialized sensors for doing measurements for various purposes, interfaces for additional types of communication such as wired communications etc. The inclusion and type of components of auxiliary equipment 2734 may vary depending on the embodiment and/or scenario.

Power source 2736 may, in some embodiments, be in the form of a battery or battery pack. Other types of power sources, such as an external power source (e.g., an electricity outlet), photovoltaic devices or power cells, may also be used. WD 2710 may further comprise power circuitry 2737 for delivering power from power source 2736 to the various parts of WD 2710 which need power from power source 2736 to carry out any functionality described or indicated herein. Power circuitry 2737 may in certain embodiments comprise power management circuitry. Power circuitry 2737 may additionally or alternatively be operable to receive power from an external power source; in which case WD 2710 may be connectable to the external power source (such as an electricity outlet) via input circuitry or an interface such as an electrical power cable. Power circuitry 2737 may also in certain embodiments be operable to deliver power from an external power source to power source 2736. This may be, for example, for the charging of power source 2736. Power circuitry 2737 may perform any formatting, converting, or other modification to the power from power source 2736 to make the power suitable for the respective components of WD 2710 to which power is supplied.

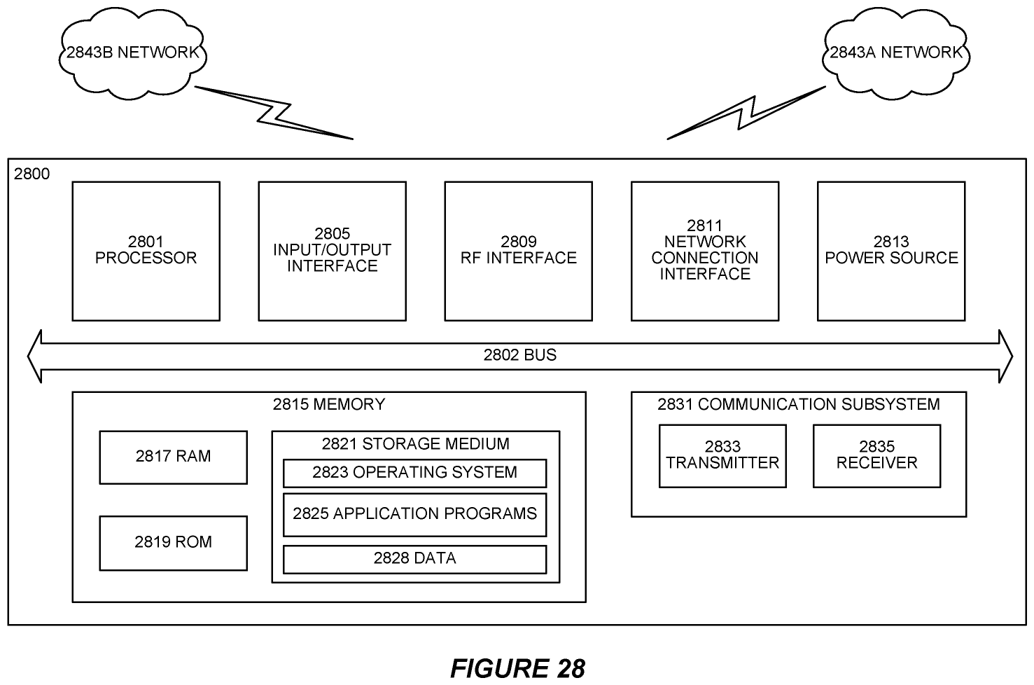

FIG. 28 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 28200 may be any UE identified by the 3^{rd} Generation Partnership Project (3GPP), including a NB-IoT UE, a machine type communication (MTC) UE, and/or an enhanced MTC (eMTC) UE. UE 2800, as illustrated in FIG. 28, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE may be used interchangeable. Accordingly, although FIG. 28 is a UE, the components discussed herein are equally applicable to a WD, and vice-versa.

In FIG. 28, UE 2800 includes processing circuitry 2801 that is operatively coupled to input/output interface 2805, radio frequency (RF) interface 2809, network connection interface 2811, memory 2815 including random access memory (RAM) 2817, read-only memory (ROM) 2819, and storage medium 2821 or the like, communication subsystem 2831, power source 2833, and/or any other component, or any combination thereof. Storage medium 2821 includes operating system 2823, application program 2825, and data 2827. In other embodiments, storage medium 2821 may include other similar types of information. Certain UEs may utilize all of the components shown in FIG. 28, or only a subset of the components. The level of integration between the components may vary from one UE to another UE. Further, certain UEs may contain multiple instances of a component, such as multiple processors, memories, transceivers, transmitters, receivers, etc.

In FIG. 28, processing circuitry 2801 may be configured to process computer instructions and data. Processing circuitry 2801 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 2801 may include two central processing units (CPUs). Data may be information in a form suitable for use by a computer.

In the depicted embodiment, input/output interface 2805 may be configured to provide a communication interface to an input device, output device, or input and output device. UE 2800 may be configured to use an output device via input/output interface 2805. An output device may use the same type of interface port as an input device. For example, a USB port may be used to provide input to and output from UE 2800. The output device may be a speaker, a sound card, a video card, a display, a monitor, a printer, an actuator, an emitter, a smartcard, another output device, or any combination thereof. UE 2800 may be configured to use an input device via input/output interface 2805 to allow a user to capture information into UE 2800. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 28, RF interface 2809 may be configured to provide a communication interface to RF components such as a transmitter, a receiver, and an antenna. Network connection interface 2811 may be configured to provide a communication interface to network 2843a. Network 2843a may encompass wired and/or wireless networks such as a local-area network (LAN), a wide-area network (WAN), a computer network, a wireless network, a telecommunications network, another like network or any combination thereof. For example, network 2843a may comprise a Wi-Fi network. Network connection interface 2811 may be configured to include a receiver and a transmitter interface used to communicate with one or more other devices over a communication network according to one or more communication protocols, such as Ethernet, TCP/IP, SONET, ATM, or the like. Network connection interface 2811 may implement receiver and transmitter functionality appropriate to the communication network links (e.g., optical, electrical, and the like). The transmitter and receiver functions may share circuit components, software or firmware, or alternatively may be implemented separately.

RAM 2817 may be configured to interface via bus 2802 to processing circuitry 2801 to provide storage or caching of data or computer instructions during the execution of software programs such as the operating system, application programs, and device drivers. ROM 2819 may be configured to provide computer instructions or data to processing circuitry 2801. For example, ROM 2819 may be configured to store invariant low-level system code or data for basic system functions such as basic input and output (I/O), startup, or reception of keystrokes from a keyboard that are stored in a non-volatile memory. Storage medium 2821 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 2821 may be configured to include operating system 2823, application program 2825 such as a web browser application, a widget or gadget engine or another application, and data file 2827. Storage medium 2821 may store, for use by UE 2800, any of a variety of various operating systems or combinations of operating systems.

Storage medium 2821 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 2821 may allow UE 2800 to access computer-executable instructions, application programs or the like, stored on transitory or non-transitory memory media, to off-load data, or to upload data. An article of manufacture, such as one utilizing a communication system may be tangibly embodied in storage medium 2821, which may comprise a device readable medium.

In FIG. 28, processing circuitry 2801 may be configured to communicate with network 2843b using communication subsystem 2831. Network 2843a and network 2843b may be the same network or networks or different network or networks. Communication subsystem 2831 may be configured to include one or more transceivers used to communicate with network 2843b. For example, communication subsystem 2831 may be configured to include one or more transceivers used to communicate with one or more remote transceivers of another device capable of wireless communication such as another WD, UE, or base station of a radio access network (RAN) according to one or more communication protocols, such as IEEE 802.28, CDMA, WCDMA, GSM, LTE, UTRAN, WiMax, or the like. Each transceiver may include transmitter 2833 and/or receiver 2835 to implement transmitter or receiver functionality, respectively, appropriate to the RAN links (e.g., frequency allocations and the like). Further, transmitter 2833 and receiver 2835 of each transceiver may share circuit components, software or firmware, or alternatively may be implemented separately.

In the illustrated embodiment, the communication functions of communication subsystem 2831 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 2831 may include cellular communication, Wi-Fi communication, Bluetooth communication, and GPS communication. Network 2843b may encompass wired and/or wireless networks such as a local-area network (LAN), a wide-area network (WAN), a computer network, a wireless network, a telecommunications network, another like network or any combination thereof. For example, network 2843b may be a cellular network, a Wi-Fi network, and/or a near-field network. Power source 2813 may be configured to provide alternating current (AC) or direct current (DC) power to components of UE 2800.

The features, benefits and/or functions described herein may be implemented in one of the components of UE 2800 or partitioned across multiple components of UE 2800. Further, the features, benefits, and/or functions described herein may be implemented in any combination of hardware, software or firmware. In one example, communication subsystem 2831 may be configured to include any of the components described herein. Further, processing circuitry 2801 may be configured to communicate with any of such components over bus 2802. In another example, any of such components may be represented by program instructions stored in memory that when executed by processing circuitry 2801 perform the corresponding functions described herein. In another example, the functionality of any of such components may be partitioned between processing circuitry 2801 and communication subsystem 2831. In another example, the non-computationally intensive functions of any of such components may be implemented in software or firmware and the computationally intensive functions may be implemented in hardware.

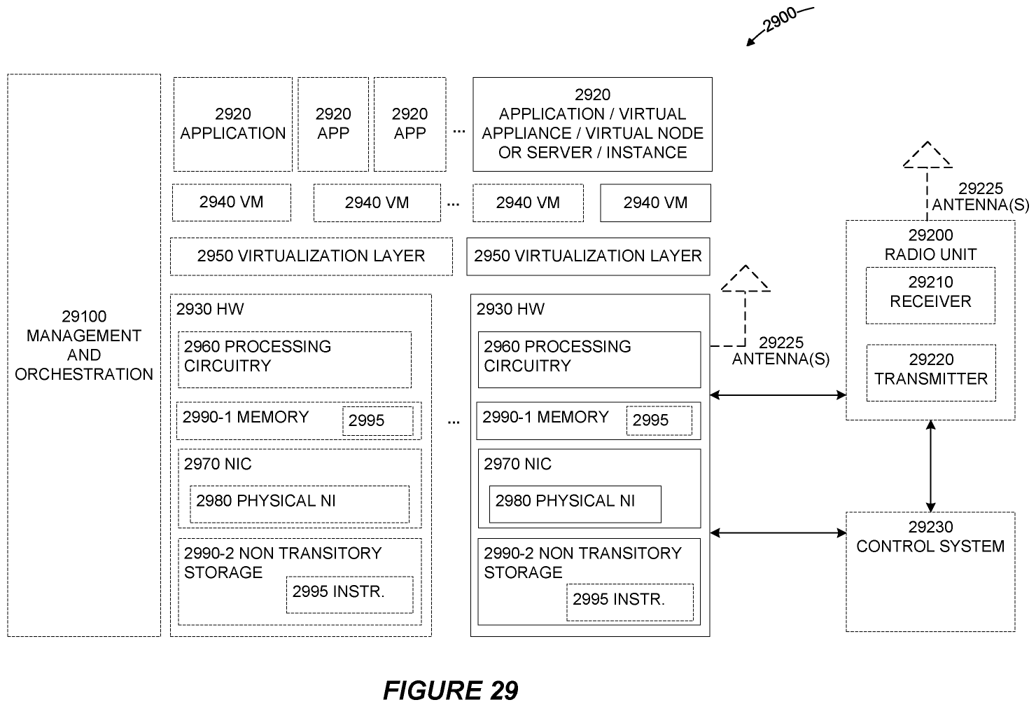

FIG. 29 is a schematic block diagram illustrating a virtualization environment 2900 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 2900 hosted by one or more of hardware nodes 2930. Further, in embodiments in which the virtual node is not a radio access node or does not require radio connectivity (e.g., a core network node), then the network node may be entirely virtualized.

The functions may be implemented by one or more applications 2920 (which may alternatively be called software instances, virtual appliances, network functions, virtual nodes, virtual network functions, etc.) operative to implement some of the features, functions, and/or benefits of some of the embodiments disclosed herein. Applications 2920 are run in virtualization environment 2900 which provides hardware 2930 comprising processing circuitry 2960 and memory 2990. Memory 2990 contains instructions 2995 executable by processing circuitry 2960 whereby application 2920 is operative to provide one or more of the features, benefits, and/or functions disclosed herein.

Virtualization environment 2900, comprises general-purpose or special-purpose network hardware devices 2930 comprising a set of one or more processors or processing circuitry 2960, which may be commercial off-the-shelf (COTS) processors, dedicated Application Specific Integrated Circuits (ASICs), or any other type of processing circuitry including digital or analog hardware components or special purpose processors. Each hardware device may comprise memory 2990-1 which may be non-persistent memory for temporarily storing instructions 2995 or software executed by processing circuitry 2960. Each hardware device may comprise one or more network interface controllers (NICs) 2970, also known as network interface cards, which include physical network interface 2980. Each hardware device may also include non-transitory, persistent, machine-readable storage media 2990-2 having stored therein software 2995 and/or instructions executable by processing circuitry 2960. Software 2995 may include any type of software including software for instantiating one or more virtualization layers 2950 (also referred to as hypervisors), software to execute virtual machines 2940 as well as software allowing it to execute functions, features and/or benefits described in relation with some embodiments described herein.

Virtual machines 2940, comprise virtual processing, virtual memory, virtual networking or interface and virtual storage, and may be run by a corresponding virtualization layer 2950 or hypervisor. Different embodiments of the instance of virtual appliance 2920 may be implemented on one or more of virtual machines 2940, and the implementations may be made in different ways.

During operation, processing circuitry 2960 executes software 2995 to instantiate the hypervisor or virtualization layer 2950, which may sometimes be referred to as a virtual machine monitor (VMM). Virtualization layer 2950 may present a virtual operating platform that appears like networking hardware to virtual machine 2940.

As shown in FIG. 29, hardware 2930 may be a standalone network node with generic or specific components. Hardware 2930 may comprise antenna 29225 and may implement some functions via virtualization. Alternatively, hardware 2930 may be part of a larger cluster of hardware (e.g., such as in a data center or customer premise equipment (CPE)) where many hardware nodes work together and are managed via management and orchestration (MANO) 29100, which, among others, oversees lifecycle management of applications 2920.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 2940 may be a software implementation of a physical machine that runs programs as if they were executing on a physical, non-virtualized machine. Each of virtual machines 2940, and that part of hardware 2930 that executes that virtual machine, be it hardware dedicated to that virtual machine and/or hardware shared by that virtual machine with others of the virtual machines 2940, forms a separate virtual network elements (VNE).

Still in the context of NFV, Virtual Network Function (VNF) is responsible for handling specific network functions that run in one or more virtual machines 2940 on top of hardware networking infrastructure 2930 and corresponds to application 2920 in FIG. 29.

In some embodiments, one or more radio units 29200 that each include one or more transmitters 29220 and one or more receivers 29210 may be coupled to one or more antennas 29225. Radio units 29200 may communicate directly with hardware nodes 2930 via one or more appropriate network interfaces and may be used in combination with the virtual components to provide a virtual node with radio capabilities, such as a radio access node or a base station.

In some embodiments, some signaling can be effected with the use of control system 29230 which may alternatively be used for communication between the hardware nodes 2930 and radio units 29200.

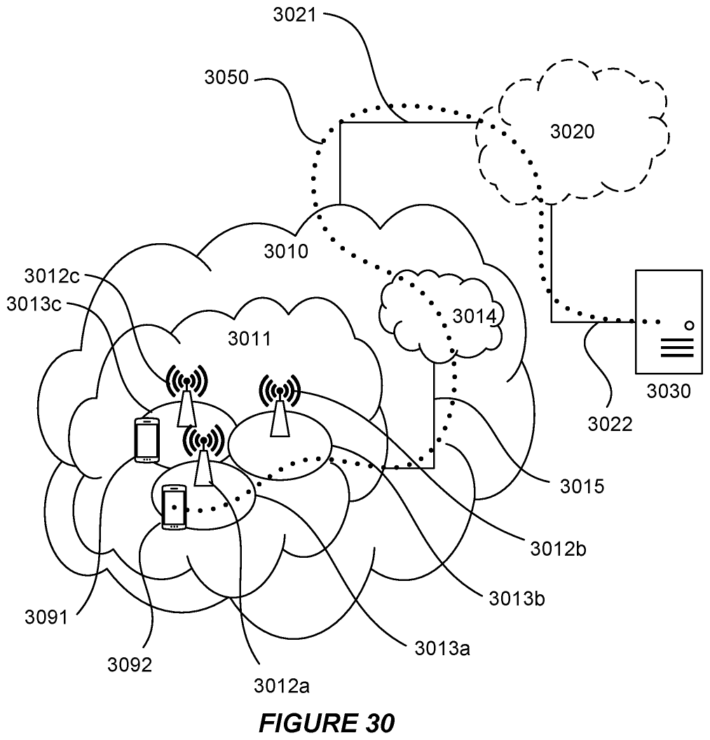

FIG. 30 illustrates a telecommunication network connected via an intermediate network to a host computer in accordance with some embodiments. In particular, with reference to FIG. 30, in accordance with an embodiment, a communication system includes telecommunication network 3010, such as a 3GPP-type cellular network, which comprises access network 3011, such as a radio access network, and core network 3014. Access network 3011 comprises a plurality of base stations 3012a, 3012b, 3012c, such as NBs, eNBs, gNBs or other types of wireless access points, each defining a corresponding coverage area 3013a, 3013b, 3013c. Each base station 3012a, 3012b, 3012c is connectable to core network 3014 over a wired or wireless connection 3015. A first UE 3091 located in coverage area 3013c is configured to wirelessly connect to, or be paged by, the corresponding base station 3012c. A second UE 3092 in coverage area 3013a is wirelessly connectable to the corresponding base station 3012a. While a plurality of UEs 3091, 3092 are illustrated in this example, the disclosed embodiments are equally applicable to a situation where a sole UE is in the coverage area or where a sole UE is connecting to the corresponding base station 3012.

Telecommunication network 3010 is itself connected to host computer 3030, which may be embodied in the hardware and/or software of a standalone server, a cloud-implemented server, a distributed server or as processing resources in a server farm. Host computer 3030 may be under the ownership or control of a service provider, or may be operated by the service provider or on behalf of the service provider. Connections 3021 and 3022 between telecommunication network 3010 and host computer 3030 may extend directly from core network 3014 to host computer 3030 or may go via an optional intermediate network 3020. Intermediate network 3020 may be one of, or a combination of more than one of, a public, private or hosted network; intermediate network 3020, if any, may be a backbone network or the Internet; in particular, intermediate network 3020 may comprise two or more sub-networks (not shown).

The communication system of FIG. 30 as a whole enables connectivity between the connected UEs 3091, 3092 and host computer 3030. The connectivity may be described as an over-the-top (OTT) connection 3050. Host computer 3030 and the connected UEs 3091, 3092 are configured to communicate data and/or signaling via OTT connection 3050, using access network 3011, core network 3014, any intermediate network 3020 and possible further infrastructure (not shown) as intermediaries. OTT connection 3050 may be transparent in the sense that the participating communication devices through which OTT connection 3050 passes are unaware of routing of uplink and downlink communications. For example, base station 3012 may not or need not be informed about the past routing of an incoming downlink communication with data originating from host computer 3030 to be forwarded (e.g., handed over) to a connected UE 3091. Similarly, base station 3012 need not be aware of the future routing of an outgoing uplink communication originating from the UE 3091 towards the host computer 3030.

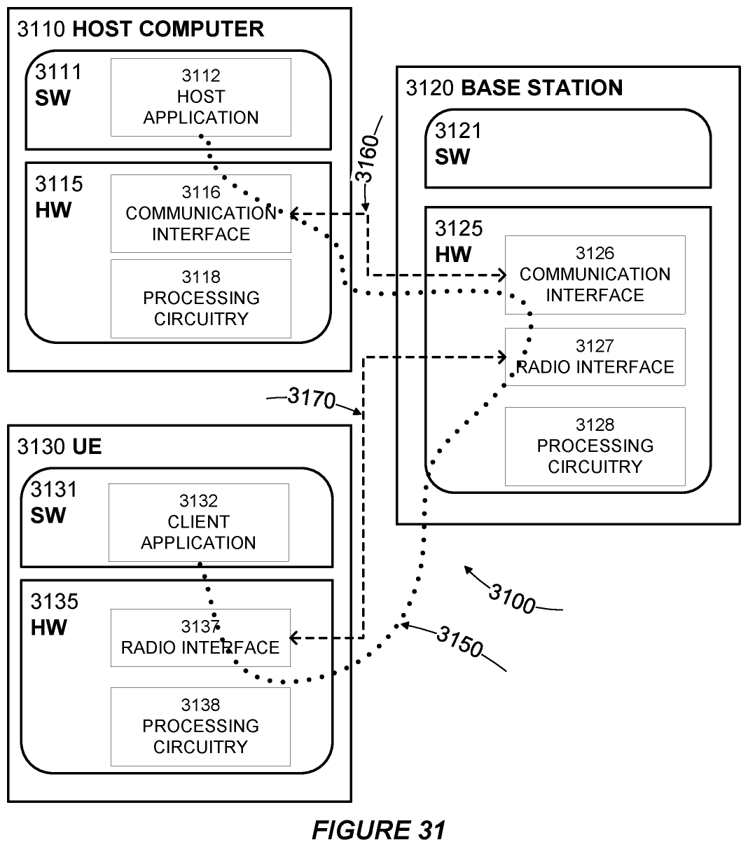

Example implementations, in accordance with an embodiment, of the UE, base station and host computer discussed in the preceding paragraphs will now be described with reference to FIG. 31. FIG. 31 illustrates host computer communicating via a base station with a user equipment over a partially wireless connection in accordance with some embodiments In communication system 3100, host computer 3110 comprises hardware 3115 including communication interface 3116 configured to set up and maintain a wired or wireless connection with an interface of a different communication device of communication system 3100. Host computer 3110 further comprises processing circuitry 3118, which may have storage and/or processing capabilities. In particular, processing circuitry 3118 may comprise one or more programmable processors, application-specific integrated circuits, field programmable gate arrays or combinations of these (not shown) adapted to execute instructions. Host computer 3110 further comprises software 3111, which is stored in or accessible by host computer 3110 and executable by processing circuitry 3118. Software 3111 includes host application 3112. Host application 3112 may be operable to provide a service to a remote user, such as UE 3130 connecting via OTT connection 3150 terminating at UE 3130 and host computer 3110. In providing the service to the remote user, host application 3112 may provide user data which is transmitted using OTT connection 3150.

Communication system 3100 further includes base station 3120 provided in a telecommunication system and comprising hardware 3125 enabling it to communicate with host computer 3110 and with UE 3130. Hardware 3125 may include communication interface 3126 for setting up and maintaining a wired or wireless connection with an interface of a different communication device of communication system 3100, as well as radio interface 3127 for setting up and maintaining at least wireless connection 3170 with UE 3130 located in a coverage area (not shown in FIG. 31) served by base station 3120. Communication interface 3126 may be configured to facilitate connection 3160 to host computer 3110. Connection 3160 may be direct or it may pass through a core network (not shown in FIG. 31) of the telecommunication system and/or through one or more intermediate networks outside the telecommunication system. In the embodiment shown, hardware 3125 of base station 3120 further includes processing circuitry 3128, which may comprise one or more programmable processors, application-specific integrated circuits, field programmable gate arrays or combinations of these (not shown) adapted to execute instructions. Base station 3120 further has software 3121 stored internally or accessible via an external connection.

Communication system 3100 further includes UE 3130 already referred to. Its hardware 3135 may include radio interface 3137 configured to set up and maintain wireless connection 3170 with a base station serving a coverage area in which UE 3130 is currently located. Hardware 3135 of UE 3130 further includes processing circuitry 3138, which may comprise one or more programmable processors, application-specific integrated circuits, field programmable gate arrays or combinations of these (not shown) adapted to execute instructions. UE 3130 further comprises software 3131, which is stored in or accessible by UE 3130 and executable by processing circuitry 3138. Software 3131 includes client application 3132. Client application 3132 may be operable to provide a service to a human or non-human user via UE 3130, with the support of host computer 3110. In host computer 3110, an executing host application 3112 may communicate with the executing client application 3132 via OTT connection 3150 terminating at UE 3130 and host computer 3110. In providing the service to the user, client application 3132 may receive request data from host application 3112 and provide user data in response to the request data. OTT connection 3150 may transfer both the request data and the user data. Client application 3132 may interact with the user to generate the user data that it provides.

It is noted that host computer 3110, base station 3120 and UE 3130 illustrated in FIG. 31 may be similar or identical to host computer 3030, one of base stations 3012a, 3012b, 3012c and one of UEs 3091, 3092 of FIG. 30, respectively. This is to say, the inner workings of these entities may be as shown in FIG. 31 and independently, the surrounding network topology may be that of FIG. 30.

In FIG. 31, OTT connection 3150 has been drawn abstractly to illustrate the communication between host computer 3110 and UE 3130 via base station 3120, without explicit reference to any intermediary devices and the precise routing of messages via these devices. Network infrastructure may determine the routing, which it may be configured to hide from UE 3130 or from the service provider operating host computer 3110, or both. While OTT connection 3150 is active, the network infrastructure may further take decisions by which it dynamically changes the routing (e.g., on the basis of load balancing consideration or reconfiguration of the network).

Wireless connection 3170 between UE 3130 and base station 3120 is in accordance with the teachings of the embodiments described throughout this disclosure. One or more of the various embodiments improve the performance of OTT services provided to UE 3130 using OTT connection 3150, in which wireless connection 3170 forms the last segment.

A measurement procedure may be provided for the purpose of monitoring data rate, latency and other factors on which the one or more embodiments improve. There may further be an optional network functionality for reconfiguring OTT connection 3150 between host computer 3110 and UE 3130, in response to variations in the measurement results. The measurement procedure and/or the network functionality for reconfiguring OTT connection 3150 may be implemented in software 3111 and hardware 3115 of host computer 3110 or in software 3131 and hardware 3135 of UE 3130, or both. In embodiments, sensors (not shown) may be deployed in or in association with communication devices through which OTT connection 3150 passes; the sensors may participate in the measurement procedure by supplying values of the monitored quantities exemplified above, or supplying values of other physical quantities from which software 3111, 3131 may compute or estimate the monitored quantities. The reconfiguring of OTT connection 3150 may include message format, retransmission settings, preferred routing etc.; the reconfiguring need not affect base station 3120, and it may be unknown or imperceptible to base station 3120. Such procedures and functionalities may be known and practiced in the art. In certain embodiments, measurements may involve proprietary UE signaling facilitating host computer 3110′s measurements of throughput, propagation times, latency and the like. The measurements may be implemented in that software 3111 and 3131 causes messages to be transmitted, in particular empty or ‘dummy’ messages, using OTT connection 3150 while it monitors propagation times, errors etc.

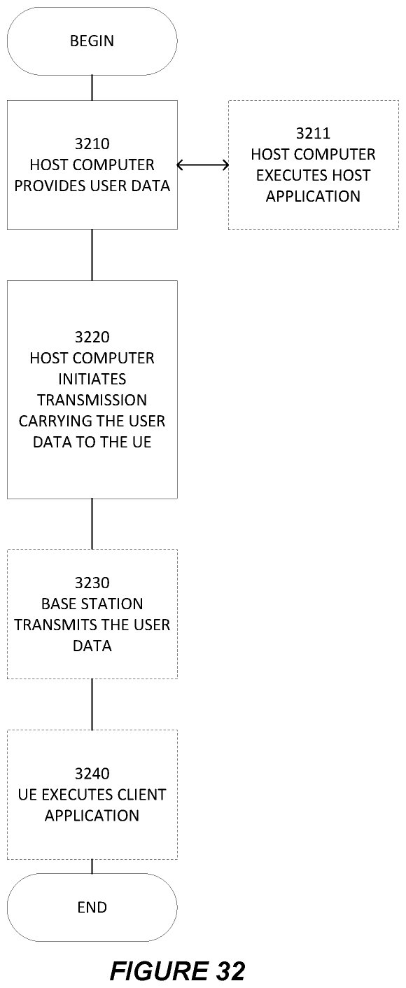

FIG. 32 is a flowchart illustrating a method implemented in a communication system, in accordance with one embodiment. The communication system includes a host computer, a base station and a UE which may be those described with reference to FIGS. 30 and 31. For simplicity of the present disclosure, only drawing references to FIG. 32 will be included in this section. In step 3210, the host computer provides user data. In substep 3211 (which may be optional) of step 3210, the host computer provides the user data by executing a host application. In step 3220, the host computer initiates a transmission carrying the user data to the UE. In step 3230 (which may be optional), the base station transmits to the UE the user data which was carried in the transmission that the host computer initiated, in accordance with the teachings of the embodiments described throughout this disclosure. In step 3240 (which may also be optional), the UE executes a client application associated with the host application executed by the host computer.

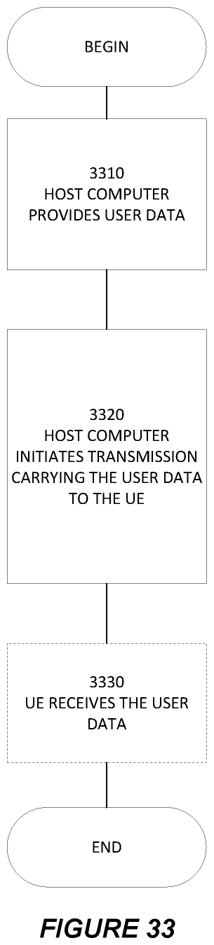

FIG. 33 is a flowchart illustrating a method implemented in a communication system, in accordance with one embodiment. The communication system includes a host computer, a base station and a UE which may be those described with reference to FIGS. 30 and 31. For simplicity of the present disclosure, only drawing references to FIG. 33 will be included in this section. In step 3310 of the method, the host computer provides user data. In an optional substep (not shown) the host computer provides the user data by executing a host application. In step 3320, the host computer initiates a transmission carrying the user data to the UE. The transmission may pass via the base station, in accordance with the teachings of the embodiments described throughout this disclosure. In step 3330 (which may be optional), the UE receives the user data carried in the transmission.

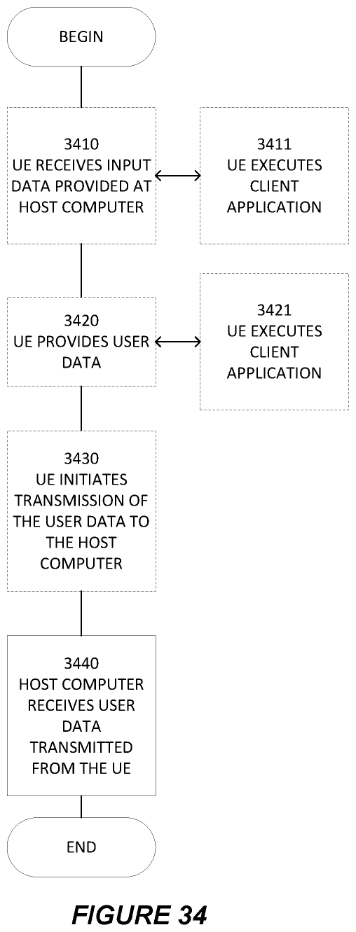

FIG. 34 is a flowchart illustrating a method implemented in a communication system, in accordance with one embodiment. The communication system includes a host computer, a base station and a UE which may be those described with reference to FIGS. 30 and 31. For simplicity of the present disclosure, only drawing references to FIG. 34 will be included in this section. In step 3410 (which may be optional), the UE receives input data provided by the host computer. Additionally or alternatively, in step 3420, the UE provides user data. In substep 3421 (which may be optional) of step 3420, the UE provides the user data by executing a client application. In substep 3411 (which may be optional) of step 3410, the UE executes a client application which provides the user data in reaction to the received input data provided by the host computer. In providing the user data, the executed client application may further consider user input received from the user. Regardless of the specific manner in which the user data was provided, the UE initiates, in substep 3430 (which may be optional), transmission of the user data to the host computer. In step 3440 of the method, the host computer receives the user data transmitted from the UE, in accordance with the teachings of the embodiments described throughout this disclosure.

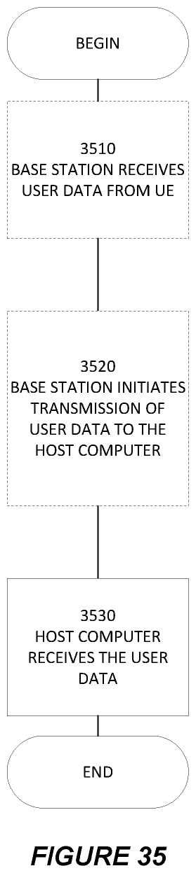

FIG. 35 is a flowchart illustrating a method implemented in a communication system, in accordance with one embodiment. The communication system includes a host computer, a base station and a UE which may be those described with reference to FIGS. 30 and 31. For simplicity of the present disclosure, only drawing references to FIG. 35 will be included in this section. In step 3510 (which may be optional), in accordance with the teachings of the embodiments described throughout this disclosure, the base station receives user data from the UE. In step 3520 (which may be optional), the base station initiates transmission of the received user data to the host computer. In step 3530 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

In view of the above, then, embodiments herein generally include a communication system including a host computer. The host computer may comprise processing circuitry configured to provide user data. The host computer may also comprise a communication interface configured to forward the user data to a cellular network for transmission to a user equipment (UE). The cellular network may comprise a base station having a radio interface and processing circuitry, the base station's processing circuitry configured to perform any of the steps of any of the embodiments described above for a base station.

In some embodiments, the communication system further includes the base station.

In some embodiments, the communication system further includes the UE, wherein the UE is configured to communicate with the base station.

In some embodiments, the processing circuitry of the host computer is configured to execute a host application, thereby providing the user data. In this case, the UE comprises processing circuitry configured to execute a client application associated with the host application.

Embodiments herein also include a method implemented in a communication system including a host computer, a base station and a user equipment (UE). The method comprises, at the host computer, providing user data. The method may also comprise, at the host computer, initiating a transmission carrying the user data to the UE via a cellular network comprising the base station. The base station performs any of the steps of any of the embodiments described above for a base station.

In some embodiments, the method further comprising, at the base station, transmitting the user data.

In some embodiments, the user data is provided at the host computer by executing a host application. In this case, the method further comprises, at the UE, executing a client application associated with the host application.

Embodiments herein also include a user equipment (UE) configured to communicate with a base station. The UE comprises a radio interface and processing circuitry configured to perform any of the embodiments above described for a UE.

Embodiments herein further include a communication system including a host computer. The host computer comprises processing circuitry configured to provide user data, and a communication interface configured to forward user data to a cellular network for transmission to a user equipment (UE). The UE comprises a radio interface and processing circuitry. The UE's components are configured to perform any of the steps of any of the embodiments described above for a UE.

In some embodiments, the cellular network further includes a base station configured to communicate with the UE.

In some embodiments, the processing circuitry of the host computer is configured to execute a host application, thereby providing the user data. The UE's processing circuitry is configured to execute a client application associated with the host application.

Embodiments also include a method implemented in a communication system including a host computer, a base station and a user equipment (UE). The method comprises, at the host computer, providing user data and initiating a transmission carrying the user data to the UE via a cellular network comprising the base station. The UE performs any of the steps of any of the embodiments described above for a UE.

In some embodiments, the method further comprises, at the UE, receiving the user data from the base station.

Embodiments herein further include a communication system including a host computer. The host computer comprises a communication interface configured to receive user data originating from a transmission from a user equipment (UE) to a base station. The UE comprises a radio interface and processing circuitry. The UE's processing circuitry is configured to perform any of the steps of any of the embodiments described above for a UE.

In some embodiments the communication system further includes the UE.

In some embodiments, the communication system further including the base station. In this case, the base station comprises a radio interface configured to communicate with the UE and a communication interface configured to forward to the host computer the user data carried by a transmission from the UE to the base station.

In some embodiments, the processing circuitry of the host computer is configured to execute a host application. And the UE's processing circuitry is configured to execute a client application associated with the host application, thereby providing the user data.

In some embodiments, the processing circuitry of the host computer is configured to execute a host application, thereby providing request data. And the UE's processing circuitry is configured to execute a client application associated with the host application, thereby providing the user data in response to the request data.

Embodiments herein also include a method implemented in a communication system including a host computer, a base station and a user equipment (UE). The method comprises, at the host computer, receiving user data transmitted to the base station from the UE. The UE performs any of the steps of any of the embodiments described above for the UE.

In some embodiments, the method further comprises, at the UE, providing the user data to the base station.

In some embodiments, the method also comprises, at the UE, executing a client application, thereby providing the user data to be transmitted. The method may further comprise, at the host computer, executing a host application associated with the client application.

In some embodiments, the method further comprises, at the UE, executing a client application, and, at the UE, receiving input data to the client application. The input data is provided at the host computer by executing a host application associated with the client application. The user data to be transmitted is provided by the client application in response to the input data.

Embodiments also include a communication system including a host computer. The host computer comprises a communication interface configured to receive user data originating from a transmission from a user equipment (UE) to a base station. The base station comprises a radio interface and processing circuitry. The base station's processing circuitry is configured to perform any of the steps of any of the embodiments described above for a base station.

In some embodiments, the communication system further includes the base station.

In some embodiments, the communication system further includes the UE. The UE is configured to communicate with the base station.

In some embodiments, the processing circuitry of the host computer is configured to execute a host application. And the UE is configured to execute a client application associated with the host application, thereby providing the user data to be received by the host computer.

Embodiments moreover include a method implemented in a communication system including a host computer, a base station and a user equipment (UE). The method comprises, at the host computer, receiving, from the base station, user data originating from a transmission which the base station has received from the UE. The UE performs any of the steps of any of the embodiments described above for a UE.

In some embodiments, the method further comprises, at the base station, receiving the user data from the UE.

In some embodiments, the method further comprises, at the base station, initiating a transmission of the received user data to the host computer.

### Example Embodiments

Embodiments of the techniques, apparatuses, and systems described herein include, but are not limited, to the following enumerated examples.

### Group B Embodiments

B1. A method performed by a first network node, configured to operate as a master network node for multi-connectivity operation of a wireless device, the method comprising:
   determining to configure the wireless device with a conditional reconfiguration;
   transmitting a handover request message to a third network node, including an indication that the procedure is for conditional handover;
   receiving an acknowledgment of the handover request message;
   delaying transmission of a release message to a second network node operating as a secondary network node for the wireless device; and
   configuring the wireless device with conditional handover information, including configuration information provided from the third network node.
B2. The method of example embodiment B1, wherein the acknowledgment indicates that a secondary node is to be kept upon execution of the conditional handover.
B3. The method of example embodiment B1 or B2, wherein the conditional handover information includes information from a fourth network node, acting as a target secondary node candidate for the conditional handover.
B4. A method performed by a third network node, configured to operate as a target master node candidate for multi-connectivity operation of a wireless device, the method comprising:
   receiving a handover request message from a first network node, the handover request message including an indication that the procedure is for conditional handover;
   transmitting a secondary node addition request to a fourth network node, including an indication that the request is for a conditional handover;
   receiving an acknowledgment of the secondary node addition request; and
   transmitting an acknowledgment of the handover request to the first network node.
B5. The method of example embodiment B4, wherein the acknowledgment of the handover request includes an indication that the secondary node is to be kept upon execution of the conditional handover.
B6. A method performed by a fourth network node, configured to operate as a target candidate secondary node for a wireless device, the method comprising:
   receiving a secondary node addition request from a third network node, including an indication that the request is for a conditional handover;
   setting a supervision timer to a value based on the indication that the request is for a conditional handover;
   transmitting an acknowledgment of the secondary node addition request to the third network node; and
   starting the supervision timer.
B7. The method of example embodiment B6, wherein setting the supervision timer comprises setting the supervision timer to a value longer than a value the fourth network node would set the supervision timer for a non-conditional handover and/or legacy secondary node addition.
B8. The method of example embodiment B6 or B7, wherein the method comprises starting the supervision timer upon transmitting the acknowledgment of the secondary node addition request to the third network node.
B9. The method of any of example embodiments B6-B8, further comprising reserving resources for the wireless device taking into account that the request is for a conditional handover.
B10. A method performed by a first network node, configured to operate as a master network node for multi-connectivity operation of a wireless device, the method comprising:
   receiving a message from a third network node, operating as a target candidate master node for a conditional handover for which the wireless device has been configured;
   transmitting a secondary node release request to a second network node operating as a source secondary node for the wireless device;
   receiving, from the second network node, an acknowledgment of the secondary node release request.
B11. The method of example embodiment B10, wherein the secondary node release request indicates that a secondary node is kept for the wireless device.
B12. The method of example embodiment B10 or B11, wherein the message is a handover success message.
B13. A method performed by a second network node, operating as a source secondary node for a wireless device operating in multi-connectivity, the method comprising:
   receiving a secondary node release request message from a first network node operating as a source master node for the wireless device;
   transmitting, to the first network node, an acknowledgment of the secondary node release request.
B14. The method of example embodiment B13, wherein the secondary node release request indicates that a secondary node is kept for the wireless device.
B15. A method performed by a third network node, configured to operate as a target master node candidate for multi-connectivity operation of a wireless device, the method comprising:
   receiving, from a wireless device, an RRC reconfiguration complete message;
   determining that the wireless device has been configured with a conditional handover and has an associated multi-connectivity-related configuration for a fourth network node, operating as a secondary node target candidate;
   transmitting a secondary node reconfiguration complete message to the fourth network node;
   transmitting a message to a first network node, operating as a source master node for the wireless device.
B16. The method of example embodiment B15, further comprising:
   receiving forwarded data from the first node; and
   transferring data for secondary node-terminated bearers of the wireless device to the fourth node.
B17. The method of example embodiment B15 or B16, wherein the secondary node reconfiguration complete message includes the RRC reconfiguration complete message received from the wireless device.
B18. A method performed by a fourth network node, configured to operate as a target candidate secondary node for a wireless device, the method comprising:
   receiving, from a third network node operating as a master node target candidate for conditional handover of the wireless device, a secondary node reconfiguration complete message; and
   stopping a supervision timer associated with conditional handover of the wireless device; and
   considering a context associated with the wireless device to be active.
B19. The method of example embodiment B18, further comprising:
   receiving forwarded data for secondary node-terminated bearers of the wireless device from the third network node.
B20. A method performed by a first network node, configured to operate as a master network node for multi-connectivity operation of a wireless device, the method comprising:
   receiving a message from a target candidate master node to which the wireless device has executed a conditional handover;
   transmitting, to a target candidate master node for which conditional handover of the wireless device has been configured but not executed, a message indicating that a conditional handover configuration for the wireless device is to be released.
B21. The method of example embodiment B21, wherein the received message is a handover success message.
B22. A method performed by a network node configured as a target candidate master node for multi-connectivity conditional handover of a wireless device, the method comprising:
   receiving, from a source master node for the wireless device, a message indicating that a conditional handover configuration for the wireless device is to be released;
   determining that the conditional handover configuration for the wireless device has an associated target secondary node candidate for the conditional handover; and
   transmitting a secondary node release request message to the target secondary node candidate.
B23. The method of example embodiment B22, further comprising receiving an acknowledgment of the secondary node release request message from the target secondary node candidate.
B24. The method of any of the previous embodiments, further comprising:
   obtaining user data; and
   forwarding the user data to a host computer or a wireless device.

### Group C Embodiments

C1. A network node configured to perform any of the steps of any of the Group B embodiments.
C2. A network node comprising processing circuitry configured to perform any of the steps of any of the Group B embodiments.
C3. A network node comprising:
   communication circuitry; and
   processing circuitry configured to perform any of the steps of any of the Group B embodiments.
C4. A network node comprising:
   processing circuitry configured to perform any of the steps of any of the Group B embodiments;
   power supply circuitry configured to supply power to the network node.
C5. A network node comprising:
   processing circuitry and memory, the memory containing instructions executable by the processing circuitry whereby the network node is configured to perform any of the steps of any of the Group B embodiments.
C6. The network node of any of embodiments C1-C5, wherein the network node is a base station.
C7. A computer program comprising instructions which, when executed by at least one processor of a radio network node, causes the radio network node to carry out the steps of any of the Group B embodiments.
C8. The computer program of embodiment C7, wherein the network node is a base station.
C9. A carrier containing the computer program of any of embodiments C7 or C8, wherein the carrier is one of an electronic signal, optical signal, radio signal, or computer readable storage medium.

### Group D Embodiments

D1. A communication system including a host computer comprising:
   processing circuitry configured to provide user data; and
   a communication interface configured to forward the user data to a cellular network for transmission to a user equipment (UE),
   wherein the cellular network comprises a base station having a radio interface and processing circuitry, the base station's processing circuitry configured to perform any of the steps of any of the Group B embodiments.
D2. The communication system of the previous embodiment further including the base station.
D3. The communication system of the previous 2 embodiments, further including the UE, wherein the UE is configured to communicate with the base station.
D4. The communication system of the previous 3 embodiments, wherein:
   the processing circuitry of the host computer is configured to execute a host application, thereby providing the user data; and
   the UE comprises processing circuitry configured to execute a client application associated with the host application.
D5. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the base station performs any of the steps of any of the Group B embodiments.
D6. The method of the previous embodiment, further comprising, at the base station, transmitting the user data.
D7. The method of the previous 2 embodiments, wherein the user data is provided at the host computer by executing a host application, the method further comprising, at the UE, executing a client application associated with the host application.
D8. A user equipment (UE) configured to communicate with a base station, the UE comprising a radio interface and processing circuitry configured to perform any of the previous 3 embodiments.
D9. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B embodiments.
D10. The communication system of the previous embodiment further including the base station.
D11. The communication system of the previous 2 embodiments, further including the UE, wherein the UE is configured to communicate with the base station.
D12. The communication system of the previous 3 embodiments, wherein:
   the processing circuitry of the host computer is configured to execute a host application;
   the UE is configured to execute a client application associated with the host application, thereby providing the user data to be received by the host computer.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the description.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Some of the embodiments contemplated herein are described more fully with reference to the accompanying drawings. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art.

1-27. (canceled)

28. A method performed by a first network node, configured to operate as a master node (MN) for multi-connectivity operation of a wireless device along with a second network node operating as a secondary node (SN) for the wireless device, the method comprising:
determining to configure the wireless device with a conditional reconfiguration;
transmitting a handover request message to a third network node, the handover request message including an indication that the handover request message is for conditional handover;
receiving an acknowledgment of the handover request message which indicates that the secondary node is to be kept upon execution of the conditional handover; and
in response to the acknowledgment of the handover request message, delaying transmission of a release message to the second network node until the first network node receives an indication that the conditional handover is executed.

29. The method of claim 28, wherein the third network node is a candidate target network node for the conditional handover, and wherein the indication that the conditional handover is executed is a handover success message received from the third network node.

30. The method of claim 28, wherein the method comprises configuring the wireless device with conditional handover information, the conditional handover information including information from the third network node for the conditional handover.

31. The method of claim 28, wherein the method further comprises:
receiving a message from the third network node to which the wireless device has executed a conditional handover;
transmitting, to the third network node for which conditional handover of the wireless device has been configured but not executed, a message indicating that a conditional handover configuration for the wireless device is to be released.

32. The method of claim 31, wherein the received message is a handover success message.

33. A method performed by a network node configured to operate as a candidate target network node for multi-connectivity operation of a wireless device, the method comprising:
receiving a handover request message from a source network node for the wireless device, the handover request message including an indication that the handover request message is for conditional handover;
transmitting a secondary node addition request to a candidate target secondary node, in response to receiving the handover request message wherein the secondary node addition request includes an indication that the secondary node addition request is for a conditional reconfiguration;
receiving an acknowledgment of the secondary node addition request; and
transmitting an acknowledgment of the handover request to the source network node.

34. The method of claim 33, wherein the candidate target secondary node is the source secondary node for the wireless device and the acknowledgment of the handover request includes an indication that the source secondary node is to be kept upon execution of the conditional procedure.

35. The method of claim 33, wherein the method further comprises:
receiving, from the wireless device, a message indicating that reconfiguration to the candidate target secondary node is complete; and
sending a secondary node reconfiguration complete message to the candidate target secondary node.

36. The method of claim 35, wherein the secondary node reconfiguration complete message includes the received message indicating that reconfiguration to the candidate target secondary node is complete.

37. The method of claim 35, further comprising sending, to the source network node, a message indicating handover success.

38. The method of claim 33, wherein the method further comprises:
receiving, from a second wireless device, a Radio Resource Control (RRC) reconfiguration complete message;
determining that the second wireless device has been configured with a conditional reconfiguration and has an associated multi-connectivity-related configuration for a candidate target secondary node;
transmitting a secondary node reconfiguration complete message to the candidate target secondary node;
transmitting a message indicating that the conditional reconfiguration has been completed, to a source master node for the second wireless device.

39. The method of claim 38, wherein the conditional reconfiguration is a conditional handover.

40. The method of claim 33, wherein the method further comprises:
receiving, from a source master node for the wireless device, a message indicating that a conditional handover configuration for the wireless device is to be released;
determining that the conditional handover configuration for the wireless device has an associated target secondary node candidate for the conditional handover; and
transmitting a secondary node release request message to the target secondary node candidate.

41. The method of claim 40, further comprising receiving an acknowledgment of the secondary node release request message from the target secondary node candidate.

42. A method performed by a network node configured to act as a candidate target secondary node for multi-connectivity operation of a wireless device, the method comprising:
receiving a secondary node addition request from a candidate target network node, the secondary node addition request including an indication that the secondary node addition request is for a conditional reconfiguration;
transmitting an acknowledgment of the secondary node addition request in response to the secondary node addition request.

43. The method of claim 42, further comprising starting a supervision timer for the secondary node addition, in response to receiving the secondary node addition request.

44. The method of claim 43, wherein the method comprises setting the supervision timer to a value based on the indication that the request is for a conditional reconfiguration.

45. The method of claim 44, wherein setting the supervision timer comprises setting the supervision timer to a value longer than a value the network node would set the supervision timer for a non-conditional secondary node addition.

46. The method of claim 43, wherein the method comprises starting the supervision timer upon transmitting the acknowledgment of the secondary node addition request.

47. The method of claim 43, further comprising:
subsequently receiving a secondary node reconfiguration complete message; and
stopping the supervision timer, in response to receiving the secondary node reconfiguration complete message.

48. The method of claim 42, further comprising reserving resources for the wireless device taking into account that the secondary node addition request is for a conditional reconfiguration.

49. A network node comprising:
communications circuitry configured to communicate with one or more wireless devices and with one or more other network nodes; and
processing circuitry operatively coupled to the communications circuitry and configured to:
determine to configure a wireless device, operating in multi-connectivity operation with the network node operating as a master node (MN) for the wireless device and with a second network node operating as a secondary node (SN) for the wireless device, with a conditional reconfiguration;
transmit a handover request message to a third network node, the handover request message including an indication that the handover request message is for conditional handover;
receive an acknowledgment of the handover request message which indicates that the secondary node is to be kept upon execution of the conditional handover; and
in response to the acknowledgment of the handover request message, delay transmission of a release message to the second network node until the network node receives an indication that the conditional handover is executed.
